(19) United States
(12) Patent Application Publication
(10) Pub. No.: US 2024/0036537 A1
(43) Pub. Date: Feb. 1, 2024

(54) BUILDING MANAGEMENT SYSTEM WITH CONTAINERIZATION FOR A GENERIC GATEWAY

(71) Applicant: Johnson Controls Tyco IP Holdings LLP, Milwaukee, WI (US)

(72) Inventors: Vivek V. Gupta, Menomonee Falls, WI (US); Daniel R. Gottschalk, Racine, WI (US); William R. Kuckuk, Hubertus, WI (US); Adam J. Scott, Grafton, WI (US); Mark T. Fischbach, New Berlin, WI (US); James J. Mertz, Wind Lake, WI (US); Yogesh N. Jalkote, Killari (IN); Sudhanshu Dixit, Milwaukee, WI (US)

(21) Appl. No.: 18/375,261

(22) Filed: Sep. 29, 2023

Related U.S. Application Data
(63) Continuation-in-part of application No. 17/374,135, filed on Jul. 13, 2021.
Application No. 17/374,135 is a continuation-in-part of application No. 17/750,815, filed on May 23, 2022.
Application No. 17/750,815 is a continuation-in-part of application No. 17/374,135, filed on Jul. 13, 2021.
Application No. 17/374,135 is a continuation-in-part of application No. 17/750,824, filed on May 23, 2022.
Application No. 17/750,824 is a continuation-in-part of application No. 17/374,135, filed on Jul. 13, 2021.
Application No. 17/374,135 is a continuation-in-part of application No. 17/750,830, filed on May 23, 2022.
Application No. 17/750,830 is a continuation-in-part of application No. 17/374,135, filed on Jul. 13, 2021.

(30) Foreign Application Priority Data
May 24, 2021 (IN) 202121022969
Feb. 10, 2023 (IN) 202341008712
Jun. 13, 2023 (IN) 202341040167

(51) Int. Cl. G05B 15/02; F24F 11/58; H04L 12/28

(52) U.S. Cl. CPC G05B 15/02; F24F 11/58; H04L 12/2834

(57) ABSTRACT

A building management system (BMS) includes building equipment operable to affect a physical state or condition of a building and a gateway device configured to couple to the building equipment via a wireless master slave/token passing (MS/TP) bus or a wired MS/TP bus. The gateway device is configured to communicate building data to a cloud-based platform including a hub configured to receive the building data, a plurality of cloud applications, wherein the plurality of cloud applications are configured to receive the building data from the hub and process the building data to provide a building data output. The cloud-based platform is configured to communicate the building data output to and receive a command based on the building data output from at least one of a control application, an analytic application, or a monitoring application. The gateway device is further configured to operate according to the command.

### CROSS-REFERENCE TO RELATED PATENT APPLICATIONS

This application is a continuation-in-part of U.S. patent application Ser. No. 17/750,815 filed on May 23, 2022, which is a continuation-in-part of U.S. patent application Ser. No. 17/374,135 filed Jul. 13, 2021, and which claims the benefit of and priority to Indian Provisional Patent Application No. 202121022969 filed May 24, 2021. This application is also a continuation-in-part of U.S. patent application Ser. No. 17/750,830 filed on May 23, 2022, which is a continuation-in-part of U.S. patent application Ser. No. 17/374,135 filed Jul. 13, 2021, and which claims the benefit of and priority to Indian Provisional Patent Application No. 202121022969 filed May 24, 2021. This application is also a continuation-in-part of U.S. patent Ser. No. 17/750,824, filed on May 23, 2022, which is a continuation-in-part of U.S. patent application Ser. No. 17/374,135 filed Jul. 13, 2021, and which claims the benefit of and priority to Indian Provisional Patent Application No. 202121022969 filed May 24, 2021. This application is also a continuation-in-part of U.S. patent application Ser. No. 17/374,135 filed Jul. 13, 2021. This application also claims the benefit of and priority to Indian Provisional Patent Application No. 202341008712, filed on Feb. 10, 2023, and the benefit of and priority to Indian Provisional Patent Application No. 202341040167 filed Jun. 13, 2023. The entire disclosures of all of the above are incorporated by reference herein.

### BACKGROUND

The present disclosure relates generally to building management systems. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

### SUMMARY

One implementation of the present disclosure is a building management system including building equipment operable to affect a physical state or condition of a building and a gateway device. The gateway device is configured to execute an MS/TP container that communicates, via an interface implemented by the MS/TP container, with the building equipment via the wireless MS/TP bus or the wired MS/TP bus and to execute a cloud communication container that communicates, via an interface implemented by the cloud communication container, with a cloud-based data platform. The gateway device is further configured to receive building data from the building equipment via the MS/TP container and provide the building data to the cloud-based data platform via the cloud-connector container. The cloud-based platform is configured to communicate the building data to at least one of a control application, an analytic application, or a monitoring application and receive a command from at least one of the control application, the analytic application, or the monitoring application, based on the building data, wherein the gateway device is further configured to operate according to the command.

Another implementation of the present disclosure is a building management system (BMS) including building equipment operable to affect a physical state or condition of a building, a gateway device coupled to the building equipment, and a network adapter removably coupled to the gateway device. The network adapter is configured to communicably couple the gateway device to a cloud-based platform. The gateway device is configured to execute a building device interface container that communicates, via an interface implemented by the building device interface container, with the building equipment and execute a cloud communication container that interfaces with the network adapter to communicate building data from the building equipment to a cloud-based data platform. The cloud communication container is selected from a plurality of communication containers based on the network adapter. The cloud-based platform is configured to communicate the building data output to at least one of a control application, an analytic application, or a monitoring application, and receive a command from at least one of the control application, the analytic application, or the monitoring application based on the building data output. The gateway device further is configured to operate according to the command.

Another implementation of the present disclosure is a building management system (BMS) including a gateway device coupled to building equipment and configured to execute a building device interface container that communicates, via an interface implemented by the building device interface container, with the building equipment to control or collect data from the building equipment, execute a cloud communication container that communicates, via an interface implemented by the cloud communication container, with a cloud-based data platform according to a data control template configured to control a data rate between the gateway device and the cloud-based platform. The gateway device is also configured to provide building data obtained from the building equipment via the building device interface container to the cloud-based data platform via the cloud communication container. The cloud-based platform includes a hub configured to generate a virtual device twin, the virtual device twin configured to represent the gateway device on the cloud-based platform and including the data control template and receive the building data. The cloud-based data platform also includes a plurality of cloud applications, wherein the plurality of cloud applications are configured to receive the building data from the hub and process the building data to provide a building data output. The cloud-based platform is configured to communicate the building data output to at least one of a control application, an analytic application, or a monitor application and receive a command from at least one of the control application, the analytic application, or the monitor application based on the building data output. The gateway device is further configured to operate according to the command.

### BRIEF DESCRIPTION OF THE DRAWINGS

FIG. 1 is drawing of a building equipped with a heating, ventilating, and air conditioning (HVAC) system, according to some embodiments.

FIG. 2 is a block diagram of an airside system which can be used in the HVAC system of FIG. 1, according to some embodiments.

FIG. 3 is a block diagram of a building management system (BMS) which can be used to monitor and control the building and HVAC system of FIGS. 1-2, according to some embodiments.

FIG. 4A is a block diagram of a building management system (BMS) with a building automation system (BAS) which can be used to monitor and control the building and HVAC system of FIGS. 1-2, according to some embodiments.

FIG. 4B is a block diagram of a building management system (BMS) which can be used to monitor and control the building and HVAC system of FIGS. 1-2, according to some embodiments.

FIG. 5 is a block diagram illustrating a gateway device which can be used in BMS 300 of FIG. 3, according to some embodiments.

FIG. 6 is a block diagram illustrating select components of gateway device which can be used in BMS 300 in greater detail, according to some embodiments.

FIG. 7 is a sequence diagram illustrating a process for automatically discovering and generating equipment templates for equipment in a building management system, according to some embodiments.

FIG. 8 is a sequence diagram illustrating a process for automatically discovering and interacting with equipment in a building management system, according to some embodiments.

FIG. 9 is a block diagram of a cloud client which can be used with a gateway device of a BMS, according to some embodiments.

FIG. 10 is a block diagram illustrating select components of a cloud platform which can be used in a BMS, according to some embodiments.

FIG. 11 is a sequence diagram illustrating a process for providing a cloud platform with an equipment list from a gateway device, according to some embodiments.

FIG. 12 is a sequence diagram illustrating a process for providing a cloud platform with an equipment template from a gateway device which can be used in a BMS, according to some embodiments.

FIG. 13 is a flow diagram illustrating a technique which can be used by the BMS of FIGS. 3-4 to automatically discover and interact with BMS equipment, according to some embodiments.

FIG. 14 is a flow diagram illustrating a technique which can be used by the BMS of FIGS. 3-4 to create and use equipment models for system bus devices, according to some embodiments.

FIGS. 15A and 15B are block diagrams illustrating a communications interface of a gateway device for use in a BMS, according to some embodiments.

FIGS. 16-18 are block diagrams illustrating a BMS with a gateway device using detachable network adapters which can be used to monitor and control a building, according to some embodiments.

FIG. 19 is a flow diagram illustrating a technique for integrating detachable network adapters which can be performed by the BMS of FIGS. 16-18, according to some embodiments.

FIG. 20 is a sequence diagram illustrating a process for updating a data control template which can be performed by the BMS of FIG. 3, according to some embodiments.

FIG. 21 is a sequence diagram illustrating a telemetry data process for sending COV data to a cloud platform which can be performed by the BMS of FIG. 3, according to some embodiments.

FIG. 22 is a sequence diagram illustrating a process for sending a heartbeat message to a cloud platform which can be performed by the BMS of FIG. 3, according to some embodiments.

FIG. 23 is a flow chart of a time synchronization process for synchronizing the time on the gateway device which can be performed by the BMS of FIG. 3, according to some embodiments.

FIG. 24 a sequence diagram illustrating a firmware update process which can be used by a gateway device of FIG. 5, according to some embodiments.

FIGS. 25-26 are block diagrams illustrating a high level process flow performed by the BMS of FIG. 9, according to some embodiments.

FIG. 27 is a block diagram of a building data platform including an edge platform, a cloud platform, and a twin manager, according to an embodiment.

FIG. 28 is a graph projection of the twin manager of FIG. 1 including application programming interface (API) data, capability data, policy data, and services, according to an embodiment.

FIG. 29 is another graph projection of the twin manager of FIG. 1 including application programming interface (API) data, capability data, policy data, and services, according to an embodiment.

FIG. 30 is a graph projection of the twin manager of FIG. 1 including equipment and capability data for the equipment, according to an embodiment.

FIG. 31 is a block diagram of the edge platform of FIG. 1 shown in greater detail to include a connectivity manager, a device manager, and a device identity manager, according to an embodiment.

FIG. 32A is another block diagram of the edge platform of FIG. 1 shown in greater detail to include communication layers for facilitating communication between building subsystems and the cloud platform and the twin manager of FIG. 1, according to an embodiment.

FIG. 32B is another block diagram of the edge platform of FIG. 1 shown distributed across building devices of a building, according to an embodiment.

FIG. 33 is a block diagram of components of the edge platform of FIG. 1, including a connector, a building normalization layer, services, and integrations distributed across various computing devices of a building, according to an embodiment.

FIG. 34 is a block diagram of a local building management system (BMS) server including a connector and an adapter service of the edge platform of FIG. 1 that operate to connect an engine with the cloud platform of FIG. 1, according to an embodiment.

FIG. 35 is a block diagram of the engine of FIG. 8 including connectors and an adapter service to connect the engine with the local BMS server of FIG. 8 and the cloud platform of FIG. 1, according to an embodiment.

FIG. 36 is a block diagram of a gateway including an adapter service connecting the engine of FIG. 8 to the cloud platform of FIG. 1, according to an embodiment.

FIG. 37 is a block diagram of a surveillance camera and a smart thermostat for a zone of the building that uses the edge platform of FIG. 1 to perform event based control, according to an embodiment.

FIG. 38 is a block diagram of a cluster based gateway that runs micro-services for facilitating communication between building subsystems and cloud applications, according to an embodiment.

FIG. 39 is a flow diagram of an example method for deploying gateway components on one or more computing systems of a building, according to an embodiment.

FIG. 40 is a flow diagram of an example method for deploying gateway components on a local BMS server, according to an embodiment.

FIG. 41 is a flow diagram of an example method for deploying gateway components on a network engine, according to an embodiment.

FIG. 42 is a flow diagram of an example method for deploying gateway components on a dedicated gateway, according to an embodiment.

FIG. 43 is a flow diagram of an example method for implementing gateway components on a building device, according to an embodiment.

FIG. 44 is a flow diagram of an example method for deploying gateway components to perform a building control algorithm, according to an embodiment.

FIG. 45 is a system diagram that may be utilized to perform optimization and autoconfiguration of edge processing devices, according to an embodiment.

FIG. 46 is a block diagram of an example system including an example building device gateway that implements containerized gateway components, in accordance with one or more implementations.

FIG. 47 is a block diagram of an example base image that may be implemented by the building device gateway described in connection with FIGS. 20, in accordance with one or more implementations.

FIG. 48 is a flow diagram of an example method for the integration and containerization of gateway components on edge devices, in accordance with one or more implementations.

### DETAILED DESCRIPTION

Referring generally to the FIGURES, a building management system (BMS) with automatic equipment discovery and equipment model distribution is shown, according to some embodiments. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

In brief overview, the BMS described herein provides a system architecture that facilitates control of the BMS and devices within it over via a gateway device. Some devices of this network may be unable to communicate over an IP network and/or are not “Internet enabled.” In this regard, only local control, i.e., commands sent over the building network for the devices may be available, i.e., commands can only be sent to the devices of the building via the building network. To allow the various devices of the building network access to the Internet or an IP based network, one or more gateways can be installed in the building which bridge the gap between the building networks and IP based networks (e.g., the Internet). By establishing a link between the building networks of the building and various IP based networks, local control of the building is extended to remote control of the building via the Internet as users can access the various devices of the building remotely, via the internet.

To properly enable the devices of the building to be controlled via the Internet, a logical network representation of the building network, the devices of the building, and the gateways (e.g., configuration data) can be maintained by a building server. The building server may be any Internet server which the gateways of the building communicate with. This remote building server may store and maintain a logical network representation of the gateways and the devices of the building. In this regard, the gateways of the building may pass equipment models and indications of the devices connected to the gateway to the building server. Further, the various connections between the gateways and the devices may be recorded by the building server, this data received by the remote building server via the gateways.

A equipment model, as referred to herein, may indicate a list of point objects of one or more devices that a particular gateway is responsible for collecting data from and/or sending control signals to. For example, an analog input may be a particular point object in an equipment model. The equipment model may indicate that the analog input is sampled every minute. In this regard, the gateway may sample the analog input every minute. In another example, the same equipment model may include a point object which is a “valve position point.” A building server may send a command to the gateway which may be a command position (e.g., 45 degrees, 5 Volts, and/or 455 steps) which the gateway may send to the device with the “valve position point.” As referred to herein, “collect” may refer to extracting data from a device.

The BMS described below can provide automatic equipment discovery and equipment model distribution for equipment connected to the gateways. Equipment discovery can occur across multiple different master slave token passing (“MS/TP”) communications busses (e.g., wireless MS/TP buses, wired MS/TP buses, etc.) and across multiple different communications protocols (BACnet, MODbus, etc.). In some embodiments, equipment discovery is accomplished using active node tables, which provide status information for devices connected to each communications bus. For example, each communications bus can be monitored for new devices by monitoring the corresponding active node table for new nodes. When a new device is detected, the BMS can begin interacting with the new device (e.g., sending control signals, using data from the device) without user interaction.

Some devices in the BMS present themselves to the network using equipment models. An equipment model defines equipment object attributes, view definitions, schedules, trends, and the associated BACnet value objects (e.g., analog value, binary value, multistate value, etc.) that are used for integration with other systems. Some devices in the BMS store their own equipment models. Other devices in the BMS have equipment models stored externally (e.g., within other devices). For example, a gateway device can store the equipment model for a chiller. In some embodiments, the gateway device automatically creates the equipment model for the chiller and/or other devices on the MS/TP bus. Other gateway devices can also create equipment models for devices connected to their MS/TP buses. The equipment model for a device can be created automatically based on the types of data points exposed by the device on the MS/TP bus, device type, and/or other device attributes. Several examples of automatic equipment discovery and equipment model distribution are discussed in greater detail below. Throughout this disclosure, the terms “equipment model,” “equipment model template,” and “equipment template” are used interchangeably.

### Building and HVAC System

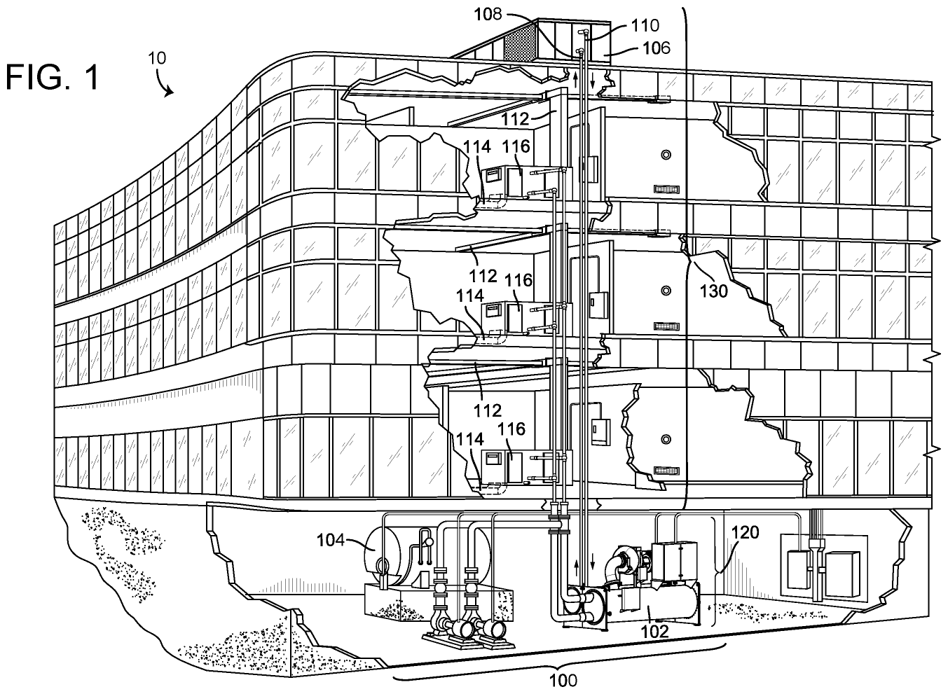

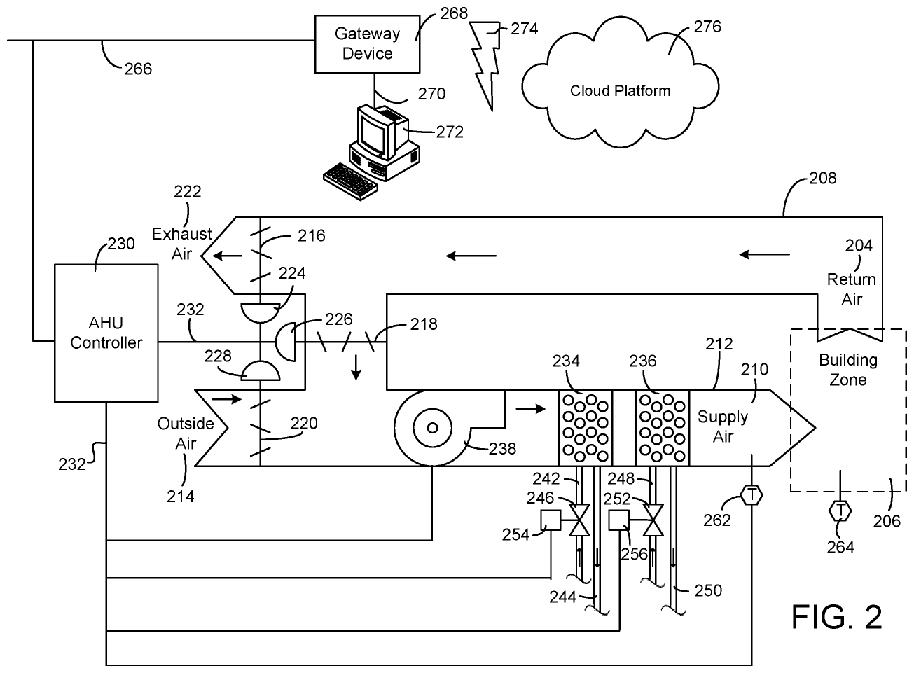

Referring now to FIG. 1, an exemplary building and HVAC system in which the systems and methods of the present invention can be implemented are shown, according to an exemplary embodiment. In FIG. 1, a perspective view of a building 10 is shown. Building 10 is served by a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary airside system which can be used in HVAC system 100 are described in greater detail with reference to FIG. 2B.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

### Airside System

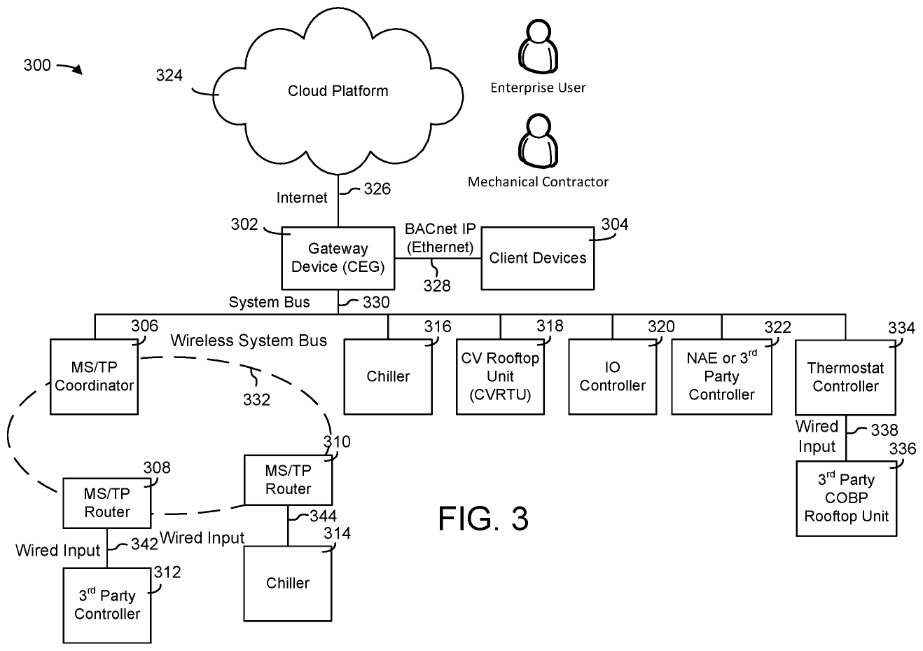

Referring now to FIG. 2, a block diagram of an airside system 200 is shown, according to an exemplary embodiment. In various embodiments, airside system 200 can supplement or replace airside system 130 in HVAC system 100 or can be implemented separate from HVAC system 100. When implemented in HVAC system 100, airside system 200 can include a subset of the HVAC devices in HVAC system 100 (e.g., AHU 106, VAV units 116, ducts 112-114, fans, dampers, etc.) and can be located in or around building 10. In some embodiments, referring to FIG. 3, airside system 200 can be used in BMS 300 as a third-party COBP rooftop unit 336. Airside system 200 can operate to heat or cool an airflow provided to building 10.

Airside system 200 is shown to include an economizer-type air handling unit (AHU) 202. Economizer-type AHUs vary the amount of outside air and return air used by the air handling unit for heating or cooling. For example, AHU 202 can receive return air 204 from building zone 206 via return air duct 208 and can deliver supply air 210 to building zone 206 via supply air duct 212. In some embodiments, AHU 202 is a rooftop unit located on the roof of building 10 (e.g., AHU 106 as shown in FIG. 1) or otherwise positioned to receive both return air 204 and outside air 214. AHU 202 can be configured to operate exhaust air damper 216, mixing damper 218, and outside air damper 220 to control an amount of outside air 214 and return air 204 that combine to form supply air 210. Any return air 204 that does not pass through mixing damper 218 can be exhausted from AHU 202 through exhaust damper 216 as exhaust air 222.

Each of dampers 216-220 can be operated by an actuator. For example, exhaust air damper 216 can be operated by actuator 224, mixing damper 218 can be operated by actuator 226, and outside air damper 220 can be operated by actuator 228. Actuators 224-228 can communicate with an AHU controller 230 via a sensor/actuator (SA) bus 232. Actuators 224-228 can receive control signals from AHU controller 230 and can provide feedback signals to AHU controller 230. Feedback signals can include, for example, an indication of a current actuator or damper position, an amount of torque or force exerted by the actuator, diagnostic information (e.g., results of diagnostic tests performed by actuators 224-228), status information, commissioning information, configuration settings, calibration data, and/or other types of information or data that can be collected, stored, or used by actuators 224-228. AHU controller 230 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 224-228.

Still referring to FIG. 2, AHU 202 is shown to include a cooling coil 234, a heating coil 236, and a fan 238 positioned within supply air duct 212. Fan 238 can be configured to force supply air 210 through cooling coil 234 and/or heating coil 236 and provide supply air 210 to building zone 206. AHU controller 230 can communicate with fan 238 via SA bus 232 to control a flow rate of supply air 210. In some embodiments, AHU controller 230 controls an amount of heating or cooling applied to supply air 210 by modulating a speed of fan 238.

Cooling coil 234 can receive a chilled fluid from waterside system 120 via piping 242 and can return the chilled fluid to waterside system 120 via piping 244. Valve 246 can be positioned along piping 242 or piping 244 to control a flow rate of the chilled fluid through cooling coil 234. In some embodiments, cooling coil 234 includes multiple stages of cooling coils that can be independently activated and deactivated (e.g., by AHU controller 230) to modulate an amount of cooling applied to supply air 210.

Heating coil 236 may receive a heated fluid from waterside system 120 via piping 248 and can return the heated fluid to waterside system 120 via piping 250. Valve 252 can be positioned along piping 248 or piping 250 to control a flow rate of the heated fluid through heating coil 236. In some embodiments, heating coil 236 includes multiple stages of heating coils that can be independently activated and deactivated (e.g., by AHU controller 230) to modulate an amount of heating applied to supply air 210.

Each of valves 246 and 252 can be controlled by an actuator. For example, valve 246 can be controlled by actuator 254 and valve 252 can be controlled by actuator 256. Actuators 254-256 can communicate with AHU controller 230 via SA bus 232. Actuators 254-256 can receive control signals from AHU controller 230 and can provide feedback signals to AHU controller 230. In some embodiments, AHU controller 230 receives a measurement of the supply air temperature from a temperature sensor 262 positioned in supply air duct 212 (e.g., downstream of cooling coil 234 and/or heating coil 236).

In some embodiments, AHU controller 230 operates valves 246 and 252 via actuators 254-256 to modulate an amount of heating or cooling provided to supply air 210 (e.g., to achieve a setpoint temperature for supply air 210 or to maintain the temperature of supply air 210 within a setpoint temperature range). The positions of valves 246 and 252 affect the amount of heating or cooling provided to supply air 210 by cooling coil 234 or heating coil 236 and may correlate with the amount of energy consumed to achieve a desired supply air temperature. In some embodiments, AHU controller 230 receives a measurement of the zone temperature from a temperature sensor 264 positioned within building zone 206. AHU controller 230 can control the temperature of supply air 210 and/or building zone 206 by activating or deactivating coils 234-236, adjusting a speed of fan 238, or a combination of both.

Still referring to FIG. 2, AHU controller 230 can be connected to gateway device 268 via system bus 266. System bus 266 can be a wired MS/TP bus, and can include any of a variety of communications hardware (e.g., wires, optical fiber, terminals, etc.) and/or communications software configured to facilitate communications between AHU controller 230 and gateway device 268. In some embodiments, system bus 266 can be a wireless MS/TP bus, and can include operating over a wireless MS/TP network such as a Zigbee 802.15.4 network. The wireless MS/TP bus can include a plurality of wireless bridge devices configured to build the MS/TP network and provide communication between AHU controller 230 and gateway device 268 in such a manner so that the devices are operationally unaware of the wireless connection. Gateway device 268 can communicate with client device 272 via data communications link 270 (e.g., BACnet IP, Ethernet, wired or wireless communications, etc.) and communicate with cloud platform 276 over internet connection 274. Internet connection 274 can be a wired or wireless connection (i.e. Ethernet, Wi-Fi, Cellular, etc.).

Client device 272 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, airside system 200, BMS 300 of FIG. 3, and/or the various subsystems, and devices thereof. Client device 272 can be a computer workstation, a client terminal, a remote or local interface, or any other type of user interface device. Client device 272 can be a stationary terminal or a mobile device. For example, client device 272 can be a desktop computer, a computer server with a user interface, a laptop computer, a tablet, a smartphone, a PDA, or any other type of mobile or non-mobile device. System bus 266, gateway device 268, client device 272 and cloud platform 276 are explained in further detail below with reference to FIG. 3.

Building Management System with Cloud-Based Monitoring and Control

Referring now to FIG. 3, a block diagram of a building management system (BMS) 300 is shown, according to an exemplary embodiment. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. BMS 300 can be used to monitor and control the devices of HVAC system 100 and/or airside system 200 (e.g., HVAC equipment), and/or waterside system 120, as well as other types of BMS devices (e.g., BACnet MS/TP devices, lighting equipment, security equipment, etc.).

In brief overview, BMS 300 provides a system architecture that facilitates central control of smart and non-smart building equipment of BMS 300 from a networked location. In some embodiments, BMS 300 can provide automatic equipment discovery and equipment model distribution. Equipment discovery can occur across multiple different communications networks (e.g., system bus, wireless system bus, etc.) and across multiple different communications protocols (e.g., LONworks, MODbus, BACnet, etc.). For the purposes of simplicity, this disclosure will describe a building management system with reference to the BACnet protocol, but it should be understood by one of ordinary skill in the art that other building management protocols may be used. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 300 can begin interacting with the new device (e.g., sending control signals, using data from the device) without user interaction.

Some devices in BMS 300 present themselves to the network using equipment models. An equipment model defines equipment object attributes, view definitions, schedules, trends, and the associated BACnet value objects (e.g., analog value, binary value, multistate value, etc.) that are used for integration with other systems. An equipment model for a device can include a collection of points objects that provide information about the device (e.g., device name, network address, model number, device type, etc.) and store present values of variables or parameters used by the device. For example, the equipment model can include point objects (e.g., standard BACnet point objects) that store the values of input variables accepted by the device (e.g., setpoint, control parameters, etc.), output variables provided by the device (e.g., temperature measurement, feedback signal, etc.), configuration parameters used by the device (e.g., operating mode, actuator stroke length, damper position, tuning parameters, etc.). The point objects in the equipment model can be mapped to variables or parameters stored within the device to expose those variables or parameters to external systems or devices. The equipment models and associated BACnet value objects and point objects can make up the building data that can be collected by BMS 300. For example, gateway device 302 can collect building data (e.g., output variables provided by the device) and communicate that building data to cloud platform 324 for processing and control of BMS 300.

In some embodiments, gateway device 302 automatically creates the equipment model for chiller 316 or other devices connected to it. Other gateway devices can also create equipment models for devices connected to them. The equipment model for a device can be created automatically based on the types of data points exposed by the device on the communications bus, device type, and/or other device attributes. In some embodiments, BMS 300 is configured to perform some or all of the operations described in U.S. patent application Ser. No. 16/844,328 filed Apr. 9, 2020, the entire disclosure of which is incorporated by reference herein.

Still referring to FIG. 3, BMS 300 is shown to include a gateway device 302 (i.e., a connected equipment gateway). Gateway device 302 can communicate with client devices 304 (e.g., user devices, desktop computers, laptop computers, mobile devices, etc.) via a data communication link 328 (e.g., BACnet IP, Ethernet, wired or wireless communication, etc.). Gateway device 302 can provide a user interface to client devices 304 via data communications link 328. The user interface may allow users to monitor and/or control BMS 300 via client devices 304. Several examples of the operations that may be performed by gateway devices facilitating communication between building equipment and cloud platforms are described in U.S. Pat. No. 10,868,857 filed Apr. 21, 2017 and U.S. patent application Ser. No. 16/844,328 filed Apr. 9, 2020. The entire disclosures of both these patent applications are incorporated by reference herein.

In some embodiments, gateway device 302 is connected to building equipment via a system bus 330. Building equipment can be devices of HVAC system 100 as well as other types of BMS devices (e.g., lighting equipment, security equipment, etc.) and/or any BACnet MS/TP master device. In some embodiments, building equipment are smart communicating equipment controllers, SC-EQ, manufactured by Johnson Controls, Inc. Further details of the SC-EQ device may be found in U.S. patent application Ser. No. 16/659,155 filed Oct. 21, 2019. The entire disclosure of U.S. patent application Ser. No. 16/659,155 is incorporated by reference herein.

System bus 330 can include any of a variety of communications hardware (e.g., wire, optical fiber, terminals, etc.) configured to facilitate communications between gateway device 302 and other devices connected to system bus 330. In some embodiments system bus 330 can additionally include and/or alternatively be replaced by a wireless system bus, shown as a wireless system bus 332.

Wireless system bus 332 can include a plurality of wireless bridge devices forming a multi-point to multi-point network. The wireless bridge devices of wireless system bus 332 are shown as MS/TP coordinator 306 and MS/TP routers 308 and 310. In some embodiments, MS/TP coordinator 306 is a component of gateway device 302. Still in others, MS/TP coordinator 306 is a separate device and may be connected to gateway device 302 using a RJ12 or MS/TP COM port. MS/TP routers 308 and 310 interface between building equipment (e.g., MS/TP devices) such as controller 312 and chiller 314 to allow them to be discovered by MS/TP coordinator 306 and posted on system bus 330 as if the devices were connected directly to system bus 330. The multi-point to multi-point network can be a mesh network created between a MS/TP coordinator 306 and MS/TP routers 308 and 310. For example, the mesh network may be an 802.15.4 based network such as ZIGBEE. Wireless system bus 332 may allow the gateway device 302 to communicate with devices connected to via the wireless system bus 332. Wireless system bus devices may include any BACnet MS/TP device and/or any device that can be connected to gateway device 302 over system bus 330. Referring still to FIG. 3, wireless system bus devices can include controller 312 and chiller 314. Wireless system bus 332 may be configured so that the wireless system bus devices act as if they were connected directly to system bus 330. In some embodiments, neither the wireless system bus devices nor gateway device 302 are aware of the intermediate network of MS/TP devices. In some embodiments, the gateway device 302 is connected to a mix of devices over both system bus 330 and wireless system bus 332. For example, system bus 330 and wireless system bus 332 can connect gateway device 302 with controller 312, chiller 314, chiller 316, a constant volume (CV) rooftop unit (RTU) 318, input/output (IO) controller 320, network automation engine (NAE) or third-party controller 322, and thermostat controller 334 connected over wired input 338 to third-party rooftop unit 336.

In some embodiments, gateway device 302 is connected to wireless system bus 332 via system bus 330. In other embodiments, gateway device 302 is connected directly to wireless system bus 332. In some embodiments, BMS 300 operates only using wireless system bus 332. In some embodiments BMS 300 can include both a wired system bus 330 and a wireless system bus 332, as shown in FIG. 3. Throughout this disclosure, the devices and building equipment connected to system bus 330 and wireless system bus 332 may be referred to together as system bus devices.

Gateway device 302 can be configured to communicate using a MS/TP protocol or any other communications protocol. Gateway device 302 can collect building data (e.g., equipment models, value objects, point objects, and/or any other data made available by building equipment) and communicate that data to cloud platform 324. Cloud platform 324 can process the data and direct gateway device 302 to collect specific data (e.g., listed value objects, point objects, etc.) from specific building equipment. Gateway device 302 can subscribe to the indicated objects and communicate the data to cloud platform 324 periodically.

Still referring to FIG. 3, gateway device 302 can be configured to communicate with cloud platform 324 via an internet communications link 326 (e.g., Wi-Fi, Ethernet, cellular, etc.) In some embodiments, internet communications link 326 may be provided by external network adapters attached to gateway device 302, as explained in further detail below. Gateway device 302 may be configured to connect the building equipment (e.g., chillers, controllers, RTUs, and/or other MS/TP devices) on the trunk (e.g., system bus 330, wireless system bus 332, etc.) to cloud platform 324. Gateway device 302 can facilitate the communication of building data from building equipment to cloud platform 324. The user interface may allow users to view the building data and/or monitor and control this connection to manage BMS 300, including the data rate between gateway device 302, the building equipment, and cloud platform 324. Gateway device 302 can be configured to automatically discover equipment in BMS 300 and automatically generate or obtain equipment models for the discovered equipment. Gateway device 302 can also be configured to gather more data from the equipment (e.g., equipment model templates) and to use the equipment model templates to drive features of gateway device 302. In some embodiments, gateway device 302 is configured similarly and performs in a similar manner to a gateway device described in commonly owned U.S. patent application Ser. No. 16/844,328 filed Apr. 9, 2020, the entire disclosure of which has been incorporated by reference herein.

Cloud platform 324 can include a variety of cloud-based services and/or applications configured to store, process, analyze, or otherwise consume the data collected from gateway device 302. Cloud platform 324 may be accessed by various users (e.g., enterprise users, mechanical contractors, cloud application users, etc.) via control applications. Some users can access and interact with gateway device 302 directly via client devices 304 (e.g., via a UI provided locally by gateway device 302), whereas other users can interact with cloud platform 324 (e.g., via a UI provided by cloud platform 324). Users can interact with cloud platform 324 via control applications configured to display the building data and provide a user with control of the gateway device 302. The features of cloud platform 324 and gateway device 302 are described in greater detail below.

Gateway device 302 can provide a user interface for any device containing an equipment model. Building equipment such as thermostat controller 334 can provide their equipment models to gateway device 302 via system bus 330. In some embodiments, gateway device 302 automatically creates equipment models for connected devices that do not contain an equipment model (e.g., non-smart equipment, legacy equipment, third-party equipment, etc.). For example, gateway device 302 can create an equipment model for any device that responds to a device tree request. In some embodiments, gateway device 302 can create an equipment model for any device that responds to a read object list attributes request. The equipment models created by gateway device 302 can be stored within gateway device 302 and/or transferred to cloud platform 324. Gateway device 302 can then provide a user interface for devices that do not contain their own equipment models using the equipment models created by gateway device 302. In some embodiments, gateway device 302 stores a view definition for each type of equipment connected via system bus 330 and wireless system bus 332 and uses the stored view definition to generate a user interface for the equipment.

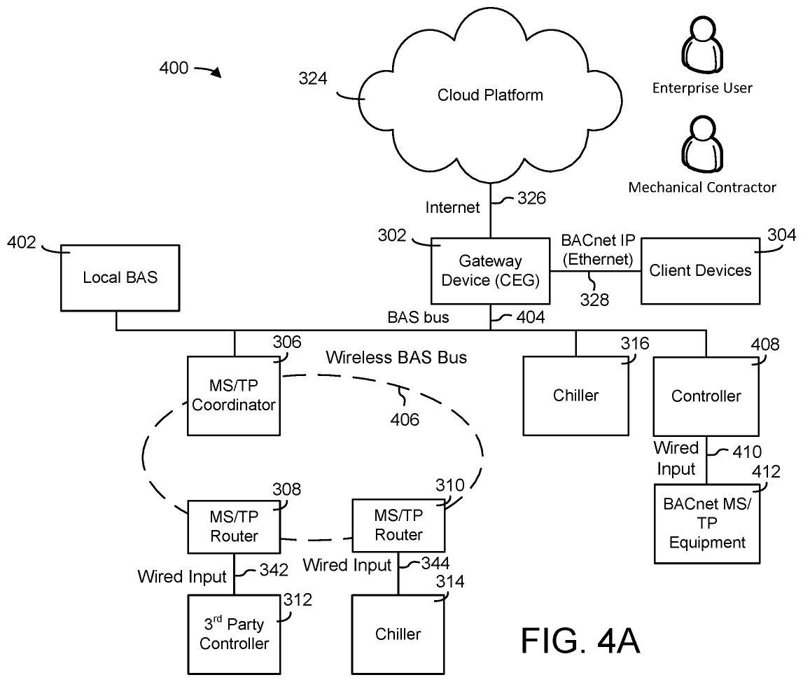

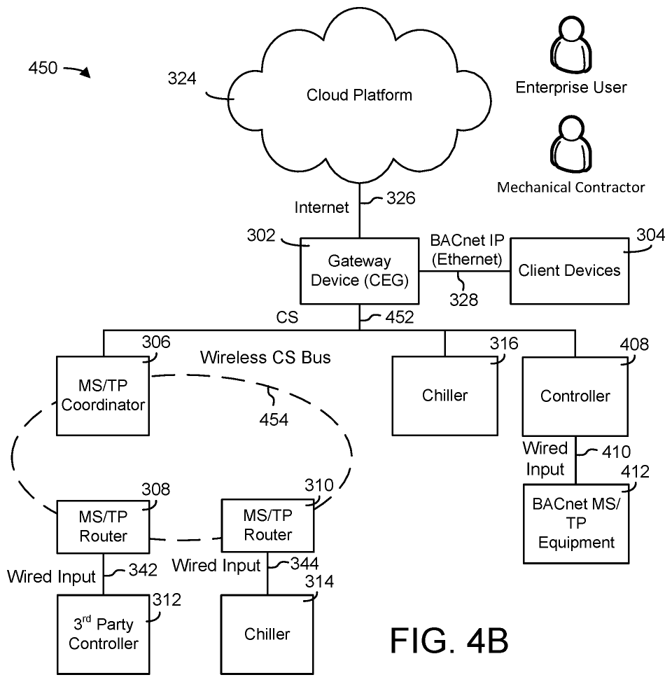

Referring now to FIG. 4A, a block diagram of BMS 400 is shown, according to an exemplary embodiment. In some embodiments, BMS 400 may include some or all of the features of BMS 300, as described with reference to FIG. 3. BMS 400 is shown to include gateway device 302 connected via BAS bus 404 to MS/TP coordinator 306. BMS 400 is shown to also include gateway device 302 connected over BAS bus 404 to chiller 316, and controller 408. MS/TP coordinator 306 can be connected via wireless BAS bus 406 to MS/TP routers 308 and 310. MS/TP router 308 is connected to controller 312 via wired input 342 and MS/TP router 310 is connected to chiller 314 via wired input 344. Controller 312 can act as an intermediary to connect MS/TP router 310 to other building equipment. As explained above with reference to FIG. 3, the MS/TP coordinator 306 and MS/TP routers 308, and 310 create a wireless system bus 332 for connecting the gateway device 302 to controller 312 and chiller 314 as though they were connected to gateway device 302 directly over BAS bus 404. Wireless BAS bus 406 may be transparent so that the gateway device 302 and the chillers 314 are unaware of the wireless connection. In some embodiments, a local building automation system (BAS) 402 is also connected to gateway device 302 via BAS bus 404. Gateway device 302 can connect to devices and local BAS 402 on the BAS trunk (e.g., system bus 330) when a local BAS 402 is present by daisy chaining with any of the MS/TP controllers on the BAS trunk 404 and communicate using the BACnet MS/TP protocol.

Referring now to FIG. 4B, a block diagram of BMS 450 is shown, according to an exemplary embodiment. BMS 450 may include some or all of the features of BMS 400 as described above with reference to FIG. 4A. BMS 450 illustrates a BMS without a local BAS. Gateway device 302 may connect to MS/TP controllers on a private connected services (CS) bus 452 instead of BAS trunk 404 as shown in FIG. 4A. BMS 450 can be configured according to the networks provided in the Appendix H and in U.S. application Ser. No. 17/374,135, filed Jul. 13, 2021 and incorporated herein by reference in its entirety.

### Gateway Device

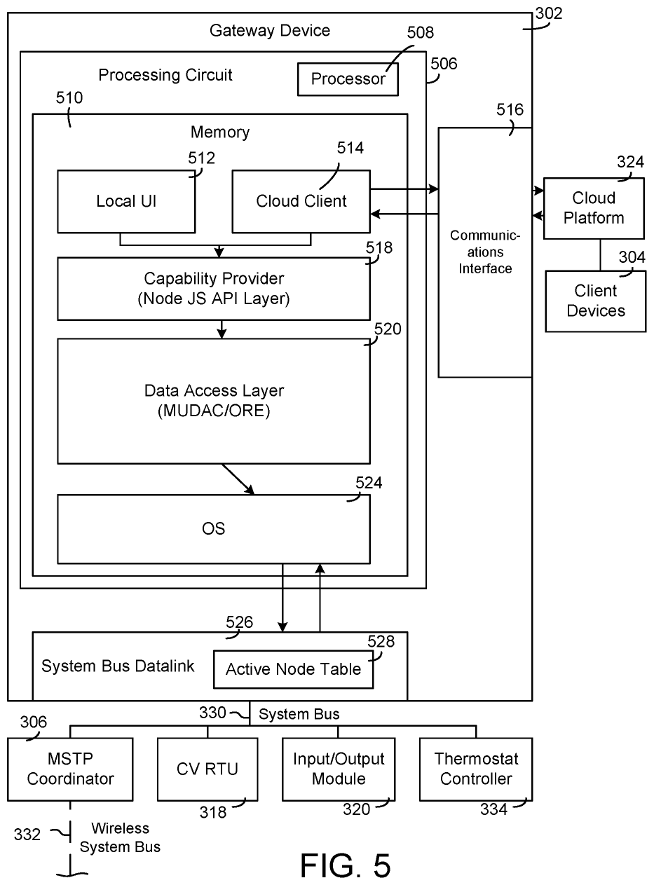

Referring now to FIG. 5, a block diagram illustrating gateway device 302 of BMS 300 in further detail is shown, according to an exemplary embodiment. Gateway device 302 is shown to include a system bus datalink 526, a communications interface 516, and a processing circuit 506. System bus datalink 526 can connect to system bus 330 and can be used by gateway device 302 to communicate with various other devices connected to system bus 330/340 and/or wireless system bus 332. In some embodiments, system bus datalink connects to data access layer 520. In some embodiments, system bus datalink is a component of data access layer 520. System bus datalink 526 can be used to communicate with chiller 316, CV RTU 318, IO controller 320, and/or thermostat controller 334 via system bus 330. System bus datalink 526 may also connect to MS/TP coordinator 306 via system bus 330, which in turn connects system bus datalink 526 to wireless system bus 332. For example, referring back now to FIG. 3, wireless system bus 332 may connect to MS/TP routers 308 and 310 which in turn connect to wireless system bus devices such as controller 312 and chiller 314, effectively connecting gateway 302 to controller 312 and chiller 314 as if they were connected via system bus 330. In other embodiments, MS/TP coordinator may be directly connected to system bus datalink 526 bypassing system bus 330.

In some embodiments, the automatic equipment discovery is based on an active node tables for system bus 330. Still referring to FIG. 5, for example, gateway device 302 is shown to include active node table 528. In embodiments where MS/TP coordinator 306 is connected directly to gateway device 302 and wireless system 332 is separate from system bus 330, there may be separate node tables for wireless system bus 332 and system bus 330. Referring back to FIG. 5, active node table 528 provides status information for the devices connected to system bus 330 and wireless system bus 332. For example, active node table 528 can indicate which building equipment (e.g., MS/TP devices) are participating in the token ring used to exchange information via system bus 330 and/or wireless system bus 332. In some embodiments, active node table 528 is a table in the form of an array of bytes. The location of each byte in active node table 528 may represent the token ring participation status of a particular node or device. Devices connected to system bus 330 and wireless system bus 332 can be identified by MAC address (or any other device identifier) in active node table 528. Advantageously, active node table 528 can list the MAC addresses of the devices connected to system bus 330 and wireless system bus 332 without requiring the devices to be placed in discovery mode.

The active node table can be stored within one or more devices connected to the system bus 330. For example, as shown in FIG. 5, active node table 528 can be stored within gateway device 302. In some embodiments, active node table 528 includes a change counter attribute. Each time a change to active node table 528 occurs (e.g., a new device begins communicating on system bus 330 and/or wireless system bus 332), the change counter attribute can be incremented by system bus datalink 526. Other objects or devices interested in the status of active node table 528 can subscribe to a change of value (COV) of the change counter attribute. When the change counter attribute is incremented, system bus datalink 526 can report the COV to any object or device that has subscribed to the COV. For example, data access layer 520 can subscribe to the COV of the change counter attribute and can be automatically notified of the COV when a change to active node table 528 occurs. In response to receiving the COV notification, data access layer 520 can read active node table 528 and discover the new device. Data access layer 520 can use the information from active node table 528 to generate a list of devices connected to system bus 330 and wireless system bus 332 (e.g., equipment list). Data access layer 520 can store the equipment list in gateway device 302. In some embodiments, the equipment list can be additionally and/or alternatively transmitted to and stored in cloud platform 324.

The equipment list generated by gateway device 302 can include information about each device connected to system bus 330 and wireless system bus 332 (e.g., device type, device model, device ID, MAC address, device attributes, etc.). When a new device is detected on system bus 330 and/or wireless system bus 332, gateway device 302 can automatically update the equipment list. Gateway device 302 can provide the updated equipment list to cloud platform 324. In some embodiments, if cloud platform 324 is missing an equipment model template for building equipment listed in the equipment list, it may request the equipment model template from gateway device 302. Gateway device 302 can retrieve the equipment model from the device if the device stores its own equipment model. If the device does not store its own equipment model, gateway device 302 can retrieve a list of point values provided by the device. Gateway device 302 can then use the equipment model and/or list of point values to generate an equipment model template for the device. Gateway device 302 may present information about the connected devices on system bus 330 and wireless system bus 332 to a user. Several examples of automatic equipment discovery and equipment model distribution can be found in commonly owned U.S. patent application Ser. No. 16/844,328 filed Apr. 9, 2020, the entire disclosure of which has been incorporated by reference herein.

Still referring to FIG. 5, processing circuit 506 is shown to include a processor 508 and memory 510. Processor 508 can be a general purpose or specific purpose processor, an application specific integrated circuit (ASIC), one or more field programmable gate arrays (FPGAs), a group of processing components, or other suitable processing components. Processor 508 is configured to execute computer code or instructions stored in memory 510 or received from other computer readable media (e.g., CDROM, network storage, a remote server, etc.).

Memory 510 can include one or more devices (e.g., memory units, memory devices, storage devices, etc.) for storing data and/or computer code for completing and/or facilitating the various processes described in the present disclosure. Memory 510 can include random access memory (RAM), read-only memory (ROM), hard drive storage, temporary storage, non-volatile memory, flash memory, optical memory, or any other suitable memory for storing software objects and/or computer instructions. Memory 510 can include database components, object code components, script components, or any other type of information structure for supporting the various activities and information structures described in the present disclosure. Memory 510 can be communicably connected to processor 508 via processing circuit 506 and can include computer code for executing (e.g., by processor 508) one or more processes described herein. When processor 508 executes instructions stored in memory 510, processor 508 generally configures gateway device 302 (and more particularly processing circuit 506) to complete such activities.

Still referring to FIG. 5, gateway device 302 is shown to include a network interface, shown as communications interface 516. Communications interface 516 can facilitate communications between gateway device 302 and external systems, devices, or applications. For example, communications interface 516 can be used by gateway device 302 to communicate with client device 304 (e.g., a tablet, a laptop computer, a smartphone, a desktop computer, a computer workstation, etc.), monitoring and reporting applications, enterprise control applications, remote systems and applications, and/or other external systems or devices for allowing user control, monitoring, and adjustment to BMS 300 and/or gateway device 302.

Communications interface 516 can include wired or wireless communications interfaces (e.g., jacks, antennas, transmitters, receivers, transceivers, wire terminals, etc.) for conducting data communications with client device 304 or other external systems or devices. In various embodiments, communications conducted via interface 516 can be direct (e.g., local wired or wireless communications) or via a communications network (e.g., a WAN, the Internet). Communications interface 516 can conduct communication using a variety of network protocols (e.g., BACnet MS/TP, BACnet IP, MODbus, etc.). In various embodiments, communications can be conducted over various network types (e.g., a cellular network, Wi-Fi network, ZIGBEE network, etc.). For example, communications interface 516 can include an Ethernet card and port for sending and receiving data via an Ethernet-based communications link or network. In another example, communications interface 516 can include a Wi-Fi transceiver for communicating via a wireless communications network. In another example, communications interface 516 can include cellular or mobile phone communications transceivers. In one embodiment, communications interface 516 is a power line communications interface and/or an Ethernet interface. In some embodiments, client devices 304 can communicate directly to gateway device 302 via communications link 516 without going through cloud platform 324. For example, a user may be able to access gateway device 302 using local UI 512 via communications interface 516.

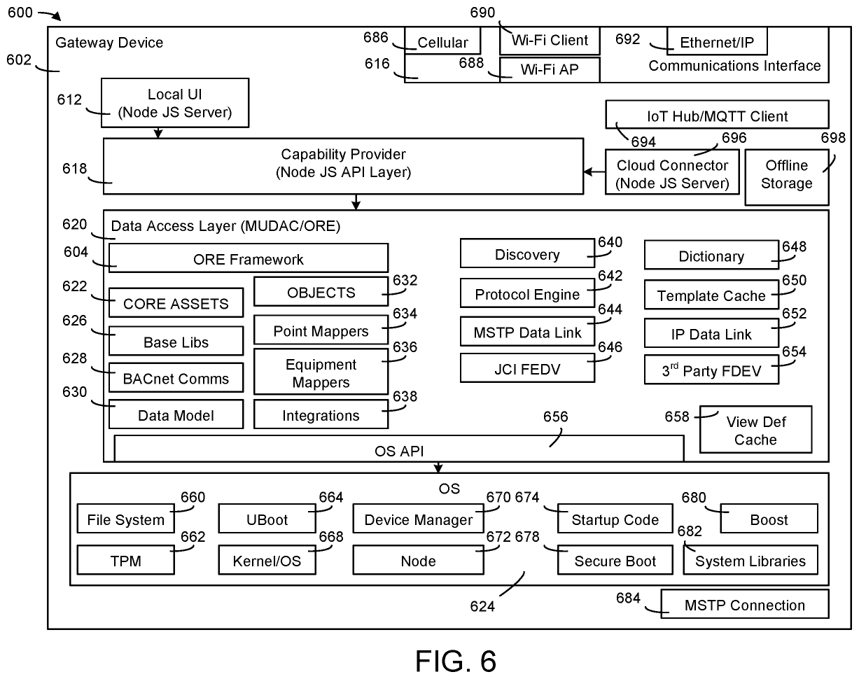

In some embodiments, the above network interfaces are components of communications interface 516. In some embodiments, the network interfaces require external network adapters to facilitate communicate over various networks. The external network adapters may be detachable network adapters. For example, the external network adapters may be USB “dongles” configured to provide network connectivity over USB to connected devices. Gateway device 302 can be configured to automatically operate a network adapter that is attached. The detachable external network adapters can connect to gateway device 302 via communications interface 516. For example, an external Wi-Fi adapter may connect to Wi-Fi client 690 shown in FIG. 6 of communications interface 516.

Referring now to FIG. 6, a block diagram of a gateway device 602 in greater detail is shown, according to an exemplary embodiment. Gateway device 302 may include all or some of the features and components of gateway device 602. For example, cloud client 514 of gateway device 302 can include IoThub/MQTT Client 694 and cloud connector 696. Data access layer 620 may include objects such as ORE framework 604, core assets 622, discovery module 640, dictionary 648, OS API 656 etc. OS 524 of gateway device 302 can include some or all of the components of OS 624. For example, OS 624 is shown to include various components such as file system 660, and Uboot 644, among others. In some embodiments, system bus datalink 526 shown in FIG. 5 may be a part of communications interface 616.

Still referring to FIG. 6, communications interface 616 is shown to include cellular module 686, Wi-Fi access point (AP) 688, Wi-Fi client 690, and Ethernet/IP module 692. In some embodiments, gateway device 302 is configured with network adapters as components of communication interface 616. Communications interface 616 can include a Wi-Fi client 690 and Wi-Fi access point (AP) 688 for communicating via a wireless communications network. Communications interface 616 can include cellular or mobile phone communications transceivers, shown as cellular module 686 for communicating directly via a cellular network. Communications interface 616 can include Wi-Fi access point (AP) 688 and Wi-Fi client 690. Wi-Fi AP 688 may be used by client devices to connect to gateway device 302. Wi-Fi client 690 may be configured to connect gateway device 602 to a cloud platform. In one embodiment, communications interface 616 includes a power line communications interface and/or an Ethernet interface, shown as Ethernet/IP 692. In some embodiments, MS/TP connection 684 is a component of communications interface 616. MS/TP connection 684 can facilitate communication between gateway device 602 and building equipment on a system bus. In some embodiments, MS/TP connection 684 may include some or all of the features of system bus datalink 526 of FIG. 5.

Communications interface 616 of gateway device 602 allows configuring and operating building equipment of BMS 300 that may each operate on various and possible distinct networks all from a single gateway device. The single gateway can eliminate the need for intermediate controllers associated with specific networks that handle only building equipment on that network. Gateway device 302 can also eliminate the need to connect all building equipment over a wired interface as it combines both a wired and wireless MS/TP connection interface in a single device.

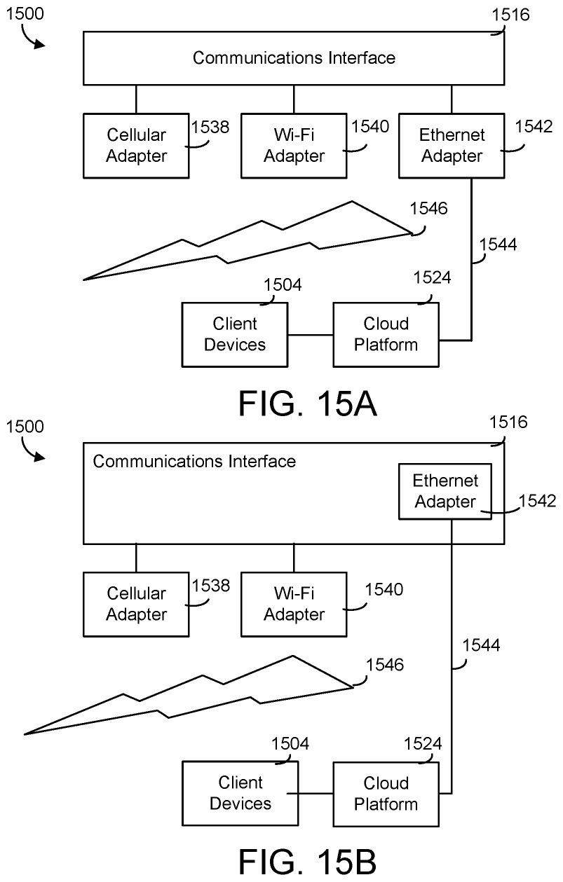

Referring now to FIGS. 15A and 15B, block diagrams of a communications interface for a BMS 1500 are shown, according to exemplary embodiments. Communications interface 1516 may include some or all components of communications interfaces 516 and 616. Communications interface 616 may connect to external, detachable network adapters. The external detachable network adapters may be configured to connect to and/or replace one or more of cellular 686, Wi-Fi client 690, and Ethernet/IP 692 shown in FIG. 6. The detachable network adapters can include cellular adapter 1538, Wi-Fi adapter 1540 and Ethernet adapter 1542. In some embodiments, the external network adapters are connected to communications interface 1516 via wired connections such as USB connections. In some embodiments, communications interface 1516 may also connect to an external detachable network adapter configured to operate over a ZIGBEE network. In some embodiments, each detachable network adapter is configured to provide connectivity over a single wireless network. In some embodiments, a detachable network adapter may provide wireless connectivity over multiple wireless networks (e.g., Wi-Fi, cellular, Zigbee, etc.).

Detachable network adapters allow gateway device 302 to function with over networks in the local region of the BMS which may have regional-specific network protocols. The same gateway device 302 can operate in various regions with independent network protocols by swapping a detachable network adapter configured to operate in Region A with another detachable network adapter configured to operate in Region B. In some embodiments, the detachable network adapters are installed by a local installer or user. For example, the cellular adapter 1538 can be attached to communications interface 1516 by an installer of the BMS. Cellular adapter 1538 may be preconfigured to operate according to regional regulations and protocols that apply to the BMS. Cellular adapter 1538 can be included on a separate device that is configured to connect with communications interface 1516 and operate automatically. In some embodiments, one or more of the network adapters can be included as components of communications interface 1516. For example, referring specifically to FIG. 15B, Ethernet adapter 1542 can be a component of communications interface 1516.

In some embodiments, communications interface 1516 is connected to just a single network adapter. For example, communications interface 1516 can be connected to only Ethernet adapter 1542. In some embodiments, communications interface 1516 can be connected to a plurality of network adapters. For example, communications interface 1516 can include Ethernet adapter 1542 and Wi-Fi adapter 1540. In some embodiments, communications interface can include cellular adapter 1538, Wi-Fi adapter 1540, and Ethernet adapter 1542. It should be understood by those of ordinary skill in the art that any combination of network adapters may be used by gateway device 302. In some embodiments, gateway device 302 is connected to a plurality of network adapters, and a user, either via local UI 512 or cloud platform 324 can direct gateway device 302 to use a specific network adapter. Any network not selected may be disabled. In some embodiments, the Wi-Fi AP 688 may still operate to allow a user to connect directly to the gateway device despite Wi-Fi adapter 1540 being disabled. In some embodiments, a gateway device, such as gateway device 302, automatically chooses a network adapter to operate over. In some embodiments, there may be a pre-installed hierarchy. For example, gateway device 302 can be configured to operate over Ethernet, then Wi-Fi, then cellular in that order. Depending on which detachable network adapters are connected to communications interface 1516, gateway device can operate them in order of priority. In some embodiments, the hierarchy may be set by a user. Still in other embodiments gateway device 302 operates over a chosen network adapter and automatically switches to another network adapter when the connection provided by the chosen network adapter fails.

In some embodiments, gateway device 302 can communicate with via a communications interface, such as communications interface 1516 cloud platform 324 over Ethernet adapter 1542 while communicating with client devices 1504 via Wi-Fi adapter 1540 and/or cellular adapter 1538. In some embodiments, client devices 1504 connect to gateway device 302 via cloud platform 1524 as shown in FIGS. 15A and 15B. Still in other embodiments client devices 1504 connect to gateway device 302 directly through wireless connection 1546. For example, referring again to FIG. 6, clients devices can connect to gateway device 302 via Wi-Fi AP 688 while gateway device 302 is communicating to cloud platform 324 via a different network interface (e.g., Ethernet, cellular, etc.).

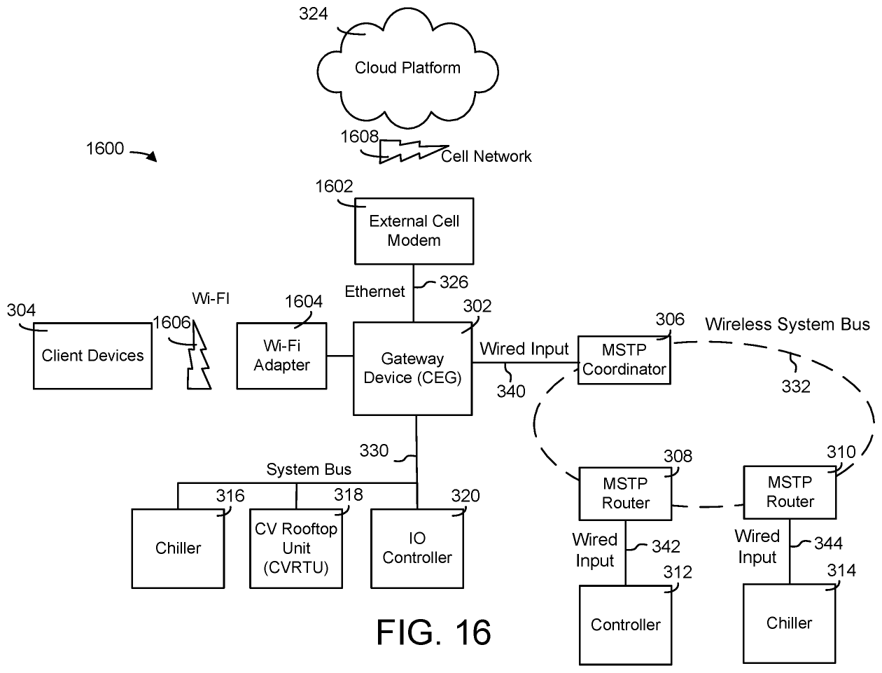

Referring now to FIG. 16, a block diagram of a BMS which can be used to monitor and control the building and HVAC system of FIGS. 1-2 is shown, according to an exemplary embodiment. BMS 1600 may include some or all of the features of BMS 300, as described with reference to FIGS. 3-7. For example, BMS 1600 is shown to include gateway device 302, cloud platform 324, Wi-Fi adapter 1604, system bus 330, wireless system bus 332 and building equipment connected via the system buses to gateway device 302. BMS 1600 illustrates an example BMS that uses Ethernet connection 326 to connect gateway device 302 to cloud platform 324. Gateway device 302 can communicate building data from the connected building equipment (e.g., chiller 314, chiller 316) to cloud platform 324 via Ethernet connection 326. In some embodiments, Ethernet connection 326 connects gateway device 302 to cloud platform 324 via an intermediate external cell modem 1602. Ethernet connection 326 can be configured by local UI 512.

Still referring to FIG. 16, client devices 304 may connect with gateway device 302 over Wi-Fi, using for example Wi-Fi adapter 1604, even while gateway device 302 is communicating with cloud platform 324 using Ethernet 326 may still connect to gateway device 302 via a Wi-Fi adapter 1604 and/or the Wi-Fi AP 688 shown in FIG. 6 as a component of communications interface 616. In some embodiments, BMS 1600 further include other network adapters connected to gateway device 302 (e.g., a detachable cellular adapter, etc.). In some embodiments, the network adapters are detachable network adapters than be swapped in and out by a user and/or installer to provide gateway device 302 with the ability to communicate over additional networks. In some embodiments, Wi-Fi adapter 1604 and and/or any other network adapters not being used to communicate building data to cloud platform 324 are disabled while Ethernet connection 326 is active. In some embodiments, Ethernet connection 326 connects directly to Ethernet/IP client 646. In some embodiments, Ethernet connection 326 connects to a detachable Ethernet adapter, shown as Ethernet 542 in FIG. 15A.

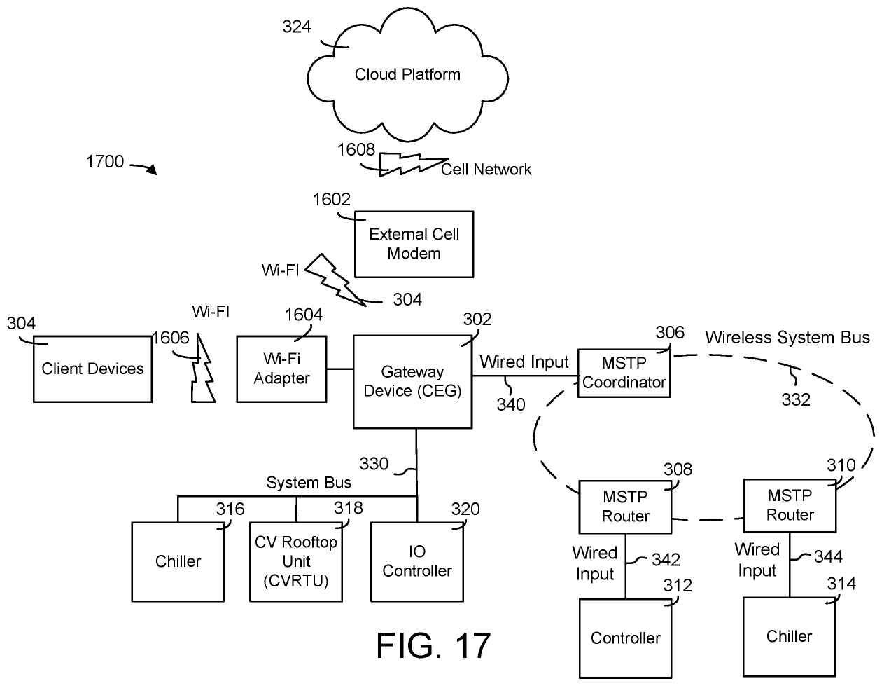

Referring now to FIG. 17, a block diagram of a BMS which can be used to monitor and control the building and HVAC system of FIGS. 1-2 is shown, according to an exemplary embodiment. BMS 1700 may include some or all of the features of BMS 300, as described with reference to FIGS. 3-7. For example, BMS 1700 is shown to include gateway device 302, cloud platform 324, Wi-Fi adapter 1604, system bus 330, wireless system bus 332, and building equipment connected via the system buses to gateway device 302. BMS 1700 illustrates an example BMS that uses Wi-Fi adapter 1604 to facilitate communication of building data from gateway device 302 to cloud platform 324. In some embodiments, Wi-Fi adapter 1604 is a detachable Wi-Fi adapter. For example, Wi-Fi adapter 1604 may be a USB Wi-Fi dongle configured to provide Wi-Fi connection to connected devices.

In some embodiments, Wi-Fi adapter 1604 is connected to external cell modem 1602. External cell modem 1602 can then connect to cloud platform 324 via cell network 1608. In some embodiments, multiple gateway devices of a BMS can connect to a single external cell modem 1602. Using Wi-Fi adapter 1604 and Wi-Fi client 690 (shown in FIG. 6), gateway device 302 can communicate to cloud platform 324 wirelessly via external cell modem 1602 and cell network 1608. In some embodiments, gateway device 302 can use Wi-Fi client 690 to communicate with cloud platform 324 while still allowing client devices 304 to communicate to gateway device 302 over Wi-Fi AP 688. In some embodiments, the Ethernet and cell adapter interfaces are disabled while the Wi-Fi interface is in use.

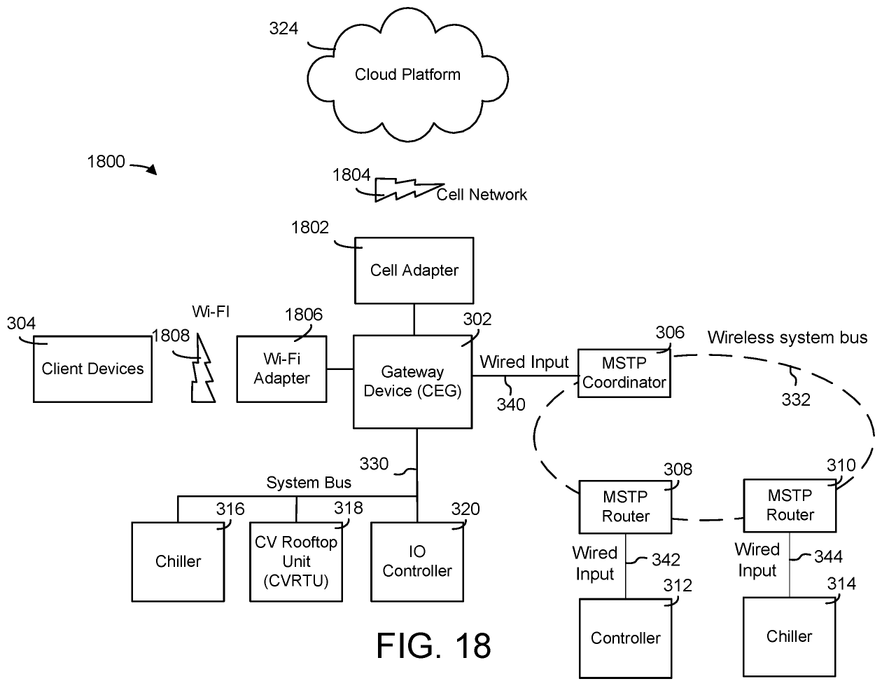

Referring now to FIG. 18, a block diagram of a BMS which can be used to monitor and control the building and HVAC system of FIGS. 1-2 is shown, according to an exemplary embodiment. BMS 1800 may include some or all of the features of BMS 300, as described with reference to FIGS. 3-7. For example, BMS 1800 is shown to include gateway device 302, cloud platform 324, Wi-Fi adapter 1604, cell adapter 1802, system bus 330, wireless system bus 332, and building equipment connected via the system buses to gateway device 302. BMS 1800 illustrates an example BMS that communicates building data directly from gateway device 302 to cloud platform 324 without intermediate external cell modem 1602. BMS 1800 is shown to include gateway device 302 connected to cell adapter 1802. Cell adapter 1802 can be a detachable cellular adapter such as a direct on-board cell modem USB dongle with a SIM card configured to provide cellular internet connectivity to cloud platform 324. In some embodiments, cellular adapter 1802 includes a remote antenna. Gateway device 302 can be configured to operate cellular adapter 1802 automatically. Cell adapter 1802 can be configured via local UI 512 of gateway device 302.

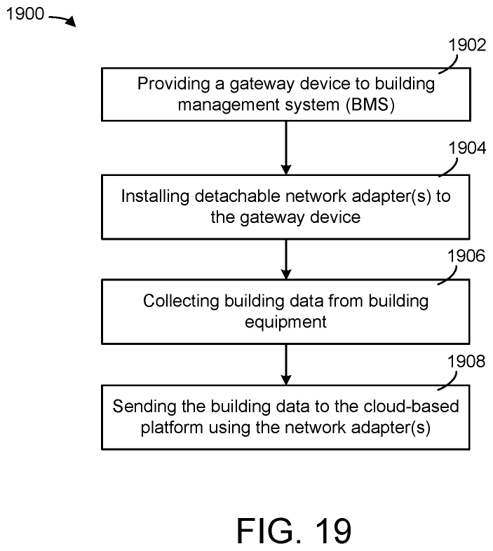

Referring now to FIG. 19, a flow chart illustrating process 1900 for operating gateway device 302 with detachable network adapters is shown, according to an exemplary embodiment. Process 1900 can be performed by one or more components of BMS 300. In some embodiments, process 1900 is performed by gateway device 302. Process 1900 is shown to include providing a gateway device to a BMS (step 1902). Multiple gateway devices may be provided to a single BMS. Each gateway device can be connected to distinct sets of building equipment. The gateway devices can connect to building equipment of the BMS over a wired or wireless MS/TP bus. Process 1900 is shown to include installing a detachable network adapter to gateway device 302 (step 1904). In some embodiments, multiple detachable network adapters may be connected to gateway device 302. The detachable network adapters may connect to gateway device 302 via USB. In some embodiments the detachable network adapters each connect gateway device 302 to various networks. For example, a detachable Wi-Fi adapter, a detachable cellular adapter, and a detachable Ethernet adapter may each individually or any combination thereof be connected to gateway device 302. In some embodiments, a single detachable network adapter may facilitate communication over a plurality of networks. The detachable network adapters may be provided by a local user and/or installer. The detachable network adapters may be pre-configured to operate according to the geographic region's network regulations. Accordingly, gateway device 302 can operate in various regions by being connected to various detachable network adapters without having to modify gateway device 302 itself. For example, Region A may operate over a 4G network while Region B may operate over a 5G network. The same gateway device may operate in either region by simply being connected to a detachable network adapter pre-configured for that region.

Process 1900 is shown to include collecting building data from building equipment (step 1906). The building data may include equipment models, BACnet value objects, BACnet point objects, view definitions, COV data, and/or any other data available from building equipment. The gateway device may collect the data over a wired and/or wireless system bus. The system bus may be an MS/TP system bus using the BACnet MS/TP protocol.

Process 1900 is shown to include sending the building data to a cloud-based platform using the attached network adapter(s) (step 1908). Gateway device 302 may stream the collected data to cloud platform 324. In some embodiments, gateway device 302 stores the collected data in a local buffer and sends it periodically. In some embodiments with multiple network adapters attached to gateway device 302, gateway device 302 may send the building data over a single network selected by a user. For example, a user may select a network to use via local UI 512. In some embodiments, the user may select the appropriate network via cloud platform 324.

### Data Access Layer

Referring again to FIG. 5, components included in memory 510 may include local UI 512, cloud client 514, capability provider (CP) 518, data access layer 520, and OS 524. Local UI 512 may allow a user to control building equipment connected to gateway device 302. In some embodiments, local UI 512 may generate a web interface (e.g., a webpage) for displaying building data (e.g., equipment model templates, view definitions, data control templates, etc.) to a user. An example of an interactive web interface that can be generated by local UI 512 based on a stored view definition and/or equipment list is described in detail in U.S. patent application Ser. No. 15/146,660 titled “HVAC Equipment Providing a Dynamic Web Interface systems and Methods” and filed May 4, 2016, the entire disclosure of which is incorporated by reference herein. CP 518 may be an application configured to facilitate communication between local UI 512 and cloud client 414 with data access layer 520.

Still referring to FIG. 5, gateway device 302 is shown to include a data access layer 520. In some embodiments, data access layer 520 is comprised of various objects shown in FIG. 6 (e.g., data model 630, point mappers 634, equipment mappers 636, protocol engine 642, etc.). Referring again to FIG. 5, data access layer 520 can be configured to perform the equipment detection and data gathering operations described above. Data access layer 520 can be configured to identify building equipment (e.g., chiller 314, chiller 316, CV TRU 318) in BMS 300 and generate or obtain equipment models for the building equipment. For example, data access layer 520 can discover and collect data from MS/TP coordinator 306 (and associated building devices on wireless system bus 332), CV RTU 318, IO module 320, and thermostat controller 334. Data access layer 520 can also discover data points provided by the building equipment and obtain values for the data points (e.g., building data) from the equipment.

In some embodiments, data access layer 520 can sign up or subscribe to a change in value (COV) of the change counter attribute of active node table 528. In some embodiments, active node table 528 is a part of data access layer 520. When a change to active node table 528 occurs, system bus datalink 526 can provide a COV notification to data access layer 520. In response to receiving the COV notification, data access layer 520 can read active node table 528. Data access layer 520 can use the information from active node table 528 to identify building equipment connected to gateway 302 and generate a list of identified devices (e.g., equipment list). The equipment list can be stored in data access layer 520 and/or provided to cloud client 514 to be pushed to cloud platform 324.

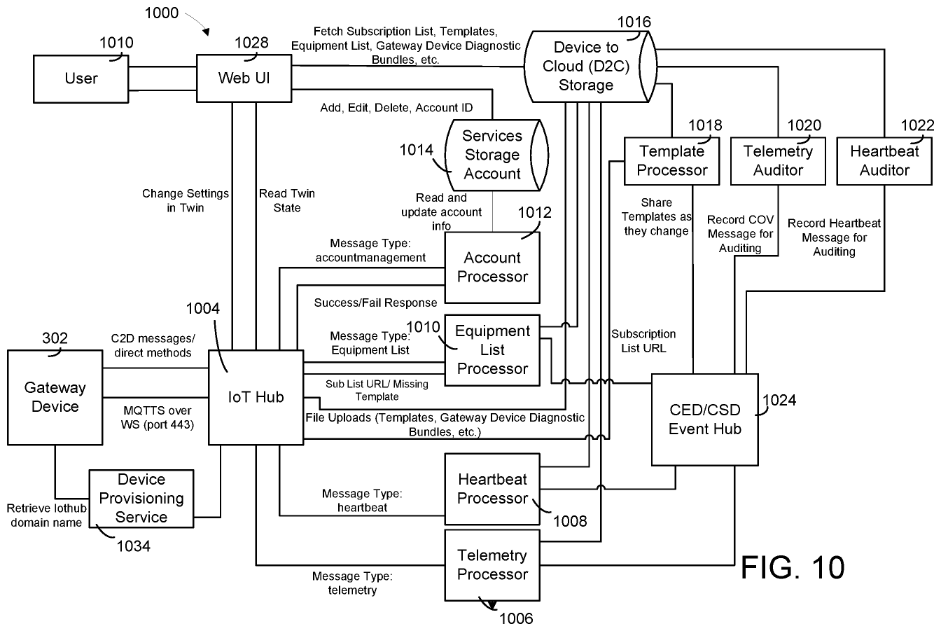

In some embodiments, gateway device 302 can collect and send COV data to cloud platform 324. Throughout this disclosure COV data may also be referred to as “telemetry data.” Data access layer 520 can receive from cloud platform 324 a subscription list for the building equipment identified in the equipment list. The subscription list may be included as part of a device twin generated by cloud platform 324. The device twin is explained in further detail below with reference to FIG. 10. The subscription list may include a list of bound properties (e.g., value objects, point objects, etc.) for building equipment in BMS 300 that the cloud platform 324 requests data for. Data access layer 520 may sign up or subscribe to a COV in the subscription list. An example of a subscription list may be found in Appendix A. When a change to bound property occurs, a COV notification can be provided to data access layer 520. In response to receiving the COV notification, data access layer 520 can read the bound property and post a sample of the bound property to cloud platform 324.

In some embodiments, data access layer 520 can provide the collected data to capability provider 518 for use in presenting the data to a user (e.g., via local UI 512) or pushing the data to cloud platform 324 (e.g., via cloud client 514). Capability provider 518 can be configured to function as a feature server for gateway device 302. Capability provider 518 can be connected to data access layer 520, cloud client 514, and local UI 512 and can process the inputs and outputs of gateway device 302 (e.g., both device- and user-oriented). Capability provider 518 can interact with cloud platform 324 to serve various features of cloud platform 324 to gateway device 302. Features of cloud platform 324 served by capability provider 518 can include, for example, time series, alarms, schedules, write property, data model, system settings, and software update. Other features of cloud platform 324 served by capability provider 518 may include interlock, data share, audit, and fault detection and diagnostics (FDD). The features and functionality of cloud platform 324 are described in greater detail below. Several of these features are described further in U.S. patent application Ser. No. 16/844,328 filed on Apr. 9, 2020 the entire disclosure of which has been incorporated by reference herein.

Still referring to FIG. 5, data access layer 520 may receive a request for a view definition from local UI 512. The view definition may identify a set of attributes for a particular device that are core to the functionality of the device. Each device or type of device in BMS 300 may have a different view definition. For example, the view definition for a chiller controller may identify the chiller outlet temperature as an important data point; however, the view definition for a valve controller may not identify such a data point as important to the operation of the valve. In some embodiments, the view definition for a device identifies a subset of the data objects defined by the equipment model for the device. Local UI 512 may use the view definition to dynamically select a subset of the stored data objects for inclusion in a web interface (e.g., a webpage) generated by local UI 512.

In some embodiments, view definitions for all the devices in BMS 300 are stored within gateway device 302. In other embodiments, view definitions can be stored in the devices themselves (e.g., within thermostat controllers, RTUs, etc.). In some embodiments, view definitions are stored in cloud platform 324. In some embodiments, the view definition for a device is a component of the device's equipment model and is provided to gateway device 302 by connected devices along with the equipment models. For example, devices connected to system bus 330 and/or wireless system bus 332 can provide their own view definitions to gateway device 302.

If a device does not provide its own view definition, gateway device 302 can create or store view definitions for the device. If the view definition provided by a particular device is different from an existing view definition for the device stored in gateway device 302, the gateway device's view definition may override or supersede the view definition provided by the device. In some embodiments, the view definition for a device includes the device's user name and description. Accordingly, the web interface generated by local UI 512 can include the device's user name and description when the web interface is generated according to the view definition.

### Equipment Model Generation

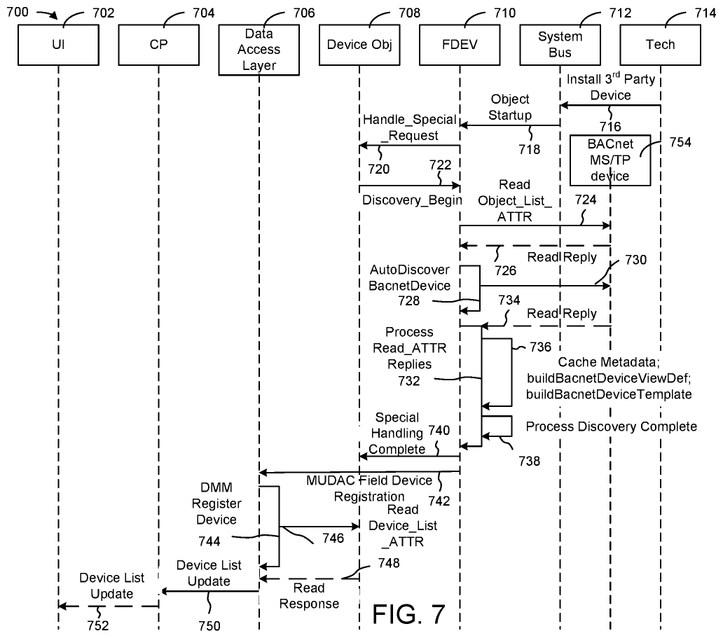

Referring now to FIG. 7, a sequence diagram illustrating a process 700 for automatically discovering and interacting with equipment in a building management system that does not have a pre-existing equipment model, according to an exemplary embodiment. Gateway device 302 of BMS 300 can automatically discover new equipment connected via system bus datalink 526 to system bus 330 and/or wireless system bus 332 as discussed above with reference to data access layer 520. Advantageously, the equipment discovery can occur automatically (e.g., without user action) and without requiring the equipment to be placed in discovery mode or sending a discovery command to the equipment. An equipment model can be composed of equipment template and a view definition associated with a given MS/TP device. Some devices lack pre-installed equipment models, and process 700 can generate equipment models for the gateway device 302 to operate the devices with. Process 700 can be performed by one or more components of BMS 300 to automatically discover building equipment on system bus 330 and wireless system bus 332. For example, process 700 can be performed by various components of gateway device 302 (e.g., user interface (UI) 702, capability provider (CP) 704, a data access layer 706, device object 708, FDEV 710, system bus 712, BACnet MS/TP device 754) and/or parts of the total BMS 300 system such as tech 714.

Process 700 is shown to include tech 714 installing a BACnet MS/TP device on the system bus 712 (step 716). The BACnet MS/TP device 754 may be a third-party controller, third-party RTU controller and/or any other BACnet device that does not have an equipment model for gateway device 302 to download. The BACnet MS/TP device 754 may be an MS/TP master device. System bus 712 can be a wired MS/TP bus such as system bus 330 and/or wireless such as wireless system bus 332. System bus 712 connects to gateway device 302 and allows gateway device 302 to communicate and/or control building equipment connected to system bus 712. System bus 712 can send an object startup message to FDEV 710 (step 718). FDEV 710 may be a part of data access layer 520 of gateway device 302. FDEV 710 can then communicate with device object 708 to “handle special request” (step 720) and device object 708 can send a message to initiate discovery back to FDEV 710 (step 722). In some embodiments, process 700 may also include polling a connected MS/TP coordinator such as MS/TP coordinator 306 to identify new MS/TP devices on a wireless MS/TP bus when one is used. FDEV 710 can then read the object list of BACnet MS/TP device 754. The object list may include the list of all BACnet exposed objects (e.g., value objects, point objects, etc.) BACnet MS/TP device 754 chooses to make available. The objects may include Analog Inputs, Analog Outputs, Analog Values, Binary Inputs, Binary Outputs, Binary Values, Multi-State Inputs, Multi-State Outputs, and Multi-State Values. For some devices such as JCI BACnet equipment, FDEV 710 may read the object list by sending a “GET_DEVICE_TREE” command to BACnet MS/TP device 754 instead, and receive an object list composed of additional objects not made available using the read command. FDEV 710 then accepts the object list from BACnet MS/TP device 754 (step 726).

Process 700 is shown to include FDEV 710 automatically discovering BACnet device(s) using the object list passed to it (step 728). This process can include reading the metadata for the objects from BACnet MS/TP device 754 (step 730). FDEV 710 can read the “object_list_ATTR” reply from BACnet MS/TP device 754 (step 732) and cache the metadata, build a BACnet device view definition, and build a BACnet equipment model template (step 936) based on the BACnet objects exposed by the BACnet MS/TP device 754. The view definition may be automatically generated using the object list of BACnet MS/TP device 754. The BACnet template can be populated with metadata from the BACnet device, or with pre-defined values based on the data type. The creation of a BACnet view definition and equipment model template is explained further below with reference to FIG. C.

FDEV 710 then ensures the read process 732 is complete (step 738) and informs device object 708 accordingly (step 740). Device object 708 can then send to data access layer 706 a field device registration (step 742). data access layer 706 can register the device in the data model manager (DMM) (step 744) which may involve reading the “Device list ATTR” from device object 708 (step 746) and receiving a response (step 748). This process is explained in further detail below with reference to FIG. C. The device list may contain all devices from system bus 712, be they connected over a wired or wireless MS/TP bus, that have been mapped to the system. Data access layer 706 can then send an updated device list to CP 704 (step 750) which can pass it to UI 702 (step 752).

### Equipment Model Discovery

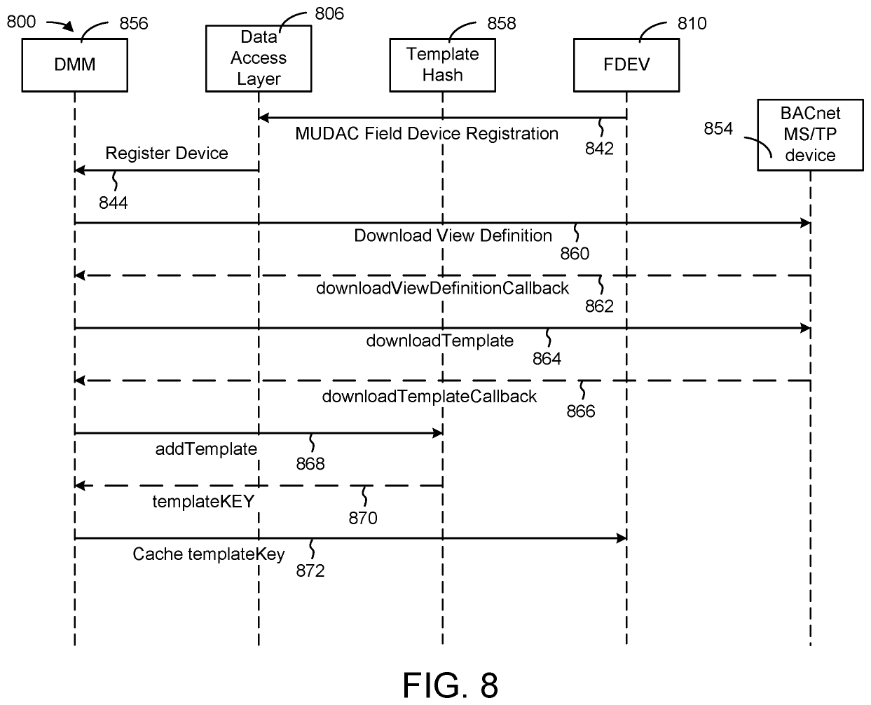

Referring now to FIG. 8, a sequence diagram illustrating process 800 for providing a view definitions and equipment templates from a BACnet device to a gateway device is shown, according to an exemplary embodiment. Process 800 can be performed by one or more components of BMS 300. For example, process 800 can be performed by various components of gateway device 302 (e.g., data module manager (DMM) 856, data access layer 806, template hash 858, FDEV 810, etc.) and BACnet MS/TP device 854. In some embodiments, process 800 is an alternative to process 700. Process 700 is shown to include components of gateway device 302 collecting creating view definitions and equipment model templates for building equipment (e.g., BACnet devices) without pre-existing ones and storing them and/or sending them to cloud platform 1000. In some embodiments, process 800 is an equivalent process for BACnet devices that have pre-existing view definitions and equipment model templates, such as SMART equipment devices manufactured by JCI.

Similar to process 700, process 800 may involve FDEV 810 sending a field device registration message to data access layer 806 (step 842), and further includes data access layer 806 registering the device to DMM 856 (step 844). Process 800 is shown to include DMM 856 requesting to download a view definition from BACnet MS/TP device 854. BACnet MS/TP device 854 can send the view definition to DMM 856 (step 862). DMM 856 is shown to then request to download the equipment model template from BACnet MS/TP device 854 (step 864) and BACnet MS/TP device 854 can respond by sending its pre-configured equipment model template (step 866). Each equipment model template may define a set of properties associated with a given device, and can be populated with metadata that is read from BACnet MS/TP device 854. An example equipment model template can be found in Appendix B. In some embodiments, the components of gateway device 302 performing process 800 may upload the received view definitions and equipment templates to the cloud, such as cloud platform 324. Cloud platform 324 may itself use the templates to fetch the metadata to fill the equipment model template.

DMM 856 can then add the template to template hash 858 (step 868), which can return a templateKEY to DMM 856 (step 870). The template key can then be cached in FDEV 810 (step 872), to be used to recall the equipment model template when needed.

### Equipment Model Processes

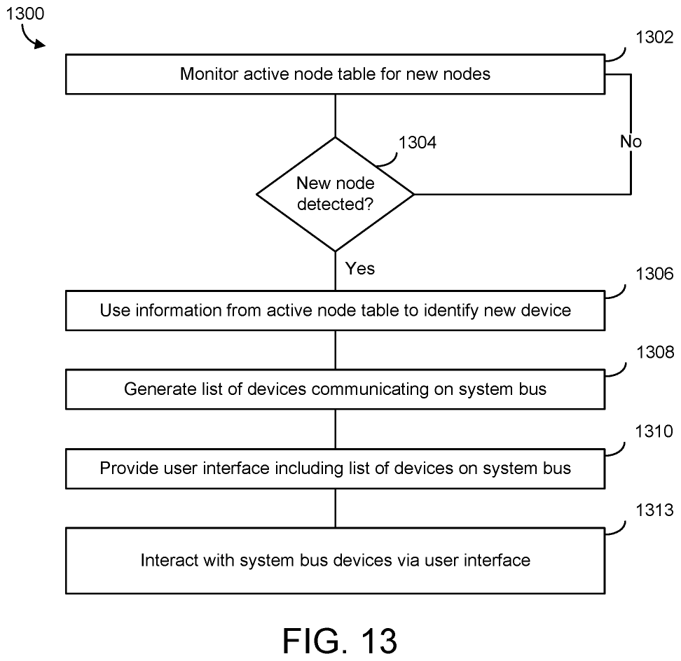

Referring now to FIG. 13, a flowchart of a process 1300 for automatically discovering and interacting with equipment in a building management system is shown, according to an exemplary embodiment. Process 1300 can be performed by one or more components of BMS 300. In some embodiments, process 1300 is be performed by gateway device 302. Process 1300 can be used to automatically discover devices communicating on system bus 330 and/or wireless system bus 332. Once the devices have been discovered, process 1300 can be used to generate a user interface (e.g., a web interface) which provides information about the devices and allows a user to monitor and control the devices.

Process 1300 is shown to include monitoring an active node table for new nodes (step 1302). In some embodiments, step 1302 is performed by gateway device 302. For example, gateway device 302 can monitor active node table 528 for new nodes. Each node in active node table 528 can represent a device communicating on system bus 330. In some embodiments, gateway device 302 monitors active node table 528 for new nodes by subscribing to a change of value (COV) of a change counter attribute for active node table 528. Each time a change to active node table 528 occurs (e.g., a new device begins communicating on system bus 330), the change counter attribute can be incremented by wired system bus datalink 526. When the change counter attribute is incremented, wired system bus datalink 526 can report the COV to data access layer 520.

Still referring to FIG. 13, process 1300 is shown to include determining whether a new node is detected (step 1304). In some embodiments, step 1304 is performed by gateway device 302. For example, data access layer 520 of gateway device 302 can read active node table 528 in response to receiving a COV notification indicating that active node table 528 has been updated. Data access layer 520 can compare the data from active node table 528 to a previous (e.g., cached) version of active node table 528 to determine whether any new nodes have been added. If a new node has been added to active node table 528, data access layer 520 can determine that a new node is detected (i.e., the result of step 1304 is “yes”) and process 1300 can proceed to step 1306. If a new node has not been added, process 1300 can return to step 1302.

Still referring to FIG. 13, process 1300 is shown to include using information from the active node table to identify the new device (step 1306). In some embodiments, step 1306 is performed by gateway device 302. For example, gateway device 302 can use address information (e.g., MAC addresses, network addresses, etc.) from active node table 528 to send a request for information to a new MS/TP bus device. The request can include a request for an equipment model stored within the new MS/TP bus device and/or a request for point values provided by the new MS/TP bus device (e.g., a get device tree request). In response to the request, the new MS/TP bus device may provide information that can be used to identify the device (e.g., device type, model number, types of data points, etc.). Gateway device 302 can identify the new MS/TP bus device based on such information.

Still referring to FIG. 13, process 1300 is shown to include generating a list of devices communicating on the system bus (step 1308). The system bus may include system bus 330 and/or wireless system bus 332. Step 1308 can be performed by data access layer 520 using information obtained from active node table 528 and/or information received from identified system bus devices.

Process 1300 is shown to include providing a user interface including the equipment list (step 1310). In some embodiments, step 1310 is performed by cloud platform 324. In some embodiments, step 1310 is performed by local UI 512 of gateway device 302. In some embodiments, local UI 512 uses a view definition for each device in the device list to determine which attributes of the devices to include in the web interface. In some embodiments, local UI 512 generates a home page for each type of equipment based on a home page view definition for the equipment type. The home page view definition can be stored in gateway device 302 (e.g., in view definition storage). Other view definitions can be stored in gateway device 302 or received from other devices at runtime.

Process 1300 is shown to include interacting with the system bus devices via the user interface (step 1312). Step 1312 can include accessing the equipment models for the system bus devices to obtain data values for display in the user interface. In some embodiments, step 1312 includes receiving input from a user via the user interface. The user input can change an attribute of a device (e.g., device name, setpoint, device type, etc.) presented in the user interface. Gateway device 302 can use the updated value of the device attribute to update the value in the equipment model for the device and/or to provide a control signal to the device.

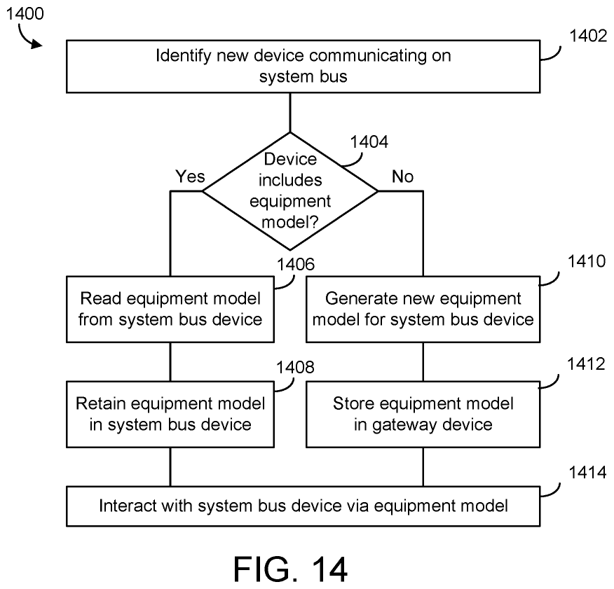

Referring now to FIG. 14, a flowchart of a process 1400 for automatically creating and using equipment models for system bus devices (e.g., devices connected to wired system bus 330 devices and/or wireless system bus 332) is shown, according to an exemplary embodiment. Process 1400 can be performed by one or more components of gateway device 302, as described with reference to FIGS. 3-5. In some embodiments, process 1400 is performed by gateway device 302 when new building equipment is detected on system bus 330 and/or wireless system bus 332.

Process 1400 is shown to include identifying a new device communicating on the system bus (step 1402). Step 1402 can include using address information (e.g., MAC addresses, network addresses, etc.) from active node table 528 to send a request for information to a new system bus device. The request can include a request for an equipment model stored within the new system bus device and/or a request for point values provided by the new system bus device (e.g., a get equipment list request). In response to the request, the new system bus device may provide information that can be used to identify the device (e.g., device type, model number, types of data points, etc.). Gateway device 302 can identify the new system bus device based on such information.

Process 1400 is shown to include determining whether the new system bus device includes an equipment model (step 1404). Some devices in BMS 300 present themselves to gateway device 302 using equipment models. An equipment model can define equipment object attributes, view definitions, schedules, trends, and the associated BACnet value objects that may also compose an equipment model template (e.g., analog value, binary value, multistate value, etc.) that are used for integration with other systems. Some system bus devices store their own equipment models (e.g., CV RTU 218, thermostat controller 334). Other devices in BMS 300 do not store their own equipment models (e.g., IO controller 320, third party controller 322, etc.). Step 1404 can include sending a request for an equipment model to the new system bus device or reading a list of point values provided by the new system bus device. If the new system bus device includes an equipment model, the system bus device may present an equipment model to gateway device 302 in response to the request.

If the system bus device includes an equipment model (i.e., the result of step 1404 is “yes”), gateway device 302 can read the equipment model from the system bus device (step 1406). Since the equipment model is already stored within the system bus device, the equipment model can be retained within the system bus device (step 1408). However, if the system bus device does not include an equipment model (i.e., the result of step 1404 is “no”), gateway device 302 can automatically generate a new equipment model for the system bus device (step 1410). In some embodiments, gateway device 302 retrieves a list of point values (e.g., BACnet objects) provided by the device and uses the list of point values to create a new equipment model for the device. The new equipment model can be stored within gateway device 302 (step 1412).

Process 1400 is shown to include interacting with the system bus device via the equipment model (step 1414). Step 1414 can include reading data values from the equipment model and writing data values to the equipment model. If the equipment model is stored in the system bus device, step 1414 can include interacting directly with the system bus device. However, if the equipment model is stored in gateway device 302, step 1414 can include interacting with gateway device 302. Gateway device 302 can then interact with the system bus device. Gateway device 302 can provide a user interface for any system bus device using the equipment models stored within the wired system bus devices and/or the equipment models created by gateway device 302. In some embodiments, gateway device 302 stores a view definition for each type of equipment connected via system bus 330 and uses the stored view definition to generate a user interface for the equipment.

### Cloud Client

Referring again to FIG. 5, gateway device 302 is shown to include cloud client 514. Cloud client 514 can be configured to interact with both capability provider 518 and local UI 512. Cloud client 514 serves as the bridge between gateway device 302 and cloud platform 324. Data passed to cloud client 514 may then be communicated to cloud platform 324 via communications interface 516. Communications interface 516 may communicate with cloud platform 324 over an internet connection (e.g., BACnet IP, Ethernet, wired or wireless connection, etc.). Cloud client 514 and communications interface 516 can communicate to cloud platform 324 over HTTPS and/or MQTT protocol. Cloud client 514 can translate gateway device concepts (e.g., Verasys concepts, Metasys concepts) into cloud concepts to allow gateway device 302 to communicate with cloud platform 324. Cloud client 514 can also translate cloud concepts into gateway device concepts to allow data from cloud platform 324 to be received and processed by gateway device 302.

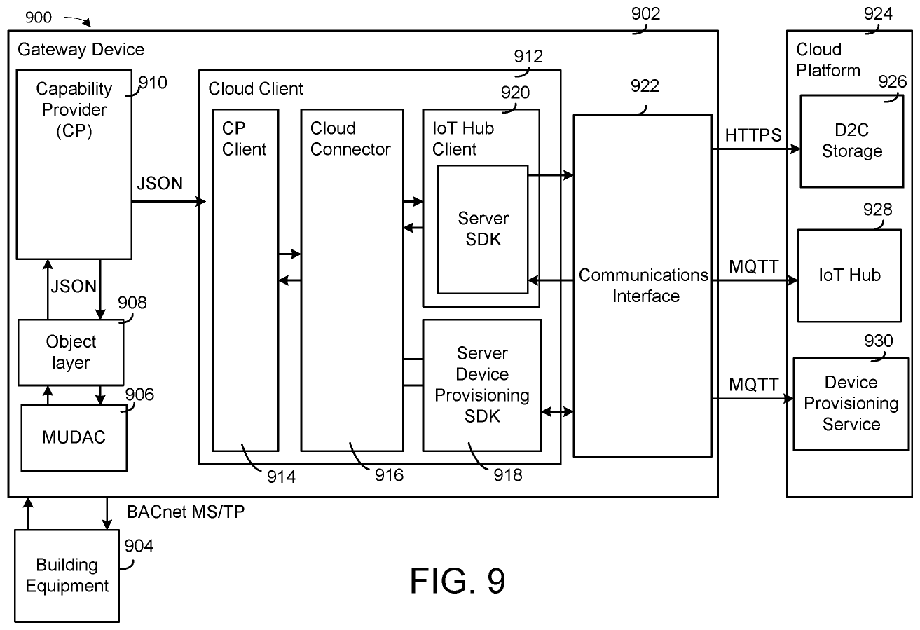

Referring now to FIG. 9, a block diagram illustrating cloud client 514 in further detail is shown, according to an exemplary embodiment. BMS 900 is shown to include building equipment 904 (e.g., chiller, CV RTU, thermostat controller, third-party controller, and/or any other BACnet MS/TP device), gateway device 902, and cloud platform 924. Building equipment 904 can send building data (e.g., equipment models, value objects, point values, and/or any other data/points exposed by the building equipment) to gateway device 302 via a BACnet MS/TP protocol. Gateway device 302 may pass the data in MUDAC 906, object layer 908 and capability provider 910. In some embodiments, MUDAC 906 and object layer 908 are the same object. The building data then pass to cloud client 912.

Cloud client 912 can be configured to interact with cloud platform 924. In some embodiments, cloud client 912 includes a feature server client, shown as CP client 914, a cloud connector 916, a server device provisioning software development kit (SDK) 918, and a library that encapsulates an internet-of-things (IoT) hub SDK with a data platform wrapper, shown as IoT hub client 920. Cloud connector 916 can be configured to interact with both capability provider 910 via CP client 914 and IoT hub client 920. Cloud connector 916 can translate gateway device concepts (e.g., Verasys concepts) into cloud concepts to allow gateway device 302 to communicate with cloud platform 924. Cloud connector 916 can also translate cloud concepts into gateway device concepts to allow data from cloud platform 924 to be received and processed by gateway device 302. Cloud client 912 can be configured to understand the endpoints, APIs, and other services provided by cloud platform 324 and can be configured to communicate with cloud platform 324. In some embodiments, cloud client 912 is configured to exchange messages with cloud platform 324 via communications interface 922 using the native messaging format of cloud platform 324 (e.g., JSON).

### Cloud Platform

Referring now to FIG. 10, a cloud platform 1000 is shown, according to an exemplary embodiment. Cloud platform 1000 may include some or all of the features of cloud platforms 324 and 724, as described above with reference to FIGS. 3-7. Cloud platform 1000 may be accessed by various users 1030 (e.g., enterprise users, mechanical contractors, cloud application users, etc.) via control applications. Some users can access and interact with gateway device 302 directly via client devices (e.g., via a UI provided by gateway device 302), whereas other users can interact with cloud platform 1000 (e.g., via a UI provided by cloud platform 1000, for example control application CED/CSD event hub 1024). The features of cloud platform 1000 and gateway device 302 are described in greater detail below. Cloud platform 1000 receives data from gateway device 302 and/or processes the data to provide a building data output and sends the data and the output to a control application, such as CED/CSD event hub 1024 in a format that it can accommodate to allow a user to operate the BMS remotely.

Cloud platform 1000 can include a variety of cloud-based services and/or applications (e.g., APIs) configured to store, process, analyze, or otherwise consume the data provided by gateway device 302. For example, cloud platform 1000 may include cloud applications such as a heartbeat service, telemetry (e.g., timeseries, COV, etc.) service, equipment list service, account service, and/or other types of services. In addition to the services (e.g., cloud applications) shown in FIG. 10, cloud platform 1000 can include any of a variety of services configured to process, store, analyze, and perform other operations on the data provided by gateway device 302. For example, cloud platform 1000 can include an asset service, an entity service, an analytics service, an alarm service, a command service, and/or other types of data platform services. Cloud platform 1000 can be configured to provide the data and the result of the various cloud applications (e.g., building data output) to one or more control applications configured to allow a user to review the data and control the operation of the gateway device. The control applications may involve modifying a device twin of the gateway device and/or viewing telemetry data and trends created based on the telemetry data by cloud platform 1000. Several examples of a data platform which can be used as part of cloud platform 1000 are described in detail in U.S. Provisional Patent Application No. 62/564,247 filed Sep. 27, 2017, U.S. Provisional Patent Application No. 62/457,654 filed Feb. 10, 2017, U.S. patent application Ser. No. 15/644,519 filed Jul. 7, 2017, U.S. patent application Ser. No. 15/644,560 filed Jul. 7, 2017, and U.S. patent application Ser. No. 15/644,581 filed Jul. 7, 2017, and U.S. patent application Ser. No. 16/844,328 filed Apr. 9, 2020. The entire disclosure of each of these patent applications is incorporated by reference herein.

Referring still to FIG. 10, gateway device 302 is shown to communicate with IoT hub 1004. Gateway device 302 may send data to IoT Hub 1004 using MQTTS streaming. IoT hub 1004 may be configured to send cloud-to-device (C2D) messages to gateway device 302. IoT hub 1004 can be configured to receive and translate the incoming data messages provided by gateway device 302. In some embodiments, IoT hub 1004 performs various data transformations and other functions specific to gateway device 302. For example, IoT hub 1004 can be configured to create entities for telemetry processor 1006 based on the equipment list and equipment model templates provided by gateway device 302. The equipment list may identify all of the equipment connected with gateway device 302, either directly or indirectly.

IoT hub 1004 and/or other components of cloud platform 1000 such as telemetry processor 1006 can provide plug & play functionality for gateway device 302 by automatically determining which values need timeseries data. Cloud platform 324 can use the equipment list in combination with equipment model templates for the identified equipment to determine which properties (i.e., data points, attributes, etc.) of equipment to bind. Cloud platform 324 can then create timeseries for the identified properties with telemetry processor 1006 and update the a subscription list. The timeseries may initially be empty, but can be updated as data samples are collected from gateway device 302 and/or equipment. In some embodiments, cloud platform 324 updates the twin subscription list to identify all of the properties that cloud platform 324 is interested in receiving change-of-value (COV) updates from gateway device 302 and/or equipment.

Gateway device is shown connected to device provisioning service 1034. Device provisioning service 1034 may be updated prior to installation of gateway device 302 into BMS 300 with the device ID, ID scope, and keys associated with gateway device 302. Device provisioning service 1034 may create the device in enroll gateway device 302 into a specific IoT hub.

IoT hub 1004 is connected to various event hubs and/or services, otherwise known as cloud applications, (shown as telemetry processor 1006, heartbeat processor 1008, equipment list processor 1010, and account processor 1012), and CED/CSD event hub 1024. The gateway device 302 sends all building data (e.g., equipment models, view definitions, COVs for subscribed properties and/or any exposed value and point objects of building equipment) it has collected on system bus 330 and wireless system bus 332 through the IoT hub 1004. IoT Hub 1004 routes all messages to the appropriate event hubs in cloud platform 1000 (e.g., telemetry messages to telemetry processor 1006, heartbeat messages to heartbeat processor 1008, etc.). For example, gateway device 302 may send a heartbeat message to IoT hub 1004, which can direct the heartbeat message to heartbeat processor 1008, which can process and send a signal to CED/CSD event hub 1024. The heartbeat message can also be sent to heartbeat auditor 1022 for storage. Files sent to IoT hub 1004 can be uploaded to the accounts storage container (e.g., services storage account 1014, D2C storage 1016, etc.). Any data received by an event hub (e.g., telemetry processor 1006, heartbeat processor 1008, etc.) can trigger an automatic function to process the data. In some embodiments, the event hubs are associated with corresponding cloud objects (e.g., template processor 1018, telemetry auditor 1020, heartbeat auditor 1022) for recording data. The processed data can be sent to CED/CSD event hub 1024. In some embodiments, there are different functions for different message types (e.g., heartbeat message, telemetry message, equipment list, etc.).

IoT hub 1004 can include components such as a file upload component, IoT device component, and message routing component. The file upload component may include a device diagnostic file and/or an equipment model template. The gateway device 302 may automatically upload an equipment model template when it determines the equipment model template cannot be found on cloud platform 1000.

The IoT devices component can consist of all devices (e.g., BACnet MS/TP devices) connected to gateway device 302 over system bus 330 and wireless system bus 332. The IoT devices component may be based on the equipment list built by gateway device 302 of all BACnet devices it has discovered on system bus 330 and wireless system bus 332.

In some embodiments, cloud platform 1000 is configured to generate and maintain a virtual “twin” for each gateway device 302 that sends data to cloud platform 1000. In some embodiments, IoT hub 1004 creates and maintains the device twin. The twin may function as a virtual service-side representation of a physical gateway device 302. For example, the twin for a given gateway device 302 may be a data object (e.g., a JSON object) that contains attributes indicating the state of gateway device 302. The twin may contain desired properties and reported properties. The reported properties can represent the current state of gateway device 302. The desired properties can represent desired modification made by a user through cloud platform 1000. For example, a user may input a desired modification to gateway device 302 through cloud platform 1000, which can update the desired properties of the device twin of gateway device 302. Gateway device 302 can periodically read the device twin and adjust its local properties to reflect the desired properties in the device twin. In some embodiments, gateway device 302 can then update the reported properties in the device twin so they match the desired properties. This can provide an indication to the user through the cloud platform that the modification has been made. In some embodiments, the updated device twin can be pushed to gateway device 302. An example of a twin for a gateway device 302 is as follows:

```
{
  “Reported”: [ ],
  “Bound”: [ ],
  “Revision”: “1”,
“Hash”: “abc”
}
```

Gateway device 302 can be configured to fill in the “Reported” field of the twin with information describing gateway device 302 (e.g., BAS units, time zone, etc.). It should be noted that the “Reported” field is different from the equipment list, which is a separate file. An example of the information which can be specified in the “Reported” field is as follows:

“Device Settings”: {
“BAS Units Setting”: “IP”,
“Time Zone Setting”: “Central”
“Heartbeat Time Series ID”: “HB-TS”
“Software Version”: 1.0
}

The “Bound” field of the twin can be filled in by cloud-based event hub (e.g., equipment list processor 1010, telemetry processor 1006, etc.) to indicate the properties of building equipment for which the event hub wants telemetry data. The cloud-based event hub may create a timeseries for the bound properties. The telemetry data may be a component of the building data sent from gateway device 302 to cloud platform 1000. The “Bound” field can include the following information:
Bound: {[FQR ID, Time Series ID]}
Organization ID
where the organization ID is used by event hubs to identify the customer associated with gateway device 302. An example of a subscription list is provided in Appendix C. If certain points in the “Bound: field are not physically present, the gateway device 302 can send the “Non-Existent” points list cloud platform 1000, which can delete the non-existent points from the twin.

The “Revision” field of the twin may be incremented each time the twin is modified by either cloud platform 1000 or by gateway device 302. Both gateway device 302 and cloud platform 1000 can update the “Revision” field of the twin each time a change is made. Both gateway device 302 and cloud platform 1000 can also synchronize with the twin to ensure that each has the most recent version of the information provided by the twin. For example, gateway device 302 and cloud platform can periodically read the twin and copy the information contained in the twin if the version of the twin is more recent than the local version of the information. A sample of another device twin may be found in Appendix D.

### Data Control Template Info

In some embodiments, the device twin may include properties useful to control the data rate between gateway device 302 and cloud platform 1000. The properties, referred to herein as data control properties, may be modified by a user to control how much data is exchanged between gateway device 302 and cloud platform 1000. The data control properties may be passed to a gateway device as part of the desired properties contained in the device twin as explained above with reference to FIG. 10. The data control properties may be a subset of the properties exchanged between gateway device 302 and cloud platform 1000 via the device twin. For example, data control properties may include a telemetry rate, a heartbeat rate, an equipment list update rate, a subscription list, a data compression setting, and a COV file upload threshold setting. The subscription list may include a fully qualified reference, a COV increment value, and a COV minimum time value. Data control properties may include other properties passed as part of the device twin that control or modify the data rate between gateway device 302 and cloud platform 1000.

Telemetry rate may be the rate at which COV data samples are posted from gateway device 302 to cloud platform 1000. For example, a telemetry rate of 30 seconds may direct gateway device 302 to send COV update values collected from building equipment to cloud platform 1000 every 30 seconds. Modifying telemetry rate can affect the number and rate of messages exchanged between gateway device 302 and cloud platform 1000.

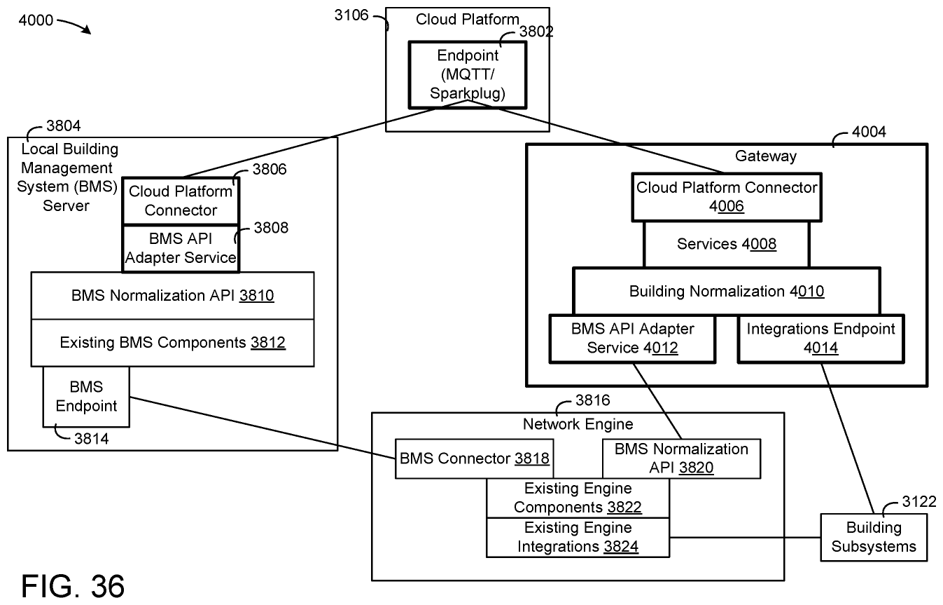

Heartbeat rate may be the rate at which gateway device 302 posts heartbeat messages to the cloud. Heartbeat messages are explained in further detail below with reference to FIG. 36.

The equipment list rate may be the rate at which the equipment list update message are posted from gateway device 302 to cloud platform 1000. The equipment list, as explained above, informs the cloud of discovered MS/TP devices connected to gateway device 302 via wired system bus 330 and/or wireless system bus 332.

The subscription list may be the list of equipment and points (e.g., BACnet point objects, value objects, etc.) that cloud platform 1000 desires COV and/or other data for. The subscription list may contain a fully qualified reference. The fully qualified reference may be a reference to a specific piece of building equipment contained with the equipment list. In some embodiments, the subscription list property within the device twin may include a COV increment. The COV increment may be the minimum amount of change in a subscribed points value required to generate a COV sample to be sent to cloud platform 1000. For example, a thermostat controller may include a temperate object exposed to gateway device 302 and included in the subscription list by cloud platform 1000. A device twin pushed to gateway device 302 may include a COV increment value of 1 degree. Gateway device 302 can be configured not to transmit a new value until the COV value is at least and/or greater than the COV increment value.

The subscription list may also include a COV minimum time point. COV minimum time point may dictate the minimum amount of time that must pass from when gateway device 302 sends a COV message to cloud-platform 1000 before another COV message can be sent. In some embodiments, the COV sent at the end of the COV minimum time point is the most recent COV. In some embodiments, gateway device 302 temporarily stores the COV values and sends them in groups based according to the COV minimum time point.

The data compression setting may be an option in the device twin indicating to gateway device 302 whether or not to compress or encode the collected COV data samples before posting the data samples to cloud platform 1000.

The COV file upload threshold setting may allow gateway device 302 to upload collected COV data samples as a file upload rather than MQTT and/or HTTPS streamed data if the COV data samples exceed a certain size. In some embodiments, a BMS may have a lower telemetry rate data control setting, and accordingly the COV samples data may exceed the MQTT and/or HTTPS threshold. In some embodiments, a gateway device may be offline, and offline data storage of the gateway device may include collected COV data that was not streamed to cloud platform 1000. The collected data can be uploaded as a file if larger than the COV file upload threshold.

In some embodiments, data control properties included in the device twin may be saved as a data control template. The data control template may be stored in cloud platform 1000 and/or gateway device 302. The data control template may be associated with a customer ID, an organization, a geographic location and/or other metadata related to the BMS. In some embodiments, a single data control template can be included in the device twin of multiple gateway devices in a BMS. In some embodiments, a data control template may be set as a default for a user and apply automatically apply to all gateway devices connected to that user. In some embodiments, a BMS may store multiple data control templates. For example, cloud platform 1000 may include a Wi-Fi data control template, a cellular data control template, and an Ethernet data control template. Cloud platform 1000 may automatically select and include in a device twin for a gateway device the data control template associated with the network used by the gateway device to connect to cloud-platform 1000. In some embodiments, a user may select the data control template to be applied to a gateway device.

The data control template is useful for a BMS constrained by monthly internet or data services such as those connected over a cellular network. Data control settings allow a user or contractor to dynamically modify and control the data rate between a gateway device and/or multiple gateway devices and a cloud platform utilizing the existing device twin messaging features of the BMS.

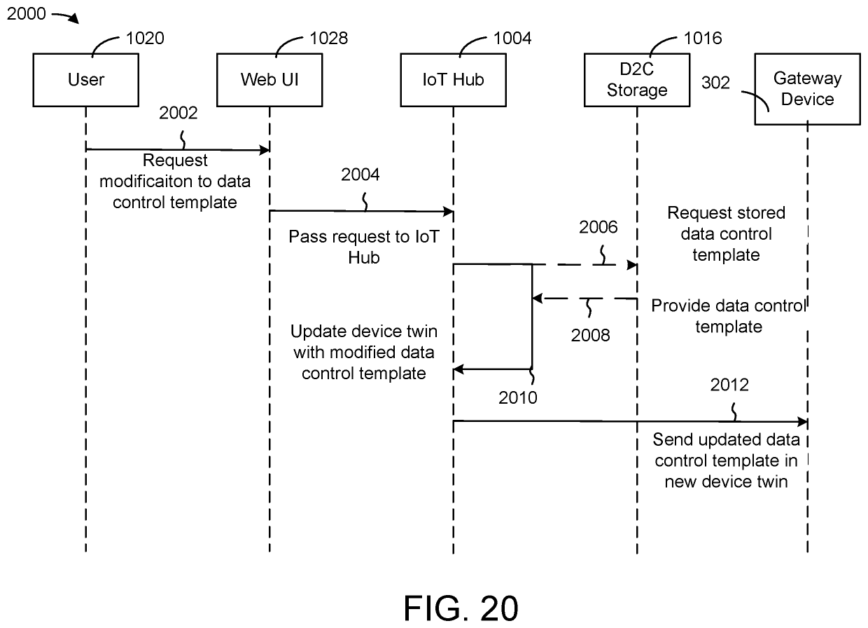

Referring now to FIG. 20, a sequence diagram illustrating a data control template update process 2000 is shown, according to an exemplary embodiment. Process 2000 can be performed by one or more components of BMS 300 to modify data control properties located within the device twin of a gateway device. For example, process 2000 can be performed by web UI 1028, IoT Hub 1004, D2C storage 1016, and gateway device 302. The data control template may be a component of a device twin stored in cloud platform 1000 and/or gateway device 302. Certain properties in the device twin that control the data rate between cloud platform 1000 and gateway device 302 may be grouped together and saved as a data control template. The data control template may be used to apply data control settings to a variety of BMS devices.

The data control template may control properties of the device twin such as the telemetry rate, the heartbeat rate, the COV increment value, the COV minimum threshold value, and/or other properties that affect the data rate between gateway device 302 and cloud platform 1000. In some embodiments the data control template is populated with default data control property values during device provisioning.

User 1030 may send a request to modify the data control template (2002). In some embodiments, the request may be to modify data control template tied to a single gateway device. In some embodiments, the data control template may be associated with multiple gateway devices. The user request may include altering the data control properties for all gateway devices associated with the data control template. The request may be to web UI 1028. Web UI 1028 may be configured to fetch subscription lists, templates, equipment list, diagnostic information, and data control properties, and/or data control templates stored in D2C storage 10106 and display such things to user 1030 for modification and control of the BMS. Web UI 1028 may pass the modification request to IoT Hub 1004 (step 2004). In some embodiments, web UI may have already retrieved from D2C storage 1016 the data control template. In some embodiments, IoT hub 1004 may request the data control template to be modified from D2C storage 1016 (step 2006) which may then provide the data control template to IoT Hub 1004 (step 2008). IoT hub 1004 may generate a new device twin incorporating the modification to the data control template. The data control template may be one or more properties contained within a device twin.

IoT Hub 1004 may update the data control properties and generate a new/updated device twin for gateway device 302 (step 2010). In some embodiments, the updated properties are contained in the desired properties of the device twin. Gateway device 302 may receive and/or request the updated device twin from IoT hub 1004 (step 2012). In some embodiments, gateway device 302 may be configured to periodically poll IoT Hub 1004 to determine if the device twin has been updated. In some embodiments, the IoT Hub 1004 may push a new device twin to gateway device 302 each one is created. Once gateway device 302 receives the new device twin it may then read the updated data control properties and update its local (e.g., reported properties) in accordance with the new data control properties in the data control template.

Referring back to FIG. 10, cloud platform 1000 is shown to include telemetry processor 1006. Telemetry processor 1006 can be configured to receive building data generated by building equipment such as change of value (COV) via gateway device 302. The telemetry data may be for bound properties listed in the gateway device's twin. Telemetry processor 1006 can be configured as a telemetry service to perform a variety of telemetry processing operations. IoT Hub 1004 can then create timeseries for the identified properties with telemetry processor 1006 and update the twin subscription list (e.g., subscription list) and push the updated twin. The timeseries may initially be empty, but can be updated as data samples are collected from gateway device 302 and/or building equipment. In some embodiments, IoT hub 1004 updates the twin subscription list to identify all of the properties that cloud platform 1000 is interested in receiving change-of-value (COV) updates from gateway device 302 and/or building equipment.

Gateway device 302 can evaluate the subscription list to identify one or more properties specified by the twin. Gateway device 302 can then subscribe to COV updates for any properties specified by the twin and unsubscribe from COV updates for any properties not specified by the twin. When a COV for a subscribed property occurs, equipment can send a COV notification to gateway device 302. The COV notification may identify the property for which a COV has occurred and may include the current value of the property. In some embodiments, telemetry processor 1006 is configured to perform some or all of the timeseries processing operations described in U.S. patent application Ser. No. 15/644,519 filed Jul. 7, 2017, U.S. patent application Ser. No. 15/644,560 filed Jul. 7, 2017, U.S. patent application Ser. No. 15/644,581 filed Jul. 7, 2017, and U.S. patent application Ser. No. 16/844,328 filed on Apr. 9, 2020. The entire disclosure of each of these patent applications is incorporated by reference herein.

### Telemetry Data Process

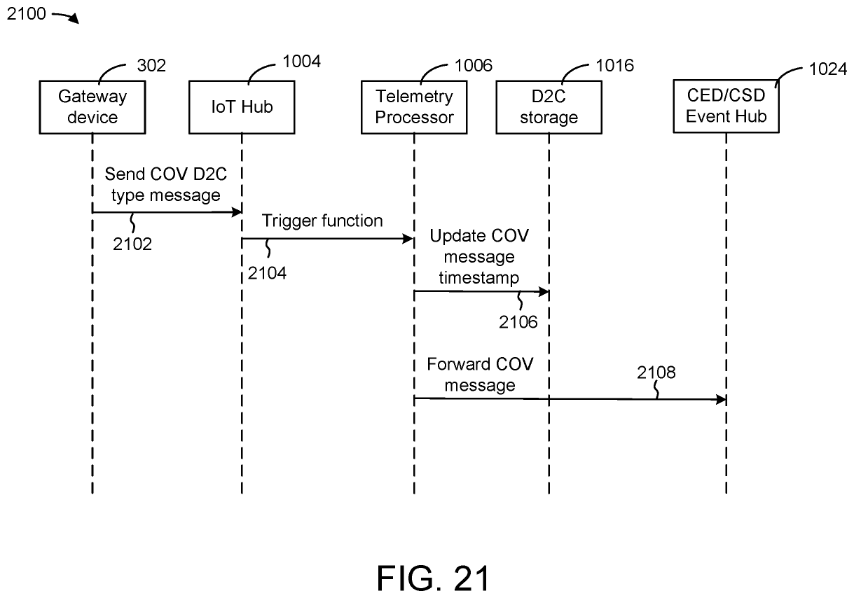

Referring now to FIG. 21, a sequence diagram illustrating a telemetry data process 2100 is shown, according to an exemplary embodiment. Process 2100 can be performed by one or more components of BMS 300 to collect and send telemetry data (e.g., change of value data) to cloud platform 324. For example, process 2100 can be performed by gateway device 302, and/or various components of cloud platform 324 (e.g., IoT hub 1004, telemetry processor 1006, D2C storage 1016, and CED/CSD event hub 1024, etc.).

When a point object in the bound point list generates telemetry data (e.g., COV data), gateway device 302 can receive the telemetry data and the COV data to IoT hub 1004 as a device-to-cloud (D2C) message. The message may include the value of the bound point, and a timestamp. Gateway device 302 can then send the telemetry data to telemetry processor 1006. The telemetry data may include a telemetry ID, a value as a string (e.g., the enumerated string), and a timestamp. telemetry processor 1006 may respond to gateway device 302 acknowledging receipt of the telemetry data. An example of a telemetry message may be found in Appendix E.

### Heartbeat Telemetry

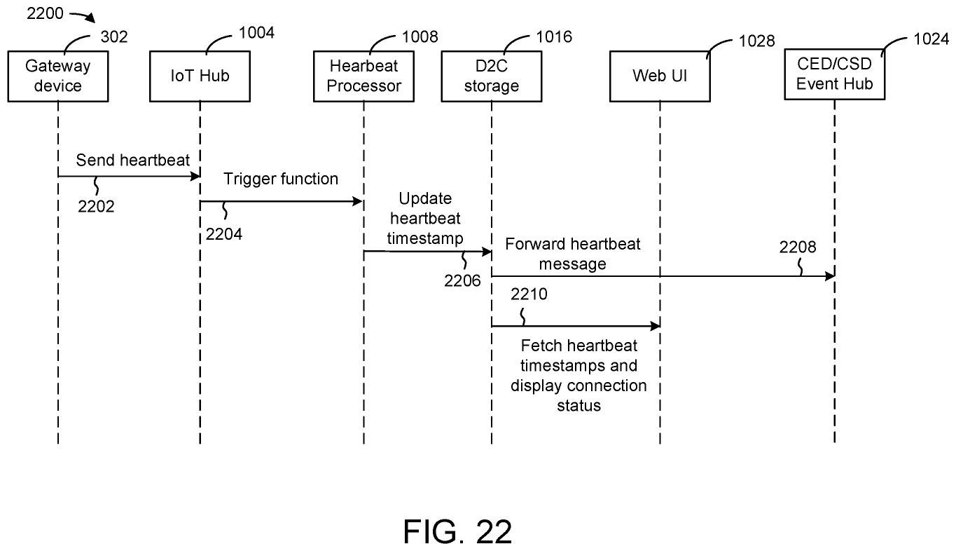

Referring now to FIG. 22, a sequence diagram illustrating process 2200 for sending a heartbeat message is shown, according to an exemplary embodiment. Process 2200 can be performed by various components of BMS 300. For example. Process 2200 can be performed by gateway device 302, IoT hub 1004, heartbeat processor 1008, D2C storage 1016, web UI 1028, and CED/CSD event hub 1024. Process 2200 is shown to include gateway device 302 sending a heartbeat message to IoT hub 1004 (step 2202). Gateway device may send the heartbeat message periodically. For example, gateway device may send a heartbeat message every 5 minutes, every 10 minutes, etc. The heartbeat rate can be a point value found in the device twin. The rate can be modified by a user either through the local UI of gateway device 302 or web UI 1028. In some embodiments, the heartbeat rate is a component of a data control template, which can itself be a component of a device twin generated by cloud platform 324.

Process 2200 is shown to include IoT hub 1004 automatically triggering heartbeat processor 1008 (step 2204). Heartbeat processor 1008 can update a heartbeat timestamp based on the latest heartbeat message and store the updated timestamp in D2C storage 1016 (step 2206). Process 2200 is shown to include D2C storage 1016 forwarding the heartbeat message to CED/CSD event hub 1024 (step 2208). In some embodiments, D2C storage 1016 can send the heartbeat message to heartbeat auditor 1022, shown in FIG. 10, for logging. Process 2200 is shown to include web UI 1028 fetching the heartbeat timestamps from D2C storage 1016 and displaying the connection status (step 2210). Examples of a properties and property values contained in a heartbeat message reported by gateway device 302 are as follows: An example heartbeat message may be found in Appendix F.

| Property | Example Value |
|---|---|
| “Current Date and Time in UTC” | 01/25/2020 14:34:20Z |
| “CPU Usage (%)” | “45” % |
| “Memory Usage (%)” | “30” % |
| “Ethernet Interface Status” | “Enabled” |
| “Wi-Fi Client Interface Status” | “Enabled” |
| “USB Cellular Interface Status” | “Enabled” |
| “Cell Signal Strength (%)” | “45” % (optional if cell dongle is |
| | connected) |
| “TMC signal strength (%)” | “65” % (optional if MS/TP |
| | coordinator is connected) |
| “Account ID” | “Customer_8211.ABCD” - |

### Equipment List Upload and Subscription List Generation

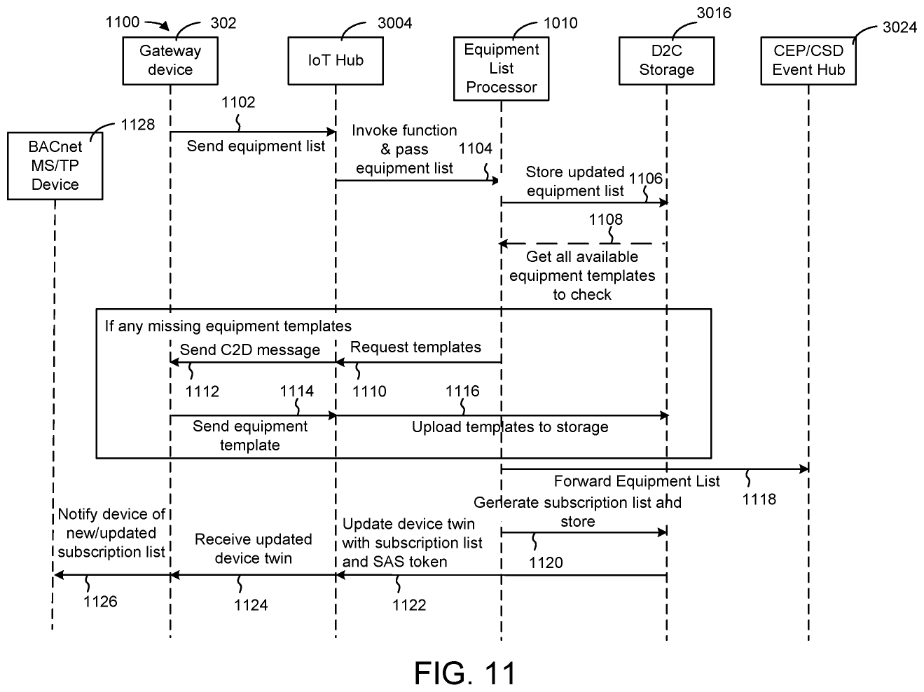

Referring now to FIG. 11, a sequence diagram illustrating process 1100 for providing a cloud platform with an equipment list from a BACnet device and providing a subscription list of bound properties based on the provided information to a gateway device is shown, according to an exemplary embodiment. Process 1100 can be performed by one or more components of BMS 300. For example, process 1100 can be performed by gateway device 302, IoT hub 1004, equipment list processor 1010, D2C storage 1016, CED/CSD event hub 1024 and BACnet device 1128.

Process 1100 is shown to include gateway device 302 sending an equipment list as a device to cloud (D2C) message to IoT hub 1004 (step 1102). Gateway device 302 may identify building equipment on system bus 330 and generate a report (e.g., equipment list) listing the identified building equipment. In some embodiments, the equipment list is in JSON format. An example equipment list can be found in Appendix G. Gateway device 302 can periodically send the equipment list to the IoT Hub 1004. IoT hub 1004 can be configured to automatically invoke a server function and pass the equipment list format to equipment list processor 1010 (step 1104). Process 1100 is shown to include storing the new (e.g., updated) equipment list in D2C storage 1016 (step 1106). Equipment list processor 1010 can be configured to retrieve from D2C storage 1010 all available equipment templates to check for an equipment template for each building device (e.g., BACnet MS/TP device) in the new equipment list (step 1108). If equipment lists are found for all building devices in the new equipment list, process 1100 can skip to step 1118. If an equipment list is not found, process 1100 is shown to include sending request for any missing equipment templates to IoT Hub 1004 (step 1110).

In some embodiments, the equipment templates may only be sent from gateway device 302 if requested by cloud platform 324. An equipment list may contain a large number of building equipment and it may be prohibitive from a data use stand point to send equipment templates for each piece of equipment every time an equipment list is provided to cloud platform 1000. In some embodiments to conserve data and avoid duplication of equipment templates, gateway device 302 may send the equipment list first and equipment list processor 1010 may be configured to check D2C storage 1016 for equipment templates before requesting gateway device 302 to send them. In some embodiments, D2C storage 1016 is associated with a customer ID and includes equipment templates for all building equipment previously connected to cloud platform 1000. A single building equipment template may associated with multiple pieces of building equipment. By first checking for pre-existing equipment model templates cloud-platform 1000 ensures only a single equipment template is stored, avoiding duplicate meta data.

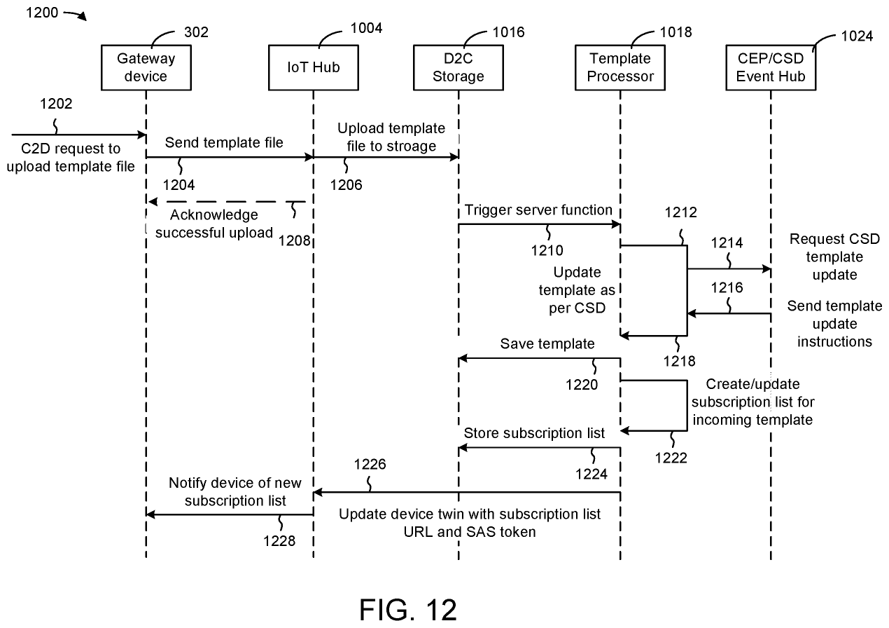

If an equipment template is not found, equipment list processor 1010 may then request gateway device 302 to provide it (step 1110). IoT hub 1004 can passes the request to gateway device 302 as a cloud-to-device (C2D) message (step 1112). Gateway device 302 can be configured to respond with equipment files (e.g., JSON equipment files) and send them to IoT hub 1004 (step 1114). The process for collecting missing equipment templates from gateway device 302 is explained in greater detail below with reference to FIG. 12. Process 1100 is shown to include IoT hub 1004 receiving the JSON template files (step 1114) and uploading the equipment templates to D2C storage 116 (step 1116).

Process 1100 is shown to include forwarding the new equipment list to the CED/CSD event hub 1024 (step 1118). Equipment list processor 1010 can be configured to use the equipment list in combination with equipment templates for the building devices determine which properties (i.e., data points, attributes, etc.) of equipment to subscribe to (step 1120). The subscribed properties may also be referred to as bound properties throughout this disclosure. Equipment list processor 1010 may generate telemetry data for the bound properties with a timeseries service (not shown). The subscription list can be used to update the device twin including a list of bound properties for gateway device 302 to subscribe too based on the subscription list as an aspect of an updated device twin sent to IoT hub 1004 (step 1122), as explained above with reference to the bound properties of the device twin. Process 1100 is shown to include gateway device 302 receiving the updated device twin (step 1124) and gateway device 302 notifying a device 1128 (e.g., BACnet MS/TP device 754) of the new/updated subscription list (step 1126).

### Template Upload

Referring now to FIG. 12, a sequence diagram illustrating a process 1200 for uploading an equipment template from gateway device 302 to cloud platform 1000 is shown, according to an exemplary embodiment. Process 1200 can be performed by various components of BMS 300. For example, process 1200 can be performed by gateway device 302, IoT hub 1004, D2C storage 1016, template processor 1018, and CED/CSD event hub 1024. In some embodiments, cloud platform 324 may determine it does not have equipment model templates for all building equipment listed in the equipment list. Cloud platform 324 can request the missing equipment model templates from gateway device 302.

Process 1200 is shown to include gateway device 302 receiving a cloud-to-device (C2D) message from cloud platform 1000 requesting gateway device 302 to upload equipment template files (step 1202). For example, the C2D message is the C2D message sent in step 1112 of process 1100. In some embodiments, equipment templates may only be uploaded when a request is sent. In some embodiments, gateway device 302 may upload an equipment template whenever it discovers new building equipment on system bus 330 and/or wireless system bus 332. Gateway device 302 can be configured to send the equipment template file to IoT hub 1004 (step 1204). In some embodiments, the equipment template is sent as a JSON file. Process 1200 is shown to include IoT hub 1004 uploading the equipment template file to D2C storage 1016 (step 1206). In some embodiments, equipment templates can be upload as a file directly to D2C storage 1016, bypassing IoT hub 1004. Process 1200 is shown to include IoT hub 1004 acknowledge the successful upload to gateway device 302 (step 1208).

The uploading of an equipment template to D2C storage 1016 may automatically trigger template processor 1018 to perform a server function with the equipment template file (step 1210). Process 1200 is shown to include template processors 1018 updating the equipment template (step 1218). Template processor 1018 may request CED/CSD event hub 1024 to provide update instructions (step 1214) and may receive update instructions (1216). In some embodiments, template processor 1018 may update the equipment template without requesting instructions from CED/CSD event hub 1024.

Process 1200 is shown to include template processor 1018 saving the updated template to D2C storage 1016 (step 1220). Template processor 1018 can create and/or update the subscription list (e.g., subscription list) in accordance with the newly received equipment template (step 1222). Template processor 1018 can store the updated subscription list in D2C storage 1016 (step 1224). Process 1200 is shown to include template processor 1018 updating the device twin with the subscription list URL and SAS token. The modifying of the device twin to pass configuration settings to gateway device 302 is explained in detail above with reference to cloud platform 1000. Process 1200 is shown to include IoT hub 1004 notifying gateway device 302 of the new subscription list (step 1228). In some embodiments, step 1228 can be a part of the device twin messaging interface implemented by cloud platform 1000.

### Time Synchronization

In some embodiments, gateway device 302 will not connect to cloud platform 1000 until it has established a good time basis. Time synchronization process 2300 can be configured to provide gateway device 302 with the latest time in UTC format. Time synchronization process 2300 is important to ensure the timestamps on building data collected from gateway device 302 are not materially different from the actual time the building data was received. Time synchronization process 2300 is also used to ensure gateway device 302 has a secure connection to the cloud platform 1000 via HTTPS. In some embodiments, gateway device 302 does not have a battery-powered clock. Accordingly, time synchronization process 2300 may be used to ensure the device is not left with a poor time basis if unpowered for a period of time.

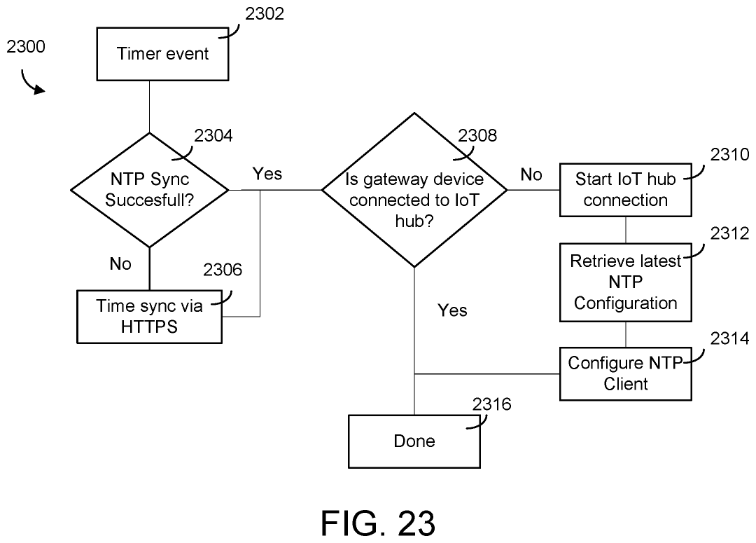

Referring now to FIG. 23, a flow chart of a time synchronization process 2300 for synchronizing the time on the gateway device is shown, according to an exemplary embodiment. Time synchronization process 2300 is shown to include a timer event initializing the process (step 2302). The timer event may be a first startup of gateway device 302 by a user or a startup after an extended unpowered state. In some embodiments, the timer event may be initiated by a user, or automatically by cloud platform 1000. Time synchronization process 2300 is shown to include checking if a network time protocol (NTP) sync was successful (step 2304). Gateway device 302 may include an NTP client which can use the NTP protocol to synchronize the system clock. NTP may synchronize devices on a network to a coordinated universal time. In some embodiments gateway device 302 has a hardcoded default NTP server provided. In some embodiments, gateway device 302 receives its NTP configuration from an IoT hub component of cloud platform 1000. If NTP synchronization fails at step 2304 then gateway device 302 will sync time via HTTP (no at step 2306). Gateway device 302 may sync time over HTTP by sending HTTP packet requests to a remote server that is connected to gateway device 302. Gateway device 302 can periodically determine if time has been synchronized over HTTPS and only send data when a good time basis is known. No data will be sent from gateway device 302 if it is not able to retrieve a time.

If time synchronization is successful either at step 2304 or 2306, gateway device 302 may broadcast the time to all devices connected on the system bus, including devices connected over the wired system bus 330/340 and wireless system bus 332. Time synchronization process 2300 is then shown to include gateway device 302 checking if it is connected to an IoT hub (step 2308). The IoT hub may be a part of cloud platform 324. If gateway device 302 is connected, then the time synchronization process is complete (step 2316). If gateway device 302 is not connected time synchronization process 2300 is shown to include starting an IoT hub connection (no at step 2310). Time synchronization process 2300 is shown to include retrieving the latest NTP configuration from the IoT hub (step 2312). This step is optional, and in some embodiments gateway device 302 may be configured with a hardcoded default NTP server. Time synchronization process 2300 is shown to include configuring the NTP client according to the latest NTP configuration information (step 2314). Time synchronization process 2300 is shown to include completing the time synchronization process (step 2316).

### Firmware Update

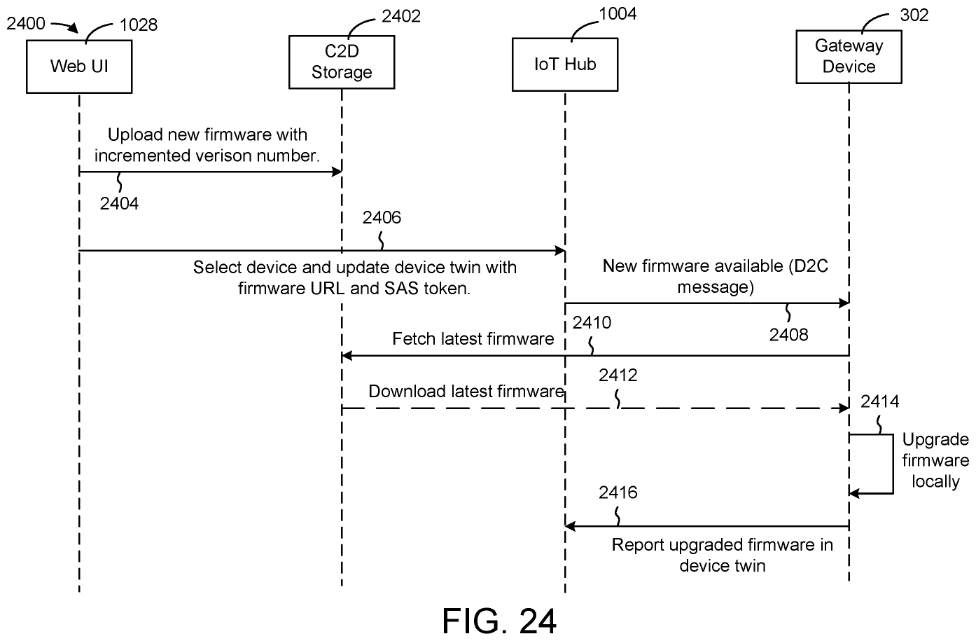

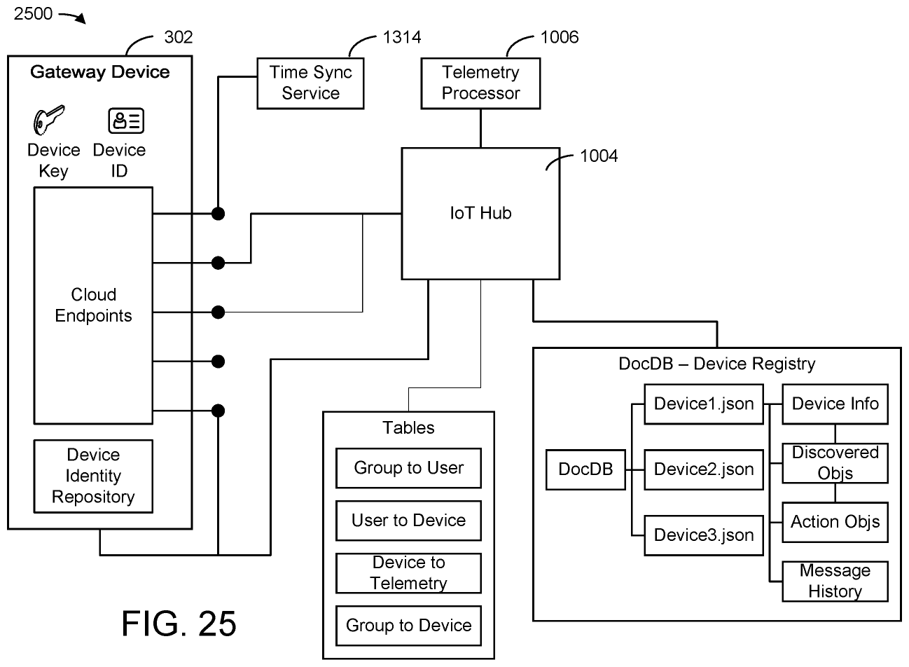

Referring now to FIG. 24, a sequence diagram illustrating a firmware update process 2400 for BMS 300 is shown, according to an exemplary embodiments. Process 2400 can be performed by one or more components of BMS to update the firmware of gateway device 302. For example, process 2400 can be performed by web UI 1028, C2D storage 2402, IoT Hub 1004 and gateway device 302. C2D storage 2402 may be a component of a cloud platform such as cloud platform 1000 for storing C2D messages. Process 2400 is shown to include a new firmware being upload to C2D storage 1016 from web UI 1028 (step 2404). In some embodiments, the firmware is uploaded by a user. Process 2400 is shown to include the web UI 1028 selecting a device and updating the devices associated device twin (e.g., device twin, etc.) with the firmware URL and a shared access signature (SAS) token on IoT hub 1004 (step 2406). IoT hub 1004 can then notify gateway device 302 of the new firmware through the updated device twin, as the gateway device 302 may periodically check the device twin as discussed above (step 2408). Gateway device 302 can then retired the latest firmware from the C2D storage 1016 and download it (steps 2410 and 2412). Gateway device 302 can then update the firmware locally (step 2414). Gateway device 302 can report that the firmware has been updated by altering the device twin (step 2416).

Referring back to FIG. 5, web UI 1028 can be configured to perform a variety of command and control operations. In some embodiments, web UI 1028 is configured to send commands and control signals to gateway device 302. The commands and control signals can then be used by gateway device 302 to control system bus equipment of BMS 300. In some embodiments, web UI 1028 sends command messages as strings, gets response messages as strings, and stores the responses.

In some embodiments, web UI 1028 allows a user to command and control the equipment of BMS 300 by writing data values to gateway device 302. It should be noted that a local user of gateway device 302 can command and control BMS 300 via a local user interface generated by gateway device 302. However, remote users (e.g., technical support, a store manager, an enterprise user, etc.) can command and control BMS 300 via web UI 1028. Web UI 828 can be configured to change any data values including setpoints, configuration parameters, schedules, and other types of data used by gateway device 302 and/or equipment.

In some embodiments, cloud platform 1000 is configured to maintain a manifest for each instance of gateway device 302 that sends data to cloud platform 1000. The manifest may indicate the most recent available version of software for gateway device 302, the installed version of software for gateway device 302, a retrieval URL for the most recent version of software for gateway device 302, and a list of endpoint URLs that define the location of cloud platform 1000. The endpoint URLs may be helpful in the event that gateway device 302 is deployed in a country that requires data to be kept within the country for legal reasons. Accordingly, the URL may be different for each country. If the endpoint URL is left empty, gateway device 302 may not send data to cloud platform 1000.

### High Level Process Flow

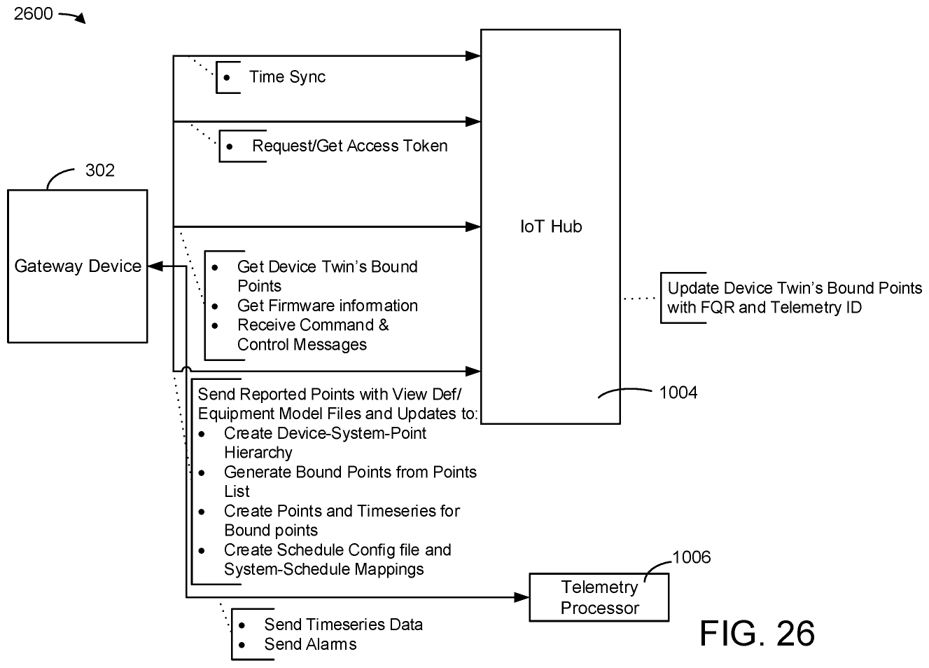

Referring now to FIGS. 25-26, block diagrams 2500 and 2600 illustrating a high level process flow performed by BMS 300 is shown, according to an exemplary embodiment. A manufacturer can log into a manufacturer portal and enter the device ID and get a device key auto-generated from the portal. Once a device ID is created, a device twin gets automatically be created in cloud platform 324 with blank reported and bound points and with a version 0. The manufacturer can embed the device ID and device key into gateway device 302 and can ship gateway device 302 to a customer or supplier. The customer admin can log into an enterprise application (e.g., one of the event hubs in cloud platform 1000) and create a user with the role of installation technician. The customer admin can provide credentials to an installation technician to allow the installation technician to install gateway device 302 at the customer site. To install gateway device 302, the installation technician can log into the enterprise application and adds the device ID to the customer record. The installation technician can then log into the UI of gateway device 302 and setup the local time zone for gateway device 302.

Once connected to the internet, gateway device 302 may initiate a time synchronization with time sync service to get the current time in UTC Format and will store it. An exemplary embodiment of the time synchronization service is shown with reference to FIG. TIME. All future data transmissions will be based on the time and the time zone of gateway device 302. Gateway device 302 can get the twin version from cloud platform 324 and store it locally. Gateway device 302 may request a telemetry ID (e.g., timeseries ID) for device status/heartbeat messages from telemetry service 1016. The telemetry ID can be stored locally in gateway device 302 and in the twin for gateway device 302. Gateway device 302 can be configured to send out “heartbeat” messages at a regular frequency (e.g., every 15 mins) to heartbeat processor 1008 using the status/heartbeat telemetry ID. These messages can be stored for device connection status monitoring and for audit purposes.

Gateway device 302 can discover the building equipment connected to it and generate an equipment list from the discovered systems. Gateway device 302 can send the equipment list to cloud platform 324. Cloud platform 324 can use retrieve internally equipment model template for equipment included on the equipment list. If cloud platform 324 does not have equipment model templates for the equipment it can request them from gateway device 302. Cloud platform 324 can use the equipment model files and the equipment list to create a reported points list (e.g., point objects). Cloud platform 324 can generate a list of bound points from a default subscription list for each system/equipment. For the bound points, telemetry service 1016 can create telemetry IDs. The point ID to telemetry ID mapping can be stored in cloud platform 324. The bound points along with their telemetry IDs can also be stored in the devices cloud twin and can be updated when changes of value occur. Gateway device 302 can synchronize with the twin by downloading and storing a list of the bound points in local memory. Gateway device 302 may transmit telemetry data for only the points listed in the bound points list.

When additional systems/equipment are connected to gateway device 302, gateway device 302 can discover the new systems/equipment and can update the equipment list. Gateway device 302 can send the updated equipment list to cloud platform 324. Cloud platform 324 can use the updated equipment list to generate an updated bound points list. Cloud platform 324 can generate bound point and telemetry IDs for any new points and can update the device's twin to be synchronized by gateway device 302.

Gateway device 302 can be configured to transmit telemetry data for the points identified in the bound points list. Such data can be sent to telemetry service 1016 along with the timestamp. If the telemetry data contains an enumerated set and an enumerated value, gateway device 302 can store the enumerated values as JSON formatted data strings and pass the strings to telemetry service 1016 with the timestamp.

Command and control messages can be initiated from an enterprise portal and routed to gateway device 302 by cloud platform 324 (e.g., from web UI 1028 and/or CED/CSD event hub 1024). At a scheduled time, gateway device 302 can log into cloud platform 324 and get the latest firmware information for gateway device 302. If the latest firmware information doesn't match the installed firmware version at gateway device 302, gateway device 302 can download the latest firmware from the URL available in the message.

Personnel can log into the web UI 1028 and manually enter the serial number of systems and/or equipment. For some equipment, cloud platform 324 can automatically fetch warranty information from a web service and update the warranty information stored in cloud platform 324. Equipment schedules can be pushed by gateway device 302 and stored in cloud platform 324. The schedules can be updated in the cloud via the enterprise portal and pushed back to gateway device 302. Setpoint changes for the system's bound points can be initiated from the enterprise portal. When a user makes a setpoint change to an item of equipment, the information can be directed to gateway device 302 and a response can be stored in cloud platform 324.

In some embodiments, gateway device 302 includes a device ID and a hashed key for secure communication. The device ID, key, and/or other password can be encoded to generate a SAS token, which can be transmitted over the network during communications with cloud platform 324. For example, the SAS token can be transmitted during telemetry data transmission, equipment alarms transmission, schedule synchronization between gateway device 302 and cloud platform 324, and/or modifying setpoints and configuration parameters.

### Containerization of Gateway Components on Edge Devices

Systems and methods described herein are directed to the integration and containerization of gateway components on edge devices, which may include building device gateways. A gateway executes a building device interface container that communicates, via an interface implemented by the building device interface container, with one or more building devices of the building to control or collect data from the one or more building devices. The gateway executes a graphical interface container that generates a graphical user interface based on the data from the one or more building devices. The gateway implements a virtual communication bus that facilitates communication between the building device interface container and the graphical interface container. In some embodiments, the systems and methods described below can be implemented in tandem with the gateway devices 302 and 602.

Referring generally to the figures, systems and methods for a building management system (BMS) with an edge system is shown, according to various exemplary embodiments. The edge system may, in some embodiments, be a software service added to a network of a BMS that can run on one or multiple different nodes of the network. The software service can be made up in terms of components, e.g., integration components, connector components, a building normalization component, software service components, endpoints, etc. The various components can be deployed on various nodes of the network to implement an edge platform that facilitates communication between a cloud or other off-premises platform and the local subsystems of the building. In some embodiments, the edge platform techniques described herein can be implemented for supporting off-premises platforms such as servers, computing clusters, computing systems located in a building other than the edge platform, or any other computing environment.

The nodes of the network could be servers, desktop computers, controllers, virtual machines, etc. In some implementations, the edge system can be deployed on multiple nodes of a network or multiple devices of a BMS with or without interfacing with a cloud or off-premises system. For example, in some implementations, the systems and methods of the present disclosure could be used to coordinate between multiple on-premises devices to perform functions of the BMS partially or wholly without interacting with a cloud or off-premises device (e.g., in a peer-to-peer manner between edge-based devices or in coordination with an on-premises server/gateway).

In some embodiments, the various components of the edge platform can be moved around various nodes of the BMS network as well as the cloud platform. The components may include software services, e.g., control applications, analytics applications, machine learning models, artificial intelligence systems, user interface applications, etc. The software services may have requirements, e.g., a requirement that another software service be present or be in communication with the software service, a particular level of processing resource availability, a particular level of storage availability, etc. In some embodiments, the services of the edge platform can be moved around the nodes of the network based on available data, processing hardware, memory devices, etc. of the nodes. The various software services can be dynamically relocated around the nodes of the network based on the requirements for each software service. In some embodiments, an orchestrator run in a cloud platform, orchestrators distributed across the nodes of the network, and/or the software service itself can make determinations to dynamically relocate the software service around the nodes of the network and/or the cloud platform.

In some embodiments, the edge system can implement plug and play capabilities for connecting devices of a building and connecting the devices to the cloud platform. In some embodiments, the components of the edge system can automatically configure the connection for a new device. For example, when a new device is connected to the edge platform, a tagging and/or recognition process can be performed. This tagging and recognition could be performed in a first building. The result of the tagging and/or recognition may be a configuration indicating how the new device or subsystem should be connected, e.g., point mappings, point lists, communication protocols, necessary integrations, etc. The tagging and/or discovery can, in some embodiments, be performed in a cloud platform and/or twin platform, e.g., based on a digital twin. The resulting configuration can be distributed to every node of the edge system, e.g., to a building normalization component. In some embodiments, the configuration can be stored in a single system, e.g., the cloud platform, and the building normalization component can retrieve the configuration from the cloud platform.

When another device of the same type is installed in the building or another building, a building normalization component can store an indication of the configuration and/or retrieve the indication of the configuration from the cloud platform. The building normalization component can facilitate plug and play by loading and/or implementing the configuration for the device without requiring a tagging and/or discover process. This can allow for the device to be installed and run without requiring any significant amount of setup.

In some embodiments, the building normalization component of one node may discover a device connected to the node. Responsive to detecting the new device, the building normalization component may search a device library and/or registry stored in the normalization component (or on another system) to identify a configuration for the new device. If the new device configuration is not present, the normalization component may send a broadcast to other nodes. For example, the broadcast could indicate an air handling unit (AHU) of a particular type, for a particular vendor, with particular points, etc. Other nodes could respond to the broadcast message with a configuration for the AHU. In some embodiments, a cloud platform could unify configurations for devices of multiple building sites and thus a configuration discovered at one building site could be used at another building site through the cloud platform. In some embodiments, the configurations for different devices could be stored in a digital twin. The digital twin could be used to perform auto configuration, in some embodiments.

In some embodiments, a digital twin of a building could be analyzed to identify how to configure a new device when the new device is connected to an edge device. For example, the digital twin could indicate the various points, communication protocols, functions, etc. of a device type of the new device (e.g., another instance of the device type). Based on the indication of the digital twin, a particular configuration for the new device could be deployed to the edge device that facilitates communication for the new device.

### Containerization of Gateway Components on Edge Devices—Building Data Platform

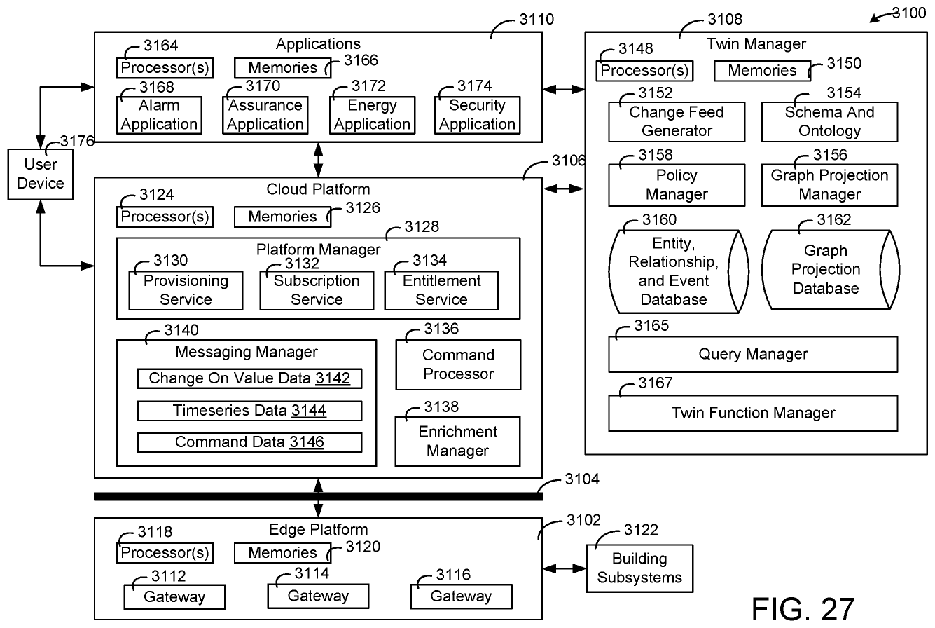

Referring now to FIG. 27, a building data platform 3100 including an edge platform 3102, a cloud platform 3106, and a twin manager 3108 are shown, according to an exemplary embodiment. The edge platform 3102, the cloud platform 3106, and the twin manager 3108 can each be separate services deployed on the same or different computing systems. In some embodiments, the cloud platform 3106 and the twin manager 3108 are implemented in off premises computing systems, e.g., outside a building. The edge platform 3102 can be implemented on-premises, e.g., within the building. However, any combination of on-premises and off-premises components of the building data platform 3100 can be implemented. The edge platform 3102 can be substantially similar to the gateway device 268, 302, 602,

The building data platform 3100 includes applications 3110. The applications 3110 can be various applications that operate to manage the building subsystems 3122. The applications 3110 can be remote or on-premises applications (or a hybrid of both) that run on various computing systems. The applications 3110 can include an alarm application 3168 configured to manage alarms for the building subsystems 3122. The applications 3110 include an assurance application 3170 that implements assurance services for the building subsystems 3122. In some embodiments, the applications 3110 include an energy application 3172 configured to manage the energy usage of the building subsystems 3122. The applications 3110 include a security application 3174 configured to manage security systems of the building.

In some embodiments, the applications 3110 and/or the cloud platform 3106 interacts with a user device 3176. In some embodiments, a component or an entire application of the applications 3110 runs on the user device 3176. The user device 3176 may be a laptop computer, a desktop computer, a smartphone, a tablet, and/or any other device with an input interface (e.g., touch screen, mouse, keyboard, etc.) and an output interface (e.g., a speaker, a display, etc.).

The applications 3110, the twin manager 3108, the cloud platform 3106, and the edge platform 3102 can be implemented on one or more computing systems, e.g., on processors and/or memory devices. For example, the edge platform 3102 includes processor(s) 3118 and memories 3120 the cloud platform 3106 includes processor(s) 124 and memories 3126, the applications 3110 include processor(s) 3164 and memories 3166 and the twin manager 3108 includes processor(s) 3148 and memories 3150.

The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.).

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

The edge platform 3102 can be configured to provide connection to the building subsystems 3122. The edge platform 3102 can receive messages from the building subsystems 3122 and/or deliver messages to the building subsystems 3122. The edge platform 3102 includes one or multiple gateways, e.g., the gateways 3112-3116. The gateways 3112-3116 can act as a gateway between the cloud platform 3106 and the building subsystems 3122. The gateways 3112-3116 can be the gateways described in U.S. patent application Ser. No. 17/127,303, filed Dec. 18, 5020, the entirety of which is incorporated by reference herein. In some embodiments, the applications 3110 can be deployed on the edge platform 3102. In this regard, lower latency in management of the building subsystems 3122 can be realized.

The edge platform 3102 can be connected to the cloud platform 3106 via a network 3104. The network 3104 can communicatively couple the devices and systems of building data platform 3100. In some embodiments, the network 3104 is at least one of and/or a combination of a Wi-Fi network, a wired Ethernet network, a ZigBee network, a Bluetooth network, and/or any other wireless network. The network 3104 may be a local area network or a wide area network (e.g., the Internet, a building WAN, etc.) and may use a variety of communications protocols (e.g., BACnet, IP, LON, etc.). The network 3104 may include routers, modems, servers, cell towers, satellites, and/or network switches. The network 3104 may be a combination of wired and wireless networks. In some embodiments, the edge platform 3102 can be substantially similar to gateway device 302 and gateway device 602 except as otherwise specified herein.

The cloud platform 3106 can be configured to facilitate communication and routing of messages between the applications 3110, the twin manager 3108, the edge platform 3102, and/or any other system. The cloud platform 3106 can include a platform manager 3128, a messaging manager 3140, a command processor 3136, and an enrichment manager 3138. In some embodiments, the cloud platform 3106 can facilitate messaging between the building data platform 3100 via the network 3104.

The messaging manager 3140 can be configured to operate as a transport service that controls communication with the building subsystems 3122 and/or any other system, e.g., managing commands to devices (C2D), commands to connectors (C2C) for external systems, commands from the device to the cloud (D2C), and/or notifications. The messaging manager 3140 can receive different types of data from the applications 3110, the twin manager 3108, and/or the edge platform 3102. The messaging manager 3140 can receive change on value data 3142, e.g., data that indicates that a value of a point has changed. The messaging manager 3140 can receive timeseries data 3144, e.g., a time correlated series of data entries each associated with a particular time stamp. Furthermore, the messaging manager 3140 can receive command data 3146. All of the messages handled by the cloud platform 3106 can be handled as an event, e.g., the data 3142-3146 can each be packaged as an event with a data value occurring at a particular time (e.g., a temperature measurement made at a particular time).

The cloud platform 3106 includes a command processor 3136. The command processor 3136 can be configured to receive commands to perform an action from the applications 3110, the building subsystems 3122, the user device 3176, etc. The command processor 3136 can manage the commands, determine whether the commanding system is authorized to perform the particular commands, and communicate the commands to the commanded system, e.g., the building subsystems 3122 and/or the applications 3110. The commands could be a command to change an operational setting that control environmental conditions of a building, a command to run analytics, etc.

The cloud platform 3106 includes an enrichment manager 3138. The enrichment manager 3138 can be configured to enrich the events received by the messaging manager 3140. The enrichment manager 3138 can be configured to add contextual information to the events. The enrichment manager 3138 can communicate with the twin manager 3108 to retrieve the contextual information. In some embodiments, the contextual information is an indication of information related to the event. For example, if the event is a timeseries temperature measurement of a thermostat, contextual information such as the location of the thermostat (e.g., what room), the equipment controlled by the thermostat (e.g., what VAV), etc. can be added to the event. In this regard, when a consuming application, e.g., one of the applications 3110 receives the event, the consuming application can operate based on the data of the event, the temperature measurement, and also the contextual information of the event.

The enrichment manager 3138 can solve a problem that when a device produces a significant amount of information, the information may contain simple data without context. An example might include the data generated when a user scans a badge at a badge scanner of the building subsystems 3122. This physical event can generate an output event including such information as “DeviceBadgeScannerID,” “BadgeID,” and/or “Date/Time.” However, if a system sends this data to a consuming application, e.g., Consumer A and a Consumer B, each customer may need to call the building data platform knowledge service to query information with queries such as, “What space, build, floor is that badge scanner in?” or “What user is associated with that badge?”

By performing enrichment on the data feed, a system can be able to perform inferences on the data. A result of the enrichment may be transformation of the message “DeviceBadgeScannerId, BadgeId, Date/Time,” to “Region, Building, Floor, Asset, DeviceId, BadgeId, UserName, EmployeeId, Date/Time Scanned.” This can be a significant optimization, as a system can reduce the number of calls by 1/n, where n is the number of consumers of this data feed.

By using this enrichment, a system can also have the ability to filter out undesired events. If there are 100 building in a campus that receive 400000 events per building each hour, but only 1 building is actually commissioned, only 1/10 of the events are enriched. By looking at what events are enriched and what events are not enriched, a system can do traffic shaping of forwarding of these events to reduce the cost of forwarding events that no consuming application wants or reads.

An example of an event received by the enrichment manager 3138 may be:

```
{
  “id”: “someguid”,
    “eventType”: “Device_Heartbeat”,
    “eventTime”: 5018-01-27T00:00:00+00:00”
    “eventValue”: 1,
    “deviceID”: “someguid”
}
```

An example of an enriched event generated by the enrichment manager 3138 may be:

{
“id”: “someguid”,
“eventType”: “Device_Heartbeat”,
“eventTime”: 5018-01-27T00:00:00+00:00”
“eventValue”: 1,
“deviceID”: “someguid”,
“buildingName”: “Building-48”,
“buildingID”: “SomeGuid”,
“panelID”: “SomeGuid”,
“panelName”: “Building-48-Panel-13”,
“cityID”: 371,
“cityName”: “Milwaukee”,
“stateID”: 48,
“stateName”: “Wisconsin (WI)”,
“countryID”: 1,
“countryName”: “United States”
}

By receiving enriched events, an application of the applications 3110 can be able to populate and/or filter what events are associated with what areas. Furthermore, user interface generating applications can generate user interfaces that include the contextual information based on the enriched events.

The cloud platform 3106 includes a platform manager 3128. The platform manager 3128 can be configured to manage the users and/or subscriptions of the cloud platform 3106. For example, what subscribing building, user, and/or tenant utilizes the cloud platform 3106. The platform manager 3128 includes a provisioning service 3130 configured to provision the cloud platform 3106, the edge platform 3102, and the twin manager 3108. The platform manager 3128 includes a subscription service 3132 configured to manage a subscription of the building, user, and/or tenant while the entitlement service 3134 can track entitlements of the buildings, users, and/or tenants.

The twin manager 3108 can be configured to manage and maintain a digital twin. The digital twin can be a digital representation of the physical environment, e.g., a building. The twin manager 3108 can include a change feed generator 3152, a schema and ontology 3154, a projection manager 3156, a policy manager 3158, an entity, relationship, and event database 3160, and a graph projection database 3162.

The graph projection manager 3156 can be configured to construct graph projections and store the graph projections in the graph projection database 3162. Entities, relationships, and events can be stored in the database 3160. The graph projection manager 3156 can retrieve entities, relationships, and/or events from the database 3160 and construct a graph projection based on the retrieved entities, relationships and/or events. In some embodiments, the database 3160 includes an entity-relationship collection for multiple subscriptions.

In some embodiment, the graph projection manager 3156 generates a graph projection for a particular user, application, subscription, and/or system. In this regard, the graph projection can be generated based on policies for the particular user, application, and/or system in addition to an ontology specific for that user, application, and/or system. In this regard, an entity could request a graph projection and the graph projection manager 3156 can be configured to generate the graph projection for the entity based on policies and an ontology specific to the entity. The policies can indicate what entities, relationships, and/or events the entity has access to. The ontology can indicate what types of relationships between entities the requesting entity expects to see, e.g., floors within a building, devices within a floor, etc. Another requesting entity may have an ontology to see devices within a building and applications for the devices within the graph.

The graph projections generated by the graph projection manager 3156 and stored in the graph projection database 3162 can be a knowledge graph and is an integration point. For example, the graph projections can represent floor plans and systems associated with each floor. Furthermore, the graph projections can include events, e.g., telemetry data of the building subsystems 3122. The graph projections can show application services as nodes and API calls between the services as edges in the graph. The graph projections can illustrate the capabilities of spaces, users, and/or devices. The graph projections can include indications of the building subsystems 3122, e.g., thermostats, cameras, VAVs, etc. The graph projection database 3162 can store graph projections that keep up a current state of a building.

The graph projections of the graph projection database 3162 can be digital twins of a building. Digital twins can be digital replicas of physical entities that enable an in-depth analysis of data of the physical entities and provide the potential to monitor systems to mitigate risks, manage issues, and utilize simulations to test future solutions. Digital twins can play an important role in helping technicians find the root cause of issues and solve problems faster, in supporting safety and security protocols, and in supporting building managers in more efficient use of energy and other facilities resources. Digital twins can be used to enable and unify security systems, employee experience, facilities management, sustainability, etc.

In some embodiments the enrichment manager 3138 can use a graph projection of the graph projection database 3162 to enrich events. In some embodiments, the enrichment manager 3138 can identify nodes and relationships that are associated with, and are pertinent to, the device that generated the event. For example, the enrichment manager 3138 could identify a thermostat generating a temperature measurement event within the graph. The enrichment manager 3138 can identify relationships between the thermostat and spaces, e.g., a zone that the thermostat is located in. The enrichment manager 3138 can add an indication of the zone to the event.

Furthermore, the command processor 3136 can be configured to utilize the graph projections to command the building subsystems 3122. The command processor 3136 can identify a policy for a commanding entity within the graph projection to determine whether the commanding entity has the ability to make the command. For example, the command processor 3136, before allowing a user to make a command, determine, based on the graph projection database 3162, to determine that the user has a policy to be able to make the command.

In some embodiments, the policies can be conditional based policies. For example, the building data platform 3100 can apply one or more conditional rules to determine whether a particular system has the ability to perform an action. In some embodiments, the rules analyze a behavioral based biometric. For example, a behavioral based biometric can indicate normal behavior and/or normal behavior rules for a system. In some embodiments, when the building data platform 3100 determines, based on the one or more conditional rules, that an action requested by a system does not match a normal behavior, the building data platform 3100 can deny the system the ability to perform the action and/or request approval from a higher level system.

For example, a behavior rule could indicate that a user has access to log into a system with a particular IP address between 8 A.M. through 5 P.M. However, if the user logs in to the system at 7 P.M., the building data platform 3100 may contact an administrator to determine whether to give the user permission to log in.

The change feed generator 3152 can be configured to generate a feed of events that indicate changes to the digital twin, e.g., to the graph. The change feed generator 3152 can track changes to the entities, relationships, and/or events of the graph. For example, the change feed generator 3152 can detect an addition, deletion, and/or modification of a node or edge of the graph, e.g., changing the entities, relationships, and/or events within the database 3160. In response to detecting a change to the graph, the change feed generator 3152 can generate an event summarizing the change. The event can indicate what nodes and/or edges have changed and how the nodes and edges have changed. The events can be posted to a topic by the change feed generator 3152.

The change feed generator 3152 can implement a change feed of a knowledge graph. The building data platform 3100 can implement a subscription to changes in the knowledge graph. When the change feed generator 3152 posts events in the change feed, subscribing systems or applications can receive the change feed event. By generating a record of all changes that have happened, a system can stage data in different ways, and then replay the data back in whatever order the system wishes. This can include running the changes sequentially one by one and/or by jumping from one major change to the next. For example, to generate a graph at a particular time, all change feed events up to the particular time can be used to construct the graph.

The change feed can track the changes in each node in the graph and the relationships related to them, in some embodiments. If a user wants to subscribe to these changes and the user has proper access, the user can simply submit a web API call to have sequential notifications of each change that happens in the graph. A user and/or system can replay the changes one by one to reinstitute the graph at any given time slice. Even though the messages are “thin” and only include notification of change and the reference “id/seq id,” the change feed can keep a copy of every state of each node and/or relationship so that a user and/or system can retrieve those past states at any time for each node. Furthermore, a consumer of the change feed could also create dynamic “views” allowing different “snapshots” in time of what the graph looks like from a particular context. While the twin manager 3108 may contain the history and the current state of the graph based upon schema evaluation, a consumer can retain a copy of that data, and thereby create dynamic views using the change feed.

The schema and ontology 3154 can define the message schema and graph ontology of the twin manager 3108. The message schema can define what format messages received by the messaging manager 3140 should have, e.g., what parameters, what formats, etc. The ontology can define graph projections, e.g., the ontology that a user wishes to view. For example, various systems, applications, and/or users can be associated with a graph ontology. Accordingly, when the graph projection manager 3156 generates an graph projection for a user, system, or subscription, the graph projection manager 3156 can generate a graph projection according to the ontology specific to the user. For example, the ontology can define what types of entities are related in what order in a graph, for example, for the ontology for a subscription of “Customer A,” the graph projection manager 3156 can create relationships for a graph projection based on the rule:

Region [symbol] Building [symbol] Floor [symbol] Space [symbol] Asset

For the ontology of a subscription of “Customer B,” the graph projection manager 3156 can create relationships based on the rule:

Building [symbol] Floor [symbol] Asset

The policy manager 3158 can be configured to respond to requests from other applications and/or systems for policies. The policy manager 3158 can consult a graph projection to determine what permissions different applications, users, and/or devices have. The graph projection can indicate various permissions that different types of entities have and the policy manager 3158 can search the graph projection to identify the permissions of a particular entity. The policy manager 3158 can facilitate fine grain access control with user permissions. The policy manager 3158 can apply permissions across a graph, e.g., if “user can view all data associated with floor 1” then they see all subsystem data for that floor, e.g., surveillance cameras, HVAC devices, fire detection and response devices, etc.

The twin manager 3108 includes a query manager 3165 and a twin function manager 3167. The query manger 3164 can be configured to handle queries received from a requesting system, e.g., the user device 3176, the applications 3110, and/or any other system. The query manager 3165 can receive queries that include query parameters and context. The query manager 3165 can query the graph projection database 3162 with the query parameters to retrieve a result. The query manager 3165 can then cause an event processor, e.g., a twin function, to operate based on the result and the context. In some embodiments, the query manager 3165 can select the twin function based on the context and/or perform operates based on the context.

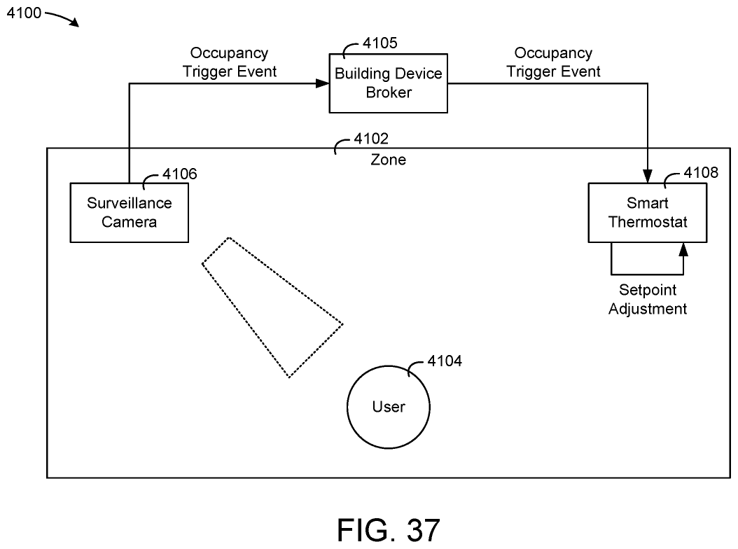

The twin function manager 3167 can be configured to manage the execution of twin functions. The twin function manager 3167 can receive an indication of a context query that identifies a particular data element and/or pattern in the graph projection database 3162. Responsive to the particular data element and/or pattern occurring in the graph projection database 3162 (e.g., based on a new data event added to the graph projection database 3162 and/or change to nodes or edges of the graph projection database 3162, the twin function manager 3167 can cause a particular twin function to execute. The twin function can execute based on an event, context, and/or rules. The event can be data that the twin function executes against. The context can be information that provides a contextual description of the data, e.g., what device the event is associated with, what control point should be updated based on the event, etc. The twin function manager 3167 can be configured to perform the operations of the FIGS. 37-41.

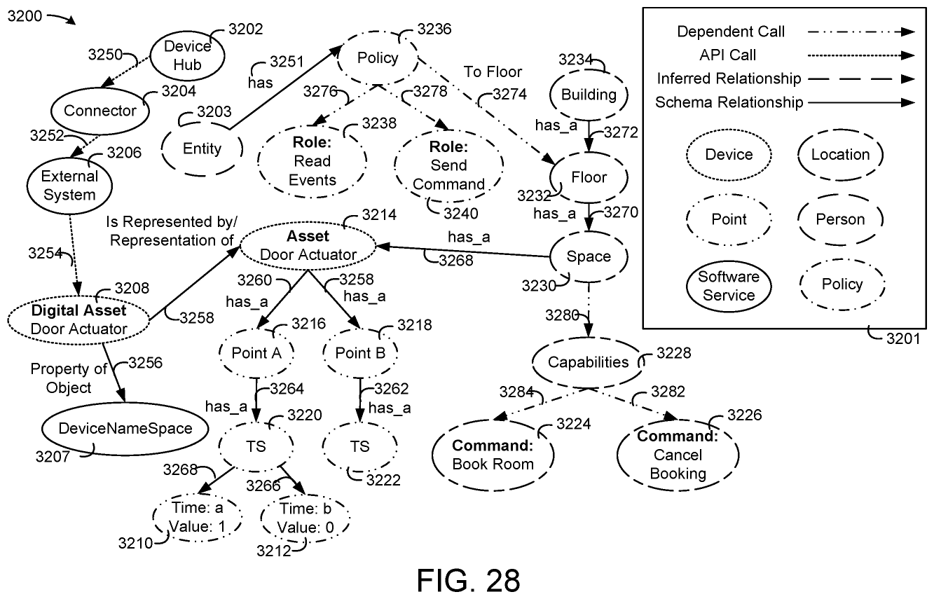

Referring now to FIG. 28, a graph projection 3200 of the twin manager 3108 including application programming interface (API) data, capability data, policy data, and services is shown, according to an exemplary embodiment. The graph projection 3200 includes nodes 3202-3240 and edges 3250-3272. The nodes 3202-3240 and the edges 3250-3272 are defined according to the key 3201. The nodes 3202-3240 represent different types of entities, devices, locations, points, persons, policies, and software services (e.g., API services). The edges 3250-3272 represent relationships between the nodes 3202-3240, e.g., dependent calls, API calls, inferred relationships, and schema relationships (e.g., BRICK relationships).

The graph projection 3200 includes a device hub 3202 which may represent a software service that facilitates the communication of data and commands between the cloud platform 3106 and a device of the building subsystems 3122, e.g., door actuator 3214. The device hub 3202 is related to a connector 3204, an external system 3206, and a digital asset “Door Actuator” 3208 by edge 3250, edge 3252, and edge 3254.

The cloud platform 3106 can be configured to identify the device hub 3202, the connector 3204, the external system 3206 related to the door actuator 3214 by searching the graph projection 3200 and identifying the edges 3250-3254 and edge 3258. The graph projection 3200 includes a digital representation of the “Door Actuator,” node 3208. The digital asset “Door Actuator” 3208 includes a “DeviceNameSpace” represented by node 3207 and related to the digital asset “Door Actuator” 3208 by the “Property of Object” edge 3256.

The “Door Actuator” 3214 has points and timeseries. The “Door Actuator” 3214 is related to “Point A” 3216 by a “has_a” edge 3260. The “Door Actuator” 3214 is related to “Point B” 3218 by a “has_A” edge 3258. Furthermore, timeseries associated with the points A and B are represented by nodes “TS” 3220 and “TS” 3222. The timeseries are related to the points A and B by “has_a” edge 3264 and “has_a” edge 3262. The timeseries “TS” 3220 has particular samples, sample 3210 and 3212 each related to “TS” 3220 with edges 3268 and 3266 respectively. Each sample includes a time and a value. Each sample may be an event received from the door actuator that the cloud platform 3106 ingests into the entity, relationship, and event database 3160, e.g., ingests into the graph projection 3200.

The graph projection 3200 includes a building 3234 representing a physical building. The building includes a floor represented by floor 3232 related to the building 3234 by the “has_a” edge from the building 3234 to the floor 3232. The floor has a space indicated by the edge “has_a” 3270 between the floor 3232 and the space 3230. The space has particular capabilities, e.g., is a room that can be booked for a meeting, conference, private study time, etc. Furthermore, the booking can be canceled. The capabilities for the floor 3232 are represented by capabilities 3228 related to space 3230 by edge 3280. The capabilities 3228 are related to two different commands, command “book room” 3224 and command “cancel booking” 3226 related to capabilities 3228 by edge 3284 and edge 3282 respectively.

If the cloud platform 3106 receives a command to book the space represented by the node, space 3230, the cloud platform 3106 can search the graph projection 3200 for the capabilities for the 3228 related to the space 3230 to determine whether the cloud platform 3106 can book the room.

In some embodiments, the cloud platform 3106 could receive a request to book a room in a particular building, e.g., the building 3234. The cloud platform 3106 could search the graph projection 3200 to identify spaces that have the capabilities to be booked, e.g., identify the space 3230 based on the capabilities 3228 related to the space 3230. The cloud platform 3106 can reply to the request with an indication of the space and allow the requesting entity to book the space 3230.

The graph projection 3200 includes a policy 3236 for the floor 3232. The policy 3236 is related set for the floor 3232 based on a “To Floor” edge 3274 between the policy 3236 and the floor 3232. The policy 3236 is related to different roles for the floor 3232, read events 3238 via edge 3276 and send command 3240 via edge 3278. The policy 3236 is set for the entity 3203 based on has edge 3251 between the entity 3203 and the policy 3236.

The twin manager 3108 can identify policies for particular entities, e.g., users, software applications, systems, devices, etc. based on the policy 3236. For example, if the cloud platform 3106 receives a command to book the space 3230. The cloud platform 3106 can communicate with the twin manager 3108 to verify that the entity requesting to book the space 3230 has_a policy to book the space. The twin manager 3108 can identify the entity requesting to book the space as the entity 3203 by searching the graph projection 3200. Furthermore, the twin manager 3108 can further identify the edge has 3251 between the entity 3203 and the policy 3236 and the edge between the policy 3236 and the command 3240.

Furthermore, the twin manager 3108 can identify that the entity 3203 has the ability to command the space 3230 based on the edge between the policy 3236 and the edge 3270 between the floor 3232 and the space 3230. In response to identifying the entity 3203 has the ability to book the space 3230, the twin manager 3108 can provide an indication to the cloud platform 3106.

Furthermore, if the entity makes a request to read events for the space 3230, e.g., the sample 3210 and the sample 3212, the twin manager 3108 can identify the edge has 3251 between the entity 3203 and the policy 3236, the edge between the policy 3236 and the read events 3238, the edge between the policy 3236 and the floor 3232, the “has_a” edge 3270 between the floor 3232 and the space 3230, the edge 3268 between the space 3230 and the door actuator 3214, the edge 3260 between the door actuator 3214 and the point A 3216, the “has_a” edge 3264 between the point A 3216 and the TS 3220, and the edges 3268 and 3266 between the TS 3220 and the samples 3210 and 3212 respectively.

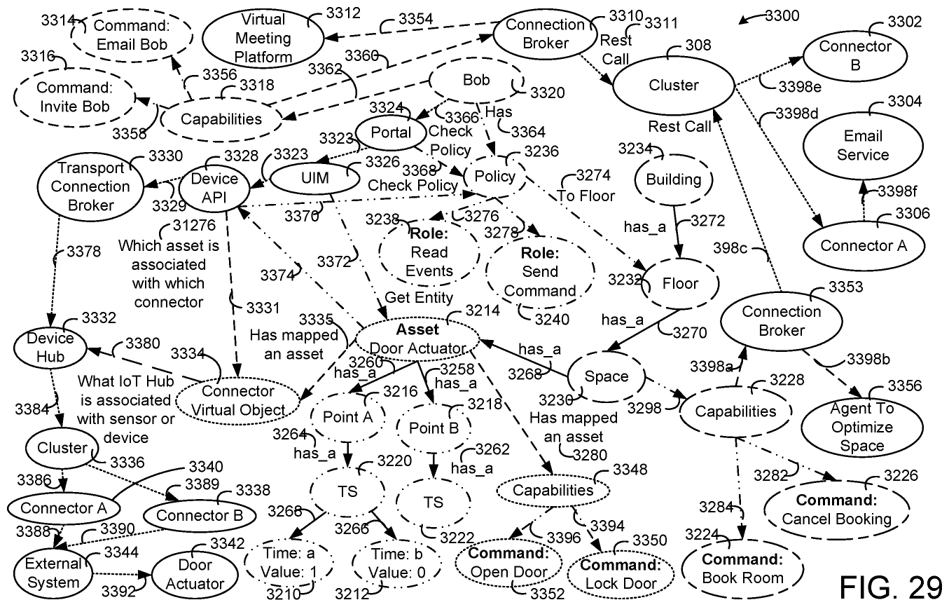

Referring now to FIG. 29, a graph projection 3300 of the twin manager 3108 including application programming interface (API) data, capability data, policy data, and services is shown, according to an exemplary embodiment. The graph projection 3300 includes the nodes and edges described in the graph projection 3200 of FIG. 28. The graph projection 3300 includes a connection broker related to capabilities 3228 by edge 3398a. The connection broker 3353 can be a node representing a software application configured to facilitate a connection with another software application. In some embodiments, the cloud platform 3106 can identify the system that implements the capabilities 3228 by identifying the edge 3398a between the capabilities 3228 and the connection broker 3353.

The connection broker 3353 is related to an agent that optimizes a space 3356 via edge 3398b. The agent represented by the node 3356 can book and cancel bookings for the space represented by the node 3230 based on the edge 3398b between the connection broker 3353 and the node 3356 and the edge 3398a between the capabilities 3228 and the connection broker 3353.

The connection broker 3353 is related to a cluster 3308 by edge 3398c. Cluster 3308 is related to connector B 3302 via edge 3398e and connector A 3306 via edge 3398d. The connector A 3306 is related to an external subscription service 3304. A connection broker 3310 is related to cluster 3308 via an edge 3311 representing a rest call that the connection broker represented by node 3310 can make to the cluster represented by cluster 3308.

The connection broker 3310 is related to a virtual meeting platform 3312 by an edge 3354. The node 3312 represents an external system that represents a virtual meeting platform. The connection broker represented by node 3310 can represent a software component that facilitates a connection between the cloud platform 3106 and the virtual meeting platform represented by node 3312. When the cloud platform 3106 needs to communicate with the virtual meeting platform represented by the node 3312, the cloud platform 3106 can identify the edge 3354 between the connection broker 3310 and the virtual meeting platform 3312 and select the connection broker represented by the node 3310 to facilitate communication with the virtual meeting platform represented by the node 3312.

A capabilities node 3318 can be connected to the connection broker 3310 via edge 3360. The capabilities 3314 can be capabilities of the virtual meeting platform represented by the node 3312 and can be related to the node 3312 through the edge 3360 to the connection broker 3310 and the edge 3354 between the connection broker 3310 and the node 3312. The capabilities 3314 can define capabilities of the virtual meeting platform represented by the node 3312. The node 3320 is related to capabilities 3314 via edge 3362. The capabilities may be an invite bob command represented by node 3316 and an email bob command represented by node 3314. The capabilities 3314 can be linked to a node 3320 representing a user, Bob. The cloud platform 3106 can facilitate email commands to send emails to the user Bob via the email service represented by the node 3304. The node 3304 is related to the connect a node 3306 via edge 3398f. Furthermore, the cloud platform 3106 can facilitate sending an invite for a virtual meeting via the virtual meeting platform represented by the node 3312 linked to the node 3318 via the edge 3358.

The node 3320 for the user Bob can be associated with the policy 3236 via the “has” edge 3364. Furthermore, the node 3320 can have a “check policy” edge 3366 with a portal node 3324. The device API node 3328 has a check policy edge 3370 to the policy node 3236. The portal node 3324 has an edge 3368 to the policy node 3236. The portal node 3324 has an edge 3323 to a node 3326 representing a user input manager (UIM). The portal node 3324 is related to the UIM node 3326 via an edge 3323. The UIM node 3326 has an edge 3323 to a device API node 3328. The UIM node 3326 is related to the door actuator node 3214 via edge 3372. The door actuator node 3214 has an edge 3374 to the device API node 3328. The door actuator 3214 has an edge 3335 to the connector virtual object 3334. The device hub 3332 is related to the connector virtual object via edge 3380. The device API node 3328 can be an API for the door actuator 3214. The connector virtual object 3334 is related to the device API node 3328 via the edge 3331.

The device API node 3328 is related to a transport connection broker 3330 via an edge 3329. The transport connection broker 3330 is related to a device hub 3332 via an edge 3378. The device hub represented by node 3332 can be a software component that hands the communication of data and commands for the door actuator 3214. The cloud platform 3106 can identify where to store data within the graph projection 3300 received from the door actuator by identifying the nodes and edges between the points 3216 and 3218 and the device hub node 3332. Similarly, the cloud platform 3308 can identify commands for the door actuator that can be facilitated by the device hub represented by the node 3332, e.g., by identifying edges between the device hub node 3332 and an open door node 3352 and an lock door node 3350. The door actuator 3114 has an edge “has mapped an asset” 3280 between the node 3214 and a capabilities node 3348. The capabilities node 3348 and the nodes 3352 and 3350 are linked by edges 3396 and 3394.

The device hub 3332 is linked to a cluster 3336 via an edge 3384. The cluster 3336 is linked to connector A 3340 and connector B 3338 by edges 3386 and the edge 3389. The connector A 3340 and the connector B 3338 is linked to an external system 3344 via edges 3388 and 3390. The external system 3344 is linked to a door actuator 3342 via an edge 3392.

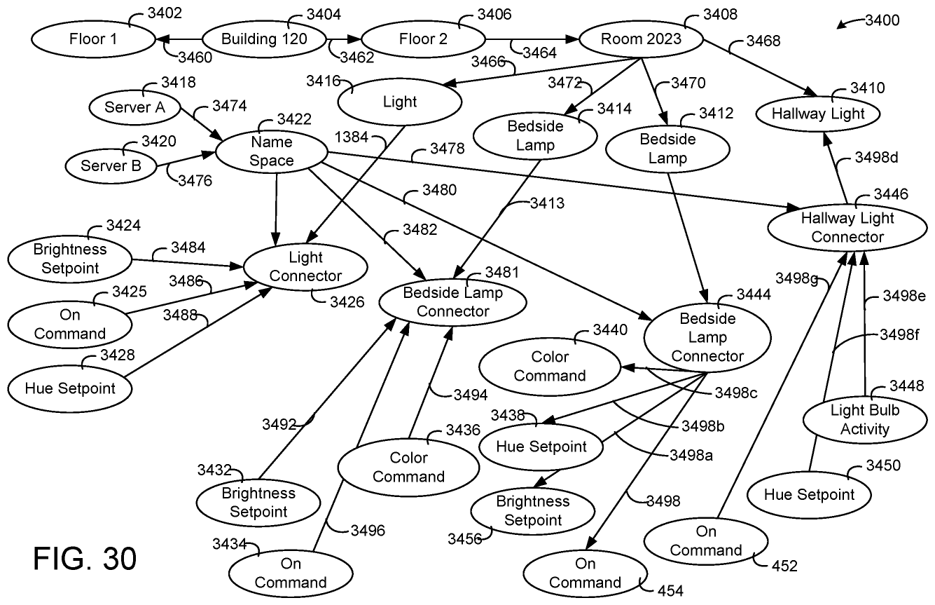

Referring now to FIG. 30, a graph projection 3400 of the twin manager 3108 including equipment and capability data for the equipment is shown, according to an exemplary embodiment. The graph projection 3400 includes nodes 3402-3456 and edges 3360-3498f. The cloud platform 3106 can search the graph projection 3400 to identify capabilities of different pieces of equipment.

A building node 3404 represents a particular building that includes two floors. A floor 1 node 3402 is linked to the building node 3404 via edge 3460 while a floor 2 node 3406 is linked to the building node 3404 via edge 3462. The floor 2 includes a particular room represented by edge 3464 between floor 2 node 3406 and room node 3408. Various pieces of equipment are included within the room. A light represented by light node 3416, a bedside lamp node 3414, a bedside lamp node 3412, and a hallway light node 3410 are related to room node 3408 via edge 3466, edge 3472, edge 3470, and edge 3468.

The light represented by light node 3416 is related to a light connector 3426 via edge 3484. The light connector 3426 is related to multiple commands for the light represented by the light node 3416 via edges 3484, 3486, and 3488. The commands may be a brightness setpoint 3424, an on command 3425, and a hue setpoint 3428. The cloud platform 3106 can receive a request to identify commands for the light represented by the light 3416 and can identify the nodes 3424-3428 and provide an indication of the commands represented by the node 3424-3428 to the requesting entity. The requesting entity can then send commands for the commands represented by the nodes 3424-3428.

The bedside lamp node 3414 is linked to a bedside lamp connector 3481 via an edge 3413. The connector 3481 is related to commands for the bedside lamp represented by the bedside lamp node 3414 via edges 3492, 3496, and 3494. The command nodes are a brightness setpoint node 3432, an on command node 3434, and a color command 3436. The hallway light 3410 is related to a hallway light connector 3446 via an edge 3498d. The hallway light connector 3446 is linked to multiple commands for the hallway light node 3410 via edges 3498g, 3498f, and 3498e. The commands are represented by an on command node 3452, a hue setpoint node 3450, and a light bulb activity node 3448.

The graph projection 3400 includes a name space node 3422 related to a server A node 3418 and a server B node 3420 via edges 3474 and 3476. The name space node 3422 is related to the bedside lamp connector 3481, the bedside lamp connector 3444, and the hallway light connector 3446 via edges 3482, 3480, and 3478. The bedside lamp connector 3444 is related to commands, e.g., the color command node 3440, the hue setpoint command 3438, a brightness setpoint command 3456, and an on command 3454 via edges 3498c, 3498b, 3498a, and 3498.

### Containerization of Gateway Components on Edge Devices—Edge Platform

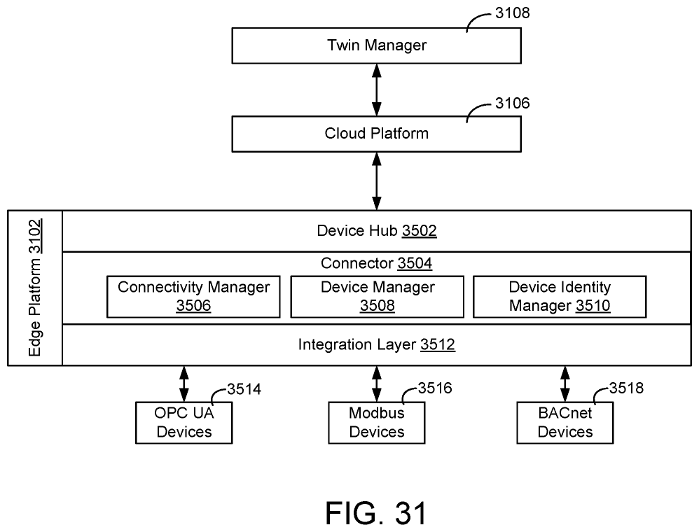

Referring now to FIG. 31, the edge platform 3102 is shown in greater detail to include a connectivity manager 3506, a device manager 3508, and a device identity manager 3510, according to an exemplary embodiment. In some embodiments, the edge platform 3102 of FIG. 30 may be a particular instance run on a computing device. For example, the edge platform 3102 could be instantiated one or multiple times on various computing devices of a building, a cloud, etc. In some embodiments, each instance of the edge platform 3102 may include the connectivity manager 3506, the device manager 3508, and/or the device identity manager 3510. These three components may serve as the core of the edge platform 3102.

The edge platform 3102 can include a device hub 3502, a connector 3504, and/or an integration layer 3512. The edge platform 3102 can facilitate communication between the devices 3514-3518 and the cloud platform 3106 and/or twin manager 3108. The communication can be telemetry, commands, control data, etc. Examples of command and control via a building data platform is described in U.S. patent application Ser. No. 17/134,661 filed Dec. 28, 5020, the entirety of which is incorporated by reference herein.

The devices 3514-3518 can be building devices that communicate with the edge platform 3102 via a variety of various building protocols. For example, the protocol could be Open Platform Communications (OPC) Unified Architecture (UA), Modbus, BACnet, etc. The integration layer 3512 can, in some embodiments, integrate the various devices 3514-3518 through the respective communication protocols of each of the devices 3514-3518. In some embodiments, the integration layer 3512 can dynamically include various integration components based on the needs of the instance of the edge platform 3102, for example, if a BACnet device is connected to the edge platform 3102, the edge platform 3102 may run a BACnet integration component. The connector 3504 may be the core service of the edge platform 3102. In some embodiments, every instance of the edge platform 3102 can include the connector 3504. In some embodiments, the edge platform 3102 is a light version of a gateway.

In some embodiments, the connectivity manager 3506 operates to connect the devices 3514-3518 with the cloud platform 3106 and/or the twin manager 3108. The connectivity manager 3506 can allow a device running the connectivity manager 3506 to connect with an ecosystem, the cloud platform 3106, another device, another device which in turn connects the device to the cloud, connects to a data center, a private on-premises cloud, etc. The connectivity manager 3506 can facilitate communication northbound (with higher level networks), southbound (with lower level networks), and/or east/west (e.g., with peer networks). The connectivity manager 3506 can implement communication via MQ Telemetry Transport (MQTT) and/or sparkplug, in some embodiments. The operational abilities of the connectivity manager 3506 can be extended via an software development toolkit (SDK), and/or an API. In some embodiments, the connectivity manager 3506 can handle offline network states with various networks.

In some embodiments, the device manager 3508 can be configured to manage updates and/or upgrades for the device that the device manager 3508 is run on, the software for the edge platform 3102 itself, and/or devices connected to the edge platform 3102, e.g., the devices 3514-3518. The software updates could be new software components, e.g., services, new integrations, etc. The device manager 3508 can be used to manage software for edge platforms for a site, e.g., make updates or changes on a large scale across multiple devices. In some embodiments, the device manager 3508 can implement an upgrade campaign where one or more certain device types and/or pieces of software are all updated together. The update depth may be of any order, e.g., a single update to a device, an update to a device and a lower level device that the device communication with, etc. In some embodiments, the software updates are delta updates, which are suitable for low-bandwidth devices. For example, instead of replacing an entire piece of software on the edge platform 3102, only the portions of the piece of software that need to be updated may be updated, thus reducing the amount of data that needs to be downloaded to the edge platform 3102 in order to complete the update.

The device identity manager 3510 can implement authorization and authentication for the edge platform 3102. For example, when the edge platform 3102 connects with the cloud platform 3106, the twin manager 3108, and/or the devices 3514-3518, the device identity manager 3510 can identify the edge platform 3102 to the various platforms, managers, and/or devices. Regardless of the device that the edge platform 3102 is implemented on, the device identity manager 3510 can handle identification and uniquely identify the edge platform 3102. The device identity manager 3510 can handle certification management, trust data, authentication, authorization, encryption keys, credentials, signatures, etc. Furthermore, the device identity manager 3510 may implement various security features for the edge platform 3102, e.g., antivirus software, firewalls, verified private networks (VPNs), etc. Furthermore, the device identity manager 3510 can manage commissioning and/or provisioning for the edge platform 3102.

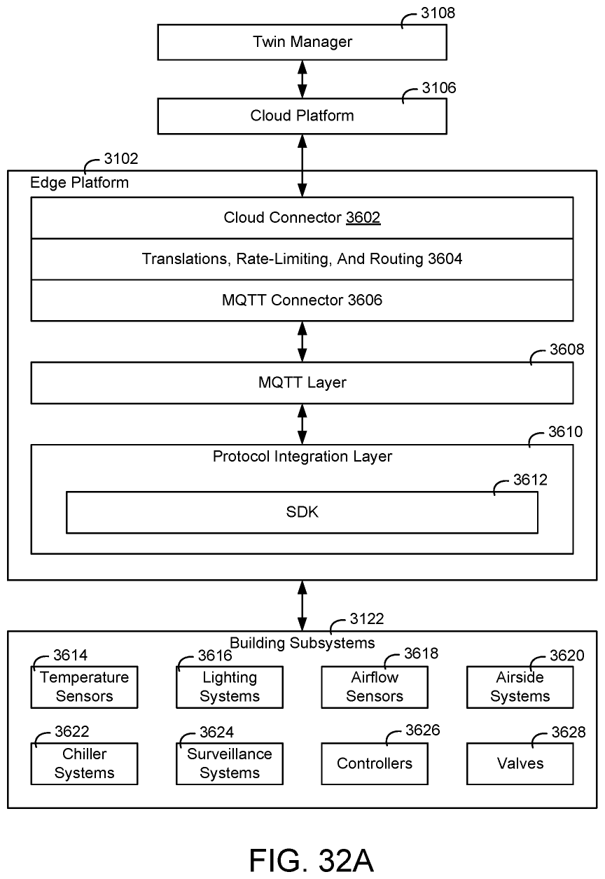

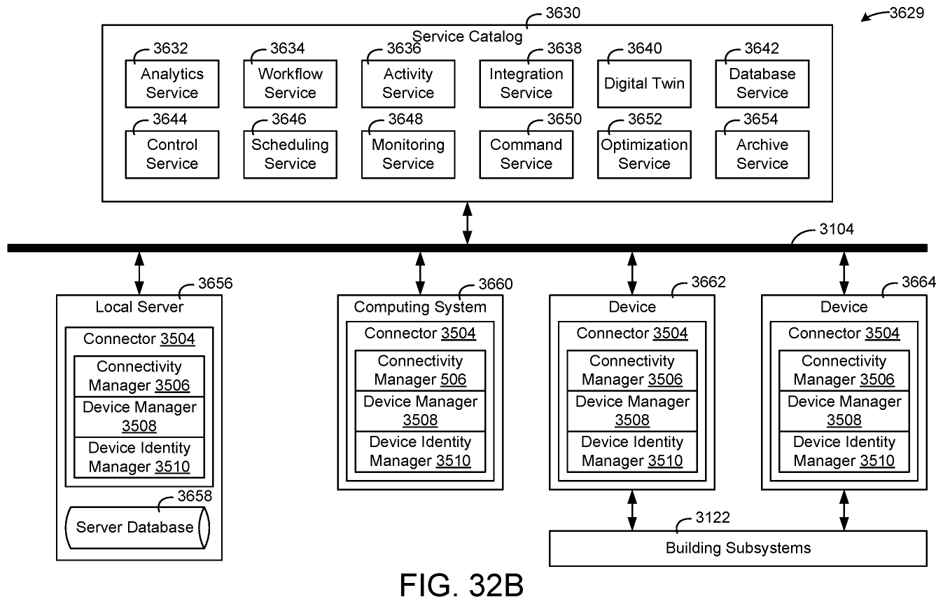

Referring now to FIG. 32A, another block diagram of the edge platform 3102 is shown in greater detail to include communication layers for facilitating communication between building subsystems 3122 and the cloud platform 3106 and/or the twin manager of FIG. 27, according to an exemplary embodiment. The building subsystems 3122 may include devices of various different building subsystems, e.g., HVAC subsystems, fire response subsystems, access control subsystems, surveillance subsystems, etc. The devices may include temperature sensors 3614, lighting systems 3616, airflow sensors 3618, airside systems 3620, chiller systems 3622, surveillance systems 3624, controllers 3626, valves 3628, etc.

The edge platform 3102 can include a protocol integration layer 3610 that facilities communication with the building subsystems 3122 via one or more protocols. In some embodiments, the protocol integration layer 3610 can be dynamically updated with a new protocol integration responsive to detecting that a new device is connected to the edge platform 3102 and the new device requires the new protocol integration. In some embodiments, the protocol integration layer 3610 can be customized through an SDK 3612.

In some embodiments, the edge platform 3102 can handle MQTT communication through an MQTT layer 3608 and an MQTT connector 3606. In some embodiments, the MQTT layer 3608 and/or the MQTT connector 3606 handles MQTT based communication and/or any other publication/subscription based communication where devices can subscribe to topics and publish to topics. In some embodiments, the MQTT connector 3606 implements an MQTT broker configured to manage topics and facilitate publications to topics, subscriptions to topics, etc. to support communication between the building subsystems 3122 and/or with the cloud platform 3106. An example of devices of a building communicating via a publication/subscription method is shown in FIG. 36.

The edge platform 3102 includes a translations, rate-limiting, and routing layer 3604. The layer 6604 can handle translating data from one format to another format, e.g., from a first format used by the building subsystems 3122 to a format that the cloud platform 3106 expects, or vice versa. The layer 6604 can further perform rate limiting to control the rate at which data is transmitted, requests are sent, requests are received, etc. The layer 6604 can further perform message routing, in some embodiments. The cloud connector 3602 may connect the edge platform 3102, e.g., establish and/or communicate with one or more communication endpoints between the cloud platform 3106 and the cloud connector 3602.

Referring now to FIG. 32B, a system 3629 where the edge platform 3102 is shown distributed across building devices of a building, according to an exemplary embodiment. The local server 3656, the computing system 3660, the device 3662, and/or the device 3664 may all be located on-premises within a building, in some embodiments. The various devices 3662 and/or 3664 may, in some embodiments, be gateway boxes, e.g., gateways 3112-3116. The gateway boxes may be the various gateways described in U.S. patent application Ser. No. 17/127,303 filed Dec. 18, 5020, the entirety of which is incorporated by reference herein. The computing system 3660 could be a desktop computer, a server system, a microcomputer, a mini personal computer (PC), a laptop computer, a dedicated computing resource in a building, etc. The local server 3656 may be an on-premises computer system that provides resources, data, services or other programs to computing devices of the building. The system 3629 includes a local server 3656 that can include a server database 3658 that stores data of the building, in some embodiments.

In some embodiments, the device 3662 and/or the device 3664 implement gateway operations for connecting the devices of the building subsystems 3122 with the cloud platform 3106 and/or the twin manager 3108. In some embodiments, the devices 3662 and/or 3664 can communicate with the building subsystems 3122, collect data from the building subsystems 3122, and communicate the data to the cloud platform 3106 and/or the twin manager 3108. In some embodiments, the devices 3662 and/or the device 3664 can push commands from the cloud platform 3106 and/or the twin manager 3108 to the building subsystem 3122.

The systems and devices 3656-3664 can each run an instance of the edge platform 3102. In some embodiments, the systems and devices 3656-3664 run the connector 3504 which may include, in some embodiments, the connectivity manager 3506, the device manager 3508, and/or the device identity manager 3510. In some embodiments, the device manager 3508 controls what services each of the systems and devices 3656-3664 run, e.g., what services from a service catalog 3630 each of the systems and devices 3656-3664 run.

The service catalog 3630 can be stored in the cloud platform 3106, within a local server (e.g., in the server database 3658 of the local server 3656), on the computing system 3660, on the device 3662, on the device 3664, etc. The various services of the service catalog 3630 can be run on the systems and devices 3656-3664, in some embodiments. The services can further move around the systems and devices 3656-3664 based on the available computing resources, processing speeds, data availability, the locations of other services which produce data or perform operations required by the service, etc.

The service catalog 3630 can include an analytics service 3632 that generates analytics data based on building data of the building subsystems 3122, a workflow service 3634 that implements a workflow, and/or an activity service 3636 that performs an activity. The service catalog 3630 includes an integration service 3638 that integrates a device with a particular subsystem (e.g., a BACnet integration, a Modbus integration, etc.), a digital twin service 3640 that runs a digital twin, and/or a database service 3642 that implements a database for storing building data. The service catalog 3630 can include a control service 3644 for operating the building subsystems 3122, a scheduling service 3646 that handles scheduling of areas (e.g., desks, conference rooms, etc.) of a building, and/or a monitoring service 3648 that monitors a piece of equipment of the building subsystem 3122. The service catalog 3630 includes a command service 3650 that implements operational commands for the building subsystems 3122, an optimization service 3652 that runs an optimization to identify operational parameters for the building subsystems 3122, and/or achieve service 3654 that archives settings, configurations, etc. for the building subsystem 3122, etc.

In some embodiments, the various systems 3656, 3660, 3662, and 3664 can realize technical advantages by implementing services of the service catalog 3630 locally and/or storing the service catalog 3630 locally. Because the services can be implemented locally, i.e., within a building, lower latency can be realized in making control decisions or deriving information since the communication time between the systems 3656, 3660, 3662, and 3664 and the cloud is not needed to run the services. Furthermore, because the systems 3656, 3660, 3662, and 3664 can run independently of the cloud (e.g., implement their services independently) even if the network 3104 fails or encounters an error that prevents communication between the cloud and the systems 3656, 3660, 3662, and 3664, the systems can continue operation without interruption. Furthermore, by balancing computation between the cloud and the systems 3656, 3660, 3662, and 3664, power usage can be balanced more effectively. Furthermore, the system 3629 has the ability to scale (e.g., grow or shrink) the functionality/services provided on edge devices based on capabilities of edge hardware onto which edge system is being implemented.

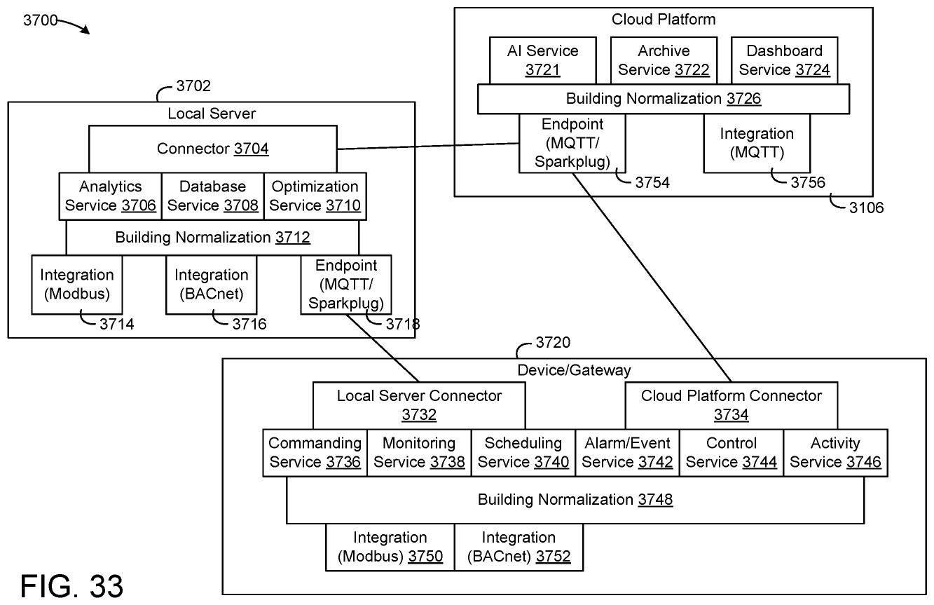

Referring now to FIG. 33, a system 3700 where connectors, building normalization layers, services, and integrations are distributed across various computing devices of a building is shown, according to an exemplary embodiment. In the system 3700, the cloud platform 3106, a local server 3702, and a device/gateway 3720 run components of the edge platform 3102, e.g., connectors, building normalization layers, services, and integrations. The local server 3702 can be a server system located within a building. The device/gateway 3720 could be a building device located within the building, in some embodiments. For example, the device/gateway 3720 could be a smart thermostat, a surveillance camera, an access control system, etc. In some embodiments, the device gateway 3720 is a dedicated gateway box. The building device may be a physical building device, and may include a memory device (e.g., a flash memory, a RAM, a ROM, etc.). The memory of the physical building device can store one or more data samples, which may be any data related to the operation of the physical building device. For example, if the building device is a smart thermostat, the data samples can be timestamped temperature readings. If the building device is a surveillance camera, the data samples may be

The local server 3702 can include a connector 3704, services 3706-3710, a building normalization layer 3712, and integrations 3714-3718. These components of the local server 3702 can be deployed to the local server 3702, e.g., from the cloud platform 3106. These components may further be dynamically moved to various other devices of the building, in some embodiments. The connector 3704 may be the connector described with reference to FIG. 30 that includes the connectivity manager 3506, the device manager 3508, and/or the device identity manager 3510. The connector 3704 may connect the local server 3702 with the cloud platform 3106, in some embodiments. For example, the connector 3704 may enable communication with an endpoint of the cloud platform 3106, e.g., the endpoint 3754 which could be an MQTT endpoint or a Sparkplug endpoint.

The building normalization layer 3712 can be a software component that runs the integrations 3714-3718 and/or the analytics 3706-3710. The building normalization layer 3712 can be configured to allow for a variety of different integrations and/or analytics to be deployed to the local server 3702. In some embodiments, the building normalization layer 3712 could allow for any service of the service catalog 3630 to run on the local server 3702. Furthermore, the building normalization layer 3712 can relocate, or allow for relocation, of services and/or integrations across the cloud platform 3106, the local server 3702, and/or the device/gateway 3720. In some embodiments, the services 3706-3710 are relocatable based on processing power of the local server 3702, based on communication bandwidth, available data, etc. The services can be moved from one device to another in the system 3700 such that the requirements for the service are met appropriately.

Furthermore, instances of the integrations 3714-3718 can be relocatable and/or deployable. The integrations 3714-3718 may be instantiated on devices of the system 3700 based on the requirements of the devices, e.g., whether the local server 3702 needs to communicate with a particular device (e.g., the Modbus integration 3714 could be deployed to the local server 3702 responsive to a detection that the local server 3702 needs to communicate with a Modbus device). The locations of the integrations can be limited by the physical protocols that each device is capable of implementing and/or security limitations of each device.

In some embodiments, the deployment and/or movement of services and/or integrations can be done manually and/or in an automated manner. For example, when a building site is commissioned, a user could manually select, e.g., via a user interface on the user device 3176, the devices of the system 3700 where each service and/or integration should run. In some embodiments, instead of having a user select the locations, a system, e.g., the cloud platform 3106, could deploy services and/or integrations to the devices of the system 3700 automatically based on the ideal locations for each of multiple different services and/or integrations.

In some embodiments, an orchestrator (e.g., run on instances of the building normalization layer 3712 or in the cloud platform 3106) or a service and/or integration itself could determine that a particular service and/or integration should move from one device to another device after deployment. In some embodiments, as the devices of the system 3700 change, e.g., more or less services are run, hard drives are filled with data, physical building devices are moved, installed, and/or uninstalled, the available data, bandwidth, computing resources, and/or memory resources may change. The services and/or integrations can be moved from a first device to a second more appropriate device responsive to a detection that the first device is not meeting the requirements of the service and/or integration.

As an example, an energy efficiency model service could be deployed to the system 3700. For example, a user may request that an energy efficiency model service run in their building. Alternatively, a system may identify that an energy efficiency model service would improve the performance of the building and automatically deploy the service. The energy efficiency model service may have requirements. For example, the energy efficiency model may have a high data throughput requirement, a requirement for access to weather data, a high requirement for data storage to store historical data needed to make inferences, etc. In some embodiments, a rules engine with rules could define whether services get pushed around to other devices, whether model goes back to the cloud for more training, whether an upgrade is needed to implement an increase in points, etc.

As another example, a historian service may manage a log of historical building data collected for a building, e.g., store a record of historical temperature measurements of a building, store a record of building occupant counts, store a record of operational control decisions (e.g., setpoints, static pressure setpoints, fan speeds, etc.), etc. One or more other services may depend on the historian, for example, the one or more other services may consume historical data recorded by the historian. In some embodiments, other services can be relocated along with the historian service such that the other services can operate on the historian data. For example, an occupancy prediction service may need a historical log of occupancy record by the historian service to run. In some embodiments, instead of having the occupancy prediction service and the historian run on the same physical device, a particular integrations between the two devices that the historian service and the occupancy prediction service run on could be established such that occupancy data of the historian service can be provided from the historian service to the occupancy prediction service.

This portability of services and/or integrations removes dependencies between hardware and software. Allowing services and/or integrations to move from one device to another device can keep services running continuously even if the run on a variety of locations. This decouples software from hardware.

In some embodiments, the building normalization layer 3712 can facilitate auto discovery of devices and/or perform auto configuration. In some embodiments, the building normalization 3726 of the cloud platform 3106 performs the auto discovery. In some embodiments, responsive to detecting a new device connected to the local server 3702, e.g., a new device of the building subsystems 3122, the building normalization can identify points of the new device, e.g., identify measurement points, control points, etc. In some embodiments, the building normalization layer 3712 performs a discovery process where strings, tags, or other metadata is analyzed to identify each point. In some embodiments, a discover process as discussed in U.S. patent application Ser. No. 16/885,959 filed May 28, 5020, U.S. patent application Ser. No. 16/885,968 filed May 28, 5020, U.S. patent application Ser. No. 16/722,439 filed Dec. 20, 2019 (now U.S. Pat. No. 10,831,163), and U.S. patent application Ser. No. 16/663,623 filed Oct. 25, 2019, which are incorporated by reference herein in their entireties.

In some embodiments, the cloud platform 3106 performs a site survey of all devices of a site or multiple sites. For example, the cloud platform 3106 could identify all devices installed in the system 3700. Furthermore, the cloud platform 3106 could perform discovery for any devices that are not recognized. The result of the discovery of a device could be a configuration for the device, for example, indications of points to collect data from and/or send commands to. The cloud platform 3106 can, in some embodiments, distribute a copy of the configuration for the device to all of the instances of the building normalization layer 3712. In some embodiments, the copy of the configuration can be distributed to other buildings different from the building that the device was discovered at. In this regard, responsive to a similar device type being installed somewhere else, e.g., in the same building, in a different building, at a different campus, etc. the instance of the building normalization can select the copy of the device configuration and implement the device configuration for the device.

Similarly, if the instance of the building normalization detects a new device that is not recognized, the building normalization could perform a discovery process for the new device and distribute the configuration for the new device to other instances of the building normalization. In this regard, each building normalization instance can implement learning by discovering new devices and injecting device configurations into a device catalog stored and distributed across each building normalization instance.

In some embodiments, the device catalog can store names of every data point of every device. In some embodiments, the services that operate on the data points can consume the data points based on the indications of the data points in the device catalog. Furthermore, the integrations may collect data from data points and/or send actions to the data points based on the naming of the device catalog. In some embodiments, the various building normalization and synchronize the device catalogs they store. For example, changes to one device catalog can be distributed to other building normalizations. If a point name was changed for a device, this change could be distributed across all building normalizations through the device catalog synchronization such that there are no disruptions to the services that consume the point.

The analytics service 3706 may be a service that generates one or more analytics based on building data received from a building device, e.g., directly from the building device or through a gateway that communicates with the building device, e.g., from the device/gateway 3720. The analytics service 3706 can be configured to generate an analytics data based on the building data such as a carbon emissions metric, an energy consumption metric, a comfort score, a health score, etc. The database service 3708 can operate to store building data, e.g., building data collected from the device/gateway 3720. In some embodiments, the analytics service 3706 may operate against historical data stored in the database service 3708. In some embodiments, the analytics service 3706 may have a requirement that the analytics service 3706 is implemented with access to a database service 3706 that stores historical data. In this regard, the analytics service 3706 can be deployed to, or relocated to a device including an instantiation of the database service 3708. In some embodiments, the database service 3708 could be deployed to the local server 3702 responsive to determining that the analytics service 3706 requires the database service 3708 to run.

The optimization service 3710 can be a service that operates to implement an optimization of one or more variables based on one or more constraints. The optimization service 3710 could, in some embodiments, implement optimization for allocating loads, making control decisions, improving energy usage and/or occupant comfort etc. The optimization performed by the optimization service 3710 could be the optimization described in U.S. patent application Ser. No. 17/542,184 filed Dec. 3, 2021, which is incorporated by reference herein.

The Modbus integration 3714 can be a software component that enables the local server 3702 to collect building data for data points of building devices that operate with a Modbus protocol. Furthermore, the Modbus integration 3714 can enable the local server 3702 to communicate data, e.g., operating parameters, setpoints, load allocations, etc. to the building device. The communicated data may, in some embodiments, be control decisions determined by the optimization service 3710.

Similarly, the BACnet integration 3716 can enable the local server 3702 to communicate with one or more BACnet based devices, e.g., send data to, or receive data from, the BACnet based devices. The endpoint 3718 could be an endpoint for MQTT and/or Sparkplug. In some embodiments, the element 3718 can be a software service including an endpoint and/or a layer for implementing MQTT and/or Sparkplug communication. In the system 3700, the endpoint 3718 can be used for communicating by the local server 3702 with the device/gateway 3720, in some embodiments.

The cloud platform 3106 can include an artificial intelligence (AI) service 3721, an archive service 3722, and/or a dashboard service 3724. The AI service 3721 can run one or more artificial intelligence operations, e.g., inferring information, performing autonomous control of the building, etc. The archive service 3722 may archive building data received from the device/gateway 3720 (e.g., collected point data). The archive service 3722 may, in some embodiments, store control decisions made by another service, e.g., the AI service 3721, the optimization service 3710, etc. The dashboard service 3724 can be configured to provide a user interface to a user with analytic results, e.g., generated by the analytics service 3706, command interfaces, etc. The cloud platform 3106 is further shown to include the building normalization 3726, which may be an instance of the building normalization layer 3712.

The cloud platform 3106 further includes an endpoint 3754 for communicating with the local server 3702 and/or the device/gateway 3720. The cloud platform 3106 may include an integration 3756, e.g., an MQTT integration supporting MQTT based communication with MQTT devices.

The device/gateway 3720 can include a local server connector 3732 and a cloud platform connector 3734. The cloud platform connector 3734 can connect the device/gateway 3720 with the cloud platform 3106. The local server connector 3732 can connect the device/gateway 3720 with the local server 3702. The device/gateway 3720 includes a commanding service 3736 configured to implement commands for devices of the building subsystems 3122 (e.g., the device/gateway 3720 itself or another device connected to the device/gateway 3720). The monitoring service 3738 can be configured to monitor operation of the devices of the building subsystems 3122, the scheduling service 3740 can implement scheduling for a space or asset, the alarm/event service 3742 can generate alarms and/or events when specific rules are tripped based on the device data, the control service 3744 can implement a control algorithm and/or application for the devices of the building subsystems 3122, and/or the activity service 3746 can implement a particular activity for the devices of the building subsystems 3122.

The device/gateway 3720 further includes a building normalization 3748. The building normalization 3748 may be an instance of the building normalization layer 3712, in some embodiments. The device/gateway 3720 may further include integrations 3750-3752. The integration 3750 may be a Modbus integration for communicating with a Modbus device. The integration 3752 may be a BACnet integration for communicating with BACnet devices.

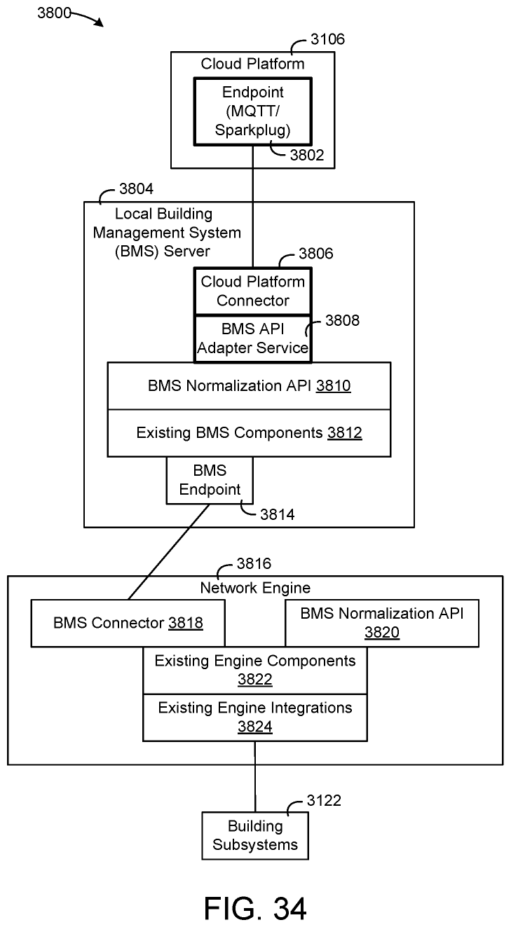

Referring now to FIG. 34, system 3800 including a local building management system (BMS) server 3804 including a cloud platform connector 3806 and a BMS API adapter service 3808 that operate to connect a network engine 3816 with the cloud platform 3106 is shown, according to an exemplary embodiment. The components 3802, 3806, and 3808 may be components of the edge platform 3102, in some embodiments. In some embodiments, the cloud platform connector 3806 is the same as, or similar to, the connector 3504, e.g., includes the connectivity manager 3506, the device manager 3508, and/or the device identity manager 3510.

The local BMS server 3804 may be a server that implements building applications and/or data collection. The building applications can be the various services discussed herein, e.g., the services of the service catalog 3630. In some embodiments, the BMS server 3804 can include data storage for storing historical data. In some embodiments, the local BMS server 3804 can be the local server 3656 and/or the local server 3702. In some embodiments, the local BMS server 3804 can implement user interfaces for viewing on a user device 3176. The local BMS server 3804 includes a BMS normalization API 3810 for allowing external systems to communicate with the local BMS server 3804. Furthermore, the local BMS server 3804 includes BMS components 3812. These components may implement the user interfaces, applications, data storage and/or logging, etc. Furthermore, the local BMS server 3804 includes a BMS endpoint 3814 for communicating with the network engine 3816. The BMS endpoint 3814 may also connect to other devices, for example, via a local or external network. The BMS endpoint 3814 can connect to any type of device capable of communicating with the local BMS server 3804.

The system 3800 includes a network engine 3816. The network engine 3816 can be configured to handle network operations for networks of the building. For example, the engine integrations 3824 of the network engine 3816 can be configured to facilitate communication via BACnet, Modbus, CAN, N2, and/or any other protocol. In some embodiments, the network communication is non-IP based communication. In some embodiments, the network communication is IP based communication, e.g., Internet enabled smart devices, BACnet/IP, etc. In some embodiments, the network engine 3816 can communicate data collected from the building subsystems 3122 and pass the data to the local BMS server 3804.

In some embodiments, the network engine 3816 includes existing engine components 3822. The engine components 3822 can be configured to implement network features for managing the various building networks that the building subsystems 3122 communicate with. The network engine 3816 may further include a BMS normalization API 3820 that implements integration with other external systems. The network engine 3816 further includes a BMS connector 3818 that facilitates a connection between the network engine 3816 and a BMS endpoint 3814. In some embodiments, the BMS connector 3818 collects point data received from the building subsystems 3122 via the engine integrations 3824 and communicates the collected points to the BMS endpoint 3814.

In the system 3800, the local BMS server 3804 can be adapted to facilitate communication between the local BMS server 3804, the network engine 3816, and/or the building subsystems 3122 with the cloud platform 3106. In some embodiments, the adaption can be implemented by deploying an endpoint 3802 to the cloud platform 3106. The endpoint 3802 can be an MQTT and/or Sparkplug endpoint, in some embodiments. Furthermore, a cloud platform connector 3806 could be deployed to the local BMS server 3804. The cloud platform connector 3806 could facilitate communication between the local BMS server 3804 and the cloud platform 3106. Furthermore, a BMS API adapter service 3808 can be deployed to the local BMS server 3804 to implement an integration between the cloud platform connector 3806 and the BMS normalization API 3810. The BMS API adapter service 3808 can form a bridge between the existing BMS components 3812 and the cloud platform connector 3806.

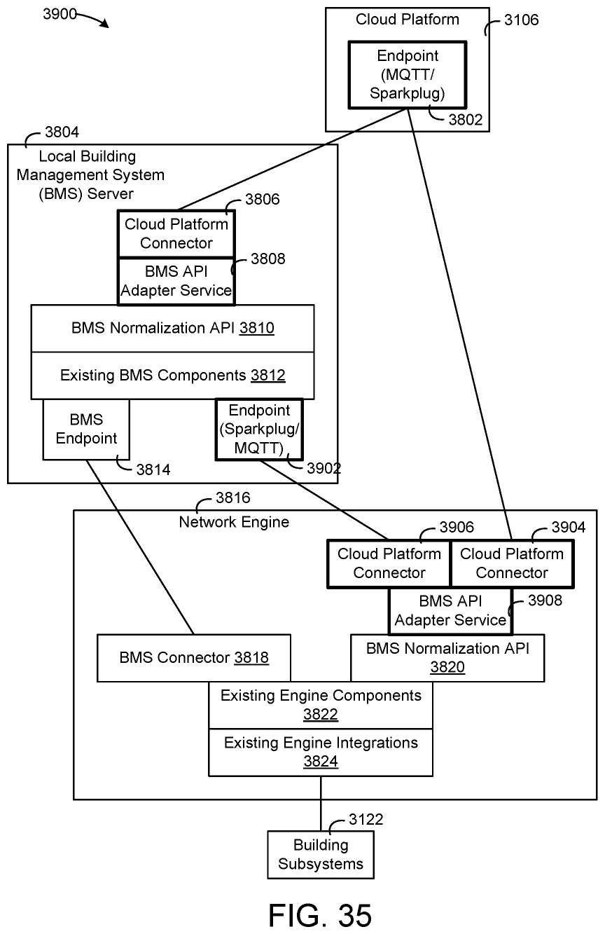

Referring now to FIG. 35, a system 3900 including the local BMS server 3804, the network engine 3816, and the cloud platform 3106 is shown where the network engine 3816 includes connectors and an adapter service that connect the engine with the local BMS server 3804 and the cloud platform 3106, according to an exemplary embodiment. In the system 3900, the network engine 3816 can be adapted to facilitate communication directly between the network engine 3816 and the cloud platform 3106.

In the system 3900, reusable cloud connector components and/or a reusable adapter service are deployed to the network engine 3816 to enable the network engine 3816 to communicate directly with the cloud platform 3106 endpoint 3802. In this regard, components of the edge platform 3102 can be deployed to the network engine 3816 itself allowing for plug and play on the engine such that gateway functions can be run on the network engine 3816 itself.

In the system 3900, a cloud platform connector 3906 and a cloud platform connector 3904 can be deployed to the network engine 3816. The cloud platform connector 3906 and/or the cloud platform connector 3904 can be instances of the cloud platform 3806. Furthermore, an endpoint 3902 can be deployed to the local BMS server 3804. The endpoint 3902 can be a sparkplug and/or MQTT endpoint. The cloud platform connector 3906 can be configured to facilitate communication between the network engine 3816 and the endpoint 3902. In some embodiments, point data can be communicated between the building subsystems 3122 and the endpoint 3902. Furthermore, the cloud platform connector 3904 can configured to facilitate communication between the endpoint 3802 and the network engine 3816, in some embodiments. A BMS API adapter service 3908 can integrate the cloud platform connector 3906 and/or the cloud platform connector 3904 with the BMS normalization API 3820.

Referring now to FIG. 36, a system 4000 including a gateway 4004 including a BMS adapter service application programming interface (API) connecting the network engine 3816 to the cloud platform 3106 is shown, according to an exemplary embodiment. In the system 4000, the gateway 4004 can facilitate communication between the cloud platform 3106 and the network engine 3816, in some embodiments. The gateway 4004 can be a physical computing system and/or device, e.g., one of the gateways 3112-3116. The gateway 4004 can be the instance of the edge platform 3102 described in FIG. 30 and/or FIG. 32A.

In some embodiments, the gateway 4004 can be deployed on a computing node of a building that the gateway software, e.g., the components 4006-1014. In some embodiments, the gateway 4004 can be installed in a building as a new physical device. In some embodiments, gateway devices can be built on computing nodes of a network to communicate with legacy devices, e.g., the network engine 3816 and/or the building subsystems 3122. In some embodiments, the gateway 4004 can be deployed to a computing system to enable the network engine 3816 to communicate with the cloud platform 3106. In some embodiments, the gateway 4004 is a new physical device and/or is a modified existing gateway. In some embodiments, the cloud platform 3106 can identify what physical devices are near and/or are connected to the network engine 3816. The cloud platform 3106 can deploy the gateway 4004 to the identified physical device. Some pieces of the software stack of the gateway may be legacy.

The gateway 4004 can include a cloud platform connector 4006 configured to facilitate communication between the endpoint 3802 of the cloud platform 3106 and/or the gateway 4004. The cloud platform connector 4006 can be an instance of the cloud platform 3806 and/or the connector 3504. The gateway 4004 can further include services 4008. The services 4008 can be the services described with reference to FIGS. 32B and/or 33. The gateway 4004 further includes a building normalization 4010. The building normalization 4010 can be the same as or similar to the building normalizations layers 3712, 3728, and/or 3748 described with reference to FIG. 33. The gateway 4004 further includes a BMS API adapter service 4012 that can be configured to facilitate communication with the BMS normalization API 3820. The BMS API adapter service 4012 can be the same as and/or similar to the BMS API adapter service 3808 and/or the BMS API adapter service 3908. The gateway 4004 may further include integrations endpoint 4014 which may facilitate communication directly with the building subsystems 3122.

In some embodiments, the gateway 4004, via the cloud platform connector 4006 and/or the BMS API adapter service 4012 can facilitate direct communication between the network engine 3816 and the cloud platform 3106. For example, data collected from the building subsystems 3122 can be collected via the engine integrations 3824 and communicated to the gateway 4004 via the BMS normalization API 3820 and the BMS API adapter service 4012. The cloud platform connector 4006 can communicate the collected data points to the endpoint 3802 of the cloud platform 3106. The BMS API adapter service 4012 and the BMS API adapter service 3808 can be common adapters which can make calls and/or responses to the BMS normalization API 3810 and/or the BMS normalization API 3820.

The gateway 4004 can allow for the addition of services (e.g., the services 4008) and/or integrations (e.g., integrations endpoint 4014) to the system 4000 that may not be deployable to the local BMS server 3804 and/or the network engine 3816. In FIG. 35, the network engine 3816 is not adapted but is brought into the ecosystem of the system 4000 through the gateway 4004, in comparison to the deployed connectivity to the local BMS server 3804 in FIG. 33 and the deployed connectivity to the network engine 3816 of FIG. 35.

Referring now to FIG. 37, a system 4100 including a surveillance camera 4106 and a smart thermostat 4108 for a zone 4102 of the building that uses the edge platform 3102 to facilitate event based control is shown, according to an exemplary embodiment. In the system 4100, the surveillance camera 4106 and/or the smart thermostat 4108 can run gateway components of the edge platform 3102. For example, the surveillance camera 4106 and/or the smart thermostat 4108 could include the connector 3504. In some embodiments, the surveillance camera 4106 and/or the smart thermostat 4108 can include an endpoint, e.g., an MQTT endpoint such as the endpoints described in FIGS. 33-36.

In some embodiments, the surveillance camera 4106 and/or the smart thermostat 4108 are themselves gateways. The gateways may be built in a portable language such as RUST and embedded within the surveillance camera 4106 and/or the smart thermostat 4108. In some embodiments, one or both of the surveillance camera 4106 and/or the smart thermostat 4108 can implement a building device broker 4105. In some embodiments, the building device broker 4105 can be implemented on a separate building gateway, e.g., the device/gateway 3720 and/or the gateway 4004.

In some embodiments, the surveillance camera 4106 can perform motion detection, e.g., detect the presence of the user 4104. In some embodiments, responsive to detecting the user 4104, the surveillance camera 4106 can generate an occupancy trigger event. The occupancy trigger event can be published to a topic by the surveillance camera 4106. The building device broker 4105 can, in some embodiments, handle various topics, handle topic subscriptions, topic publishing, etc. In some embodiments, the smart thermostat 4108 may be subscribed to an occupancy topic for the zone 4102 that the surveillance camera 4106 publishes occupancy trigger events to. The smart thermostat 4108 may, in some embodiments, adjust a temperature setpoint responsive to receiving an occupancy trigger event being published to the topic.

In some embodiments, an IoT platform and/or other application is subscribed to the topic that the surveillance camera 4106 subscribes to and commands the smart thermostat 4108 to adjust its temperature setpoint responsive to detecting the occupancy trigger event. In some embodiments the events, topics, publishing, and/or subscriptions are MQTT based messages. In some embodiments, the event communicated by the surveillance camera 4106 is an Open Network Video Interface Forum (ONVIF) event.

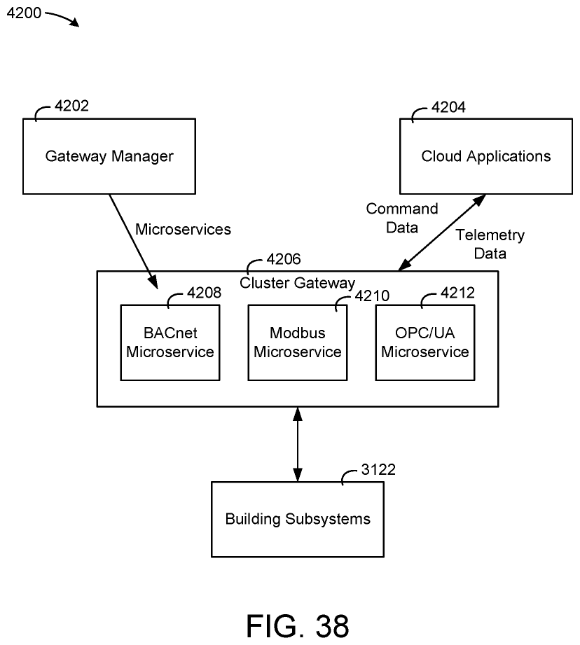

Referring now to FIG. 38, a system 4200 including a cluster based gateway 4206 that runs micro-services for facilitating communication between building subsystems 3122 and cloud applications 4204 is shown, according to an exemplary embodiment. In some embodiments, to collect telemetry data from building subsystems 3122 (e.g., BMS systems, fire systems, security systems, etc.), the system 4200 includes a gateway which collects data from the building subsystems 3122 and communicates the information to the cloud, e.g., to the cloud applications 4204, the cloud platform 3106, etc.

In some embodiments, such a gateway could include a mini personal computer (PC) with various software connectors that connect the gateway to the building subsystems 3122, e.g., a BACnet connector, an OPC/UA connector, a Modbus connector, a Transmission Control Protocol and Internet Protocol TCP/IP connector, and/or various other protocols. In some embodiments, the mini PC runs an operating system that hosts various micro-services for the communication.

In some embodiments, hosting a mini PC in a building has issues. For example, the operating system on the mini PC may need to be updated for security patches and/or operating system updates. This might result in impacting the micro-services which the mini PC runs. Micro-services may stop, may be deleted, and/or may have to updated to manage the changes in operating system. Furthermore, the mini PC may need to be managed by a local building information technologies (IT) team. The mini PC may be impacted by the building network and/or IT policies on the network. The mini PC may need to be commissioned by a technician visit to a local site. Similarly, a site visit by the technician may be required for trouble shooting any time that the mini PC encounters issues. For an increase in demand for the services of the mini PC, a technician may need to visit the site to make physical and/or software updates to the mini PC, which may incur additional cost for field testing and/or certifying new hardware and/or software.

To solve one or more of these issues, the system 4200 could include a cluster gateway 4206. The cluster gateway 4206 cold be a cluster including one or more micro-services in containers. For example, the cluster gateway 4206 could be a Kubernetes cluster with Docker instances of micro-services. For example, the cluster gateway 4206 could run a BACnet micro-serve 4208, a Modbus micro-service 4210, and/or an OPC/U micro-service 4212. The cluster gateway 4206 can replace the mini PC with a more generic hardware device with the capability to host one or more different and/or changing containers.

In some embodiments, software updates to the cluster gateway 4206 can be managed centrally by a gateway manager 4202. The gateway manager 4202 could push new micro-services, e.g., a BACnet micro-service, a Modbus micro-service 4210, and/or a OPC/UA micro-service to the cluster gateway 4206. In this manner, software upgrades are not dependent on an IT infrastructure at a building. A building owner may manage the underlying hardware that the cluster gateway 4206 runs on while the cluster gateway 4206 may be managed by a separate development entity. In some embodiments, commissioning for the cluster gateway 4206 is managed remotely. Furthermore, the workload for the cluster gateway 4206 can be managed, in some embodiments. In some embodiments, the cluster gateway 4206 runs independent of the hardware on which it is hosted, and thus any underlying hardware upgrades do not require testing for software tools and/or software stack of the cluster gateway 4206.

The gateway manager 4202 can be configured to install and/or upgrade the cluster gateway 4206. The gateway manager 4202 can make upgrades to the micro-services that the cluster gateway 4206 runs and/or make upgrades to the operating environment of the cluster gateway 4206. In some embodiments, upgrades, security patches, new software, etc. can be pushed by the gateway manager 4202 to the cluster gateway 4206 in an automated manner. In some embodiments, errors and/or issues of the cluster gateway 4206 can be managed remotely and users can receive notifications regarding the errors and/or issues. In some embodiments, commissioning for the cluster gateway 4206 can be automated and the cluster gateway 4206 can be set up to run on a variety of different hardware environments.

In some embodiments, the cluster gateway 4206 can provide telemetry data of the building subsystems 3122 to the cloud applications 4204. Furthermore, the cloud applications 4204 can provide command and control data to the cluster gateway 4206 for controlling the building subsystems 3122. In some embodiments, command and/or control operations can be handled by the cluster gateway 4206. This may provide the ability to manage the demand and/or bandwidth requirements of the site by commanding the various containers including the micro-services on the cluster gateway 4206. This may allow for the management of upgrades and/or testing. Furthermore, this may allow for the replication of development, testing, and/or production environments. The cloud applications 4204 could be energy management applications, optimization applications, etc. In some embodiments, the cloud applications 4204 are the applications 3110. In some embodiments, the cloud applications 4204 are the cloud platform 3106.

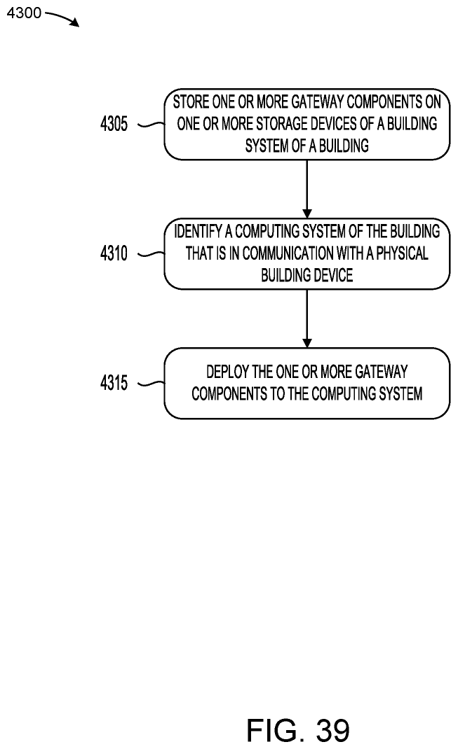

Referring to FIG. 39, illustrated is a flow diagram of an example method 4300 for deploying gateway components on one or more computing systems of a building, according to an exemplary embodiment. In various embodiments, the local server 3702 performs the method 4300. However, it should be understood that any computing system described herein may perform any or all of the operations described in connection with the method 4300. For example, in some embodiments, the cloud platform 3106 performs method 4300. In yet other embodiments, the local server 3702 may perform the method 4300. For example, the cloud platform 3106 may perform method 4300 to deploy gateway components on one or more computing devices (e.g., the local server 3702, the device/gateway 3720, the local BMS server 3804, the network engine 3816, the gateway 4004, the gateway manager 4202, the cluster gateway 4206, any other computing systems or devices described herein, etc.) in a building, which may collect, store, process, or otherwise access data samples received via one or more physical building devices. The data samples may be sensor data, operational data, configuration data, or any other data described herein. The computing system performing the operations of the method 4300 is referred to herein as the “building system.”

At step 4305, the building system can store one or more gateway components on one or more storage devices of the building system. The building system may be located within, or located remote from, the building to which the building system corresponds. The gateway components stored on the storage devices of the building system can facilitate communication with a cloud platform (e.g., the cloud platform 3106) and facilitate communication with a physical building device (e.g., the device/gateway 3720, the building subsystems 3122, etc.). The gateway components can be, for example, any of the, connectors, building normalization layers, services, or integrations described herein, including but certainly not limited to the connector 3704, services 3706-3710, a building normalization layer 3712, and integrations 3714-3718, among other components, software, integrations, configuration settings, or any other software-related data described in connection with FIGS. 27-38.

At step 4310, the building system can identify a computing system of the building that is in communication with the physical building device, the physical building device storing one or more data samples. Identifying the computing system can include accessing a database or lookup table of computing systems or devices that are present within or otherwise associated with managing one or more aspects of the building. In some implementations, the building system can query a network of the building to which the building system is communicatively coupled, to identify one or more other computing systems on the network. The computing systems may be associated with respective identifiers, and may communicate with the building system via the network or another suitable communications interface, connector, or integration, as described herein. The computing system may be in communication with one or more physical building devices, as described herein. In some implementations, the building system can identify each of the computing systems of the building that are in communication with at least one physical building device.

At step 4315, the building system can deploy the one or more gateway components to the identified computing system responsive to identifying that the computing system is in communication with the physical building device(s). For example, the building system can utilize one or more communication channels, which may be established via a network of the building, to transmit the gateway components to each of the identified computing systems of the building. Deploying the one or more gateway components can include installing or otherwise configuring the gateway components to execute at the one or more identified computing systems. Generally, the gateway components can be executed to perform any of the operations described herein. Deploying the gateway components can include forming storing computer-executable instructions corresponding to the gateway components at the identified computing systems. In some implementations, the particular gateway components deployed at an identified computing system can be selected based on the type of the physical building device to which the identified computing system is connected. Likewise, in some embodiments, the particular gateway components deployed at an identified computing system can be selected to correspond to an operation, type, or processing capability of the identified computing system, among other factors as described herein. Deploying the gateway components may include storing the gateway components in one or more predetermined memory regions at the computing system (e.g., in a particular directory, executable memory region, etc.), and may include installing, configuring, or otherwise applying one or more configuration settings for the gateway components or for the operation of the computing system.

As described herein, the one or more gateway components can include any type of software component, hardware configuration settings, or combinations thereof. The gateway components may include processor-executable instructions, which can be executed by the computing system to which the gateway component(s) are deployed. The one or more gateway components can cause the computing system to communicate with the physical building device to receive the one or more data samples (e.g., via one or more networks or communication interfaces). Additionally, the one or more gateway components cause the computing system to communicate the one or more data samples to the cloud platform. For example, the gateway components can include one or more adapters or communication software APIs that facilitate communication between computing devices within, and external to, the building. The gateway components may include adapters that cause the computing system to communicate with one or more network engines. The gateway components can include instructions that, when executed by the computing system, cause the computing system to detect a new physical building device connected to the computing system (e.g., by searching through different connected devices by device identifier, etc.), and then search a device library for a configuration of the new physical building device. Using the configuration for the new physical device, the gateway components can cause the computing system to implement the configuration to facilitate communication with the new physical building device. The gateway components can also perform a discovery process to discover the configuration for the new physical building device and store the configuration in the device library, for example, if the device library did not include the configuration. The device library can be stored at the cloud platform or on the one or more gateway components themselves. In some implementations, the device library is distributed across one or more instances of the one or more gateway components in a plurality of different buildings, and may be retrieved, for example, by accessing one or more networks to communicate with the multiple instances of gateway components to retrieve portions of, or all of, the device library. The gateway components can receive one or more values for control points of the physical building device, for example, from the building system, from the cloud platform, or from another system or device described herein, and communicate the one or more values to the control points of the physical building device via the one or more gateway components.

The one or more gateway components can include a building service that causes the computing system to generate data based on the one or more data samples, which may be analytics data or any other type of data described herein that may be based on or associated with the data samples. When deploying the gateway components, the building system can identify one or more requirements for the building service, or any other of the gateway components. The requirements may include required processing resources, storage resources, data availability, or a presence of another building service executing at the computing system. The building system can query the computing system to determine the current operating characteristics (e.g., processing resources, storage resources, data availability, or a presence of another building service executing at the computing system, etc.), to determine that the computing system meets the one or more requirements for the gateway component(s). If the computing system meets the requirements, the building system can deploy the corresponding gateway components to the computing system. If the requirements are not met, the building system may deploy the gateway components to another computing system. The building system can periodically query, or otherwise receive messages from, the computing system that indicate the current operating characteristics of the computing system. In doing so, the building system can identify whether the requirements for the building service (or other gateway components) are no longer met by the computing system. If the requirements are no longer met, the building system can move (e.g., terminate execution of the gateway components or remove the gateway components from the computing system, and re-deploy the gateway components) the gateway components (e.g., the building service) from the computing system to a different computing system that meets the one or more requirements of the building service or gateway component(s).

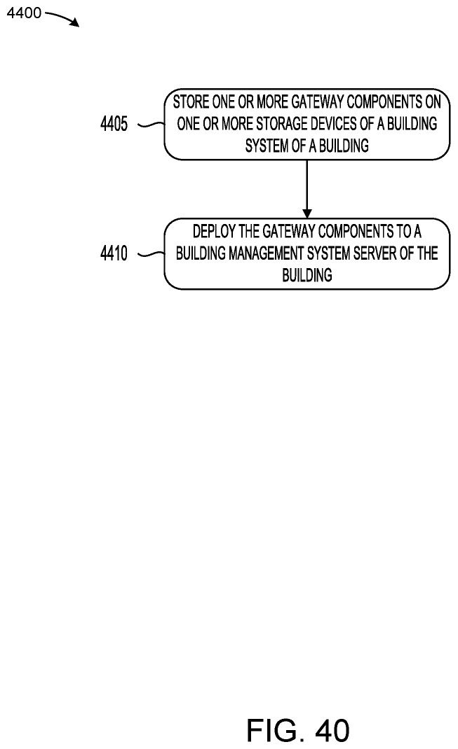

Referring to FIG. 40 is a flow diagram of an example method 4400 for deploying gateway components on a local BMS server, according to an exemplary embodiment. In various embodiments, the local server 3702 performs the method 4400. However, it should be understood that any computing system described herein may perform any or all of the operations described in connection with the method 4400. For example, in some embodiments, the cloud platform 3106 performs method 4400. In yet other embodiments, the local server 3702 may perform the method 4400. For example, the cloud platform 3106 may perform method 4400 to deploy gateway components on one or more computing devices (e.g., the local server 3702, the device/gateway 3720, the local BMS server 3804, the network engine 3816, the gateway 4004, the gateway manager 4202, the cluster gateway 4206, any other computing systems or devices described herein, etc.) in a building, which may collect, store, process, or otherwise access data samples received via one or more physical building devices. The data samples may be sensor data, operational data, configuration data, or any other data described herein. The computing system performing the operations of the method 4400 is referred to herein as the “building system.”

At step 4405, the building system can store one or more gateway components on one or more storage devices of the building system. The building system may be located within, or located remote from, the building to which the building system corresponds. The gateway components stored on the storage devices of the building system can facilitate communication with a cloud platform (e.g., the cloud platform 3106) and facilitate communication with a physical building device (e.g., the device/gateway 3720, the building subsystems 3122, etc.). The gateway components can be, for example, any of the, connectors, building normalization layers, services, or integrations described herein, including but certainly not limited to the connector 3704, services 3706-710, a building normalization layer 3712, and integrations 3714-718, among other components, software, integrations, configuration settings, or any other software-related data described in connection with FIGS. 37-38.

At step 4410, the building system can deploy the one or more gateway components to a BMS server, which may be in communication with one or more building devices via one or more network engines, as shown in FIG. 34. The BMS server can execute one or more BMS applications on the data samples received (e.g., via one or more networks or communication interfaces) from the physical building devices. To deploy the gateway components, the building system can utilize one or more communication channels, which may be established via a network of the building, to transmit the gateway components to the BMS server of the building. Deploying the one or more gateway components can include installing or otherwise configuring the gateway components to execute at the BMS server. Generally, the gateway components can be executed to perform any of the operations described herein. Deploying the gateway components can include forming storing computer-executable instructions corresponding to the gateway components at the BMS server. In some implementations, the particular gateway components deployed at the BMS server can be selected based on the type of the physical building device(s) to which the BMS server is connected (e.g., via the network engine, etc.), or to other types of computing systems with which the BMS server is in communication. Likewise, in some embodiments, the particular gateway components deployed at the BMS server can be selected to correspond to an operation, type, or processing capability of the BMS server, among other factors as described herein. Deploying the gateway components may include storing the gateway components in one or more predetermined memory regions at the BMS server (e.g., in a particular directory, executable memory region, etc.), and may include installing, configuring, or otherwise applying one or more configuration settings for the gateway components or for the operation of the BMS server.

As described herein, the one or more gateway components can include any type of software component, hardware configuration settings, or combinations thereof. The gateway components may include processor-executable instructions, which can be executed by the BMS server to which the gateway component(s) are deployed. The one or more gateway components can cause the BMS server to communicate with the physical building device to receive the one or more data samples (e.g., via one or more networks or communication interfaces). Additionally, the one or more gateway components cause the BMS server to communicate the one or more data samples to the cloud platform. For example, the gateway components can include one or more adapters or communication software APIs that facilitate communication between computing devices within, and external to, the building. The gateway components may include adapters that cause the BMS server to communicate with one or more network engines. The gateway components can include instructions that, when executed by the BMS server, cause the BMS server to detect a new physical building device connected to the BMS server (e.g., by searching through different connected devices by device identifier, etc.), and then search a device library for a configuration of the new physical building device. Using the configuration for the new physical device, the gateway components can cause the BMS server to implement the configuration to facilitate communication with the new physical building device. The gateway components can also perform a discovery process to discover the configuration for the new physical building device and store the configuration in the device library, for example, if the device library did not include the configuration. The device library can be stored at the cloud platform or on the one or more gateway components themselves. In some implementations, the device library is distributed across one or more instances of the one or more gateway components in a plurality of different buildings, and may be retrieved, for example, by accessing one or more networks to communicate with the multiple instances of gateway components to retrieve portions of, or all of, the device library. The gateway components can receive one or more values for control points of the physical building device, for example, from the building system, from the cloud platform, or from another system or device described herein, and communicate the one or more values to the control points of the physical building device via the one or more gateway components.

The one or more gateway components can include a building service that causes the BMS server to generate data based on the one or more data samples, which may be analytics data or any other type of data described herein that may be based on or associated with the data samples. When deploying the gateway components, the building system can identify one or more requirements for the building service, or any other of the gateway components. The requirements may include required processing resources, storage resources, data availability, or a presence of another building service executing at the BMS server. The building system can query the BMS server to determine the current operating characteristics (e.g., processing resources, storage resources, data availability, or a presence of another building service executing at the BMS server, etc.), to determine that the BMS server meets the one or more requirements for the gateway component(s). If the BMS server meets the requirements, the building system can deploy the corresponding gateway components to the BMS server. If the requirements are not met, the building system may deploy the gateway components to another BMS server. The building system can periodically query, or otherwise receive messages from, the BMS server that indicate the current operating characteristics of the BMS server. In doing so, the building system can identify whether the requirements for the building service (or other gateway components) are no longer met by the BMS server. If the requirements are no longer met, the building system can move (e.g., terminate execution of the gateway components or remove the gateway components from the BMS server, and re-deploy the gateway components) the gateway components (e.g., the building service) from the BMS server to a different computing system that meets the one or more requirements of the building service or gateway component(s). In some implementations, the building system can identify communication protocols corresponding to the physical building devices associated with the BMS server, and deploy one or more integration components (e.g., associated with the physical building devices) to the BMS server to communicate with the one or more physical building devices via the one or more communication protocols. The integration components can be part of the one or more gateway components.

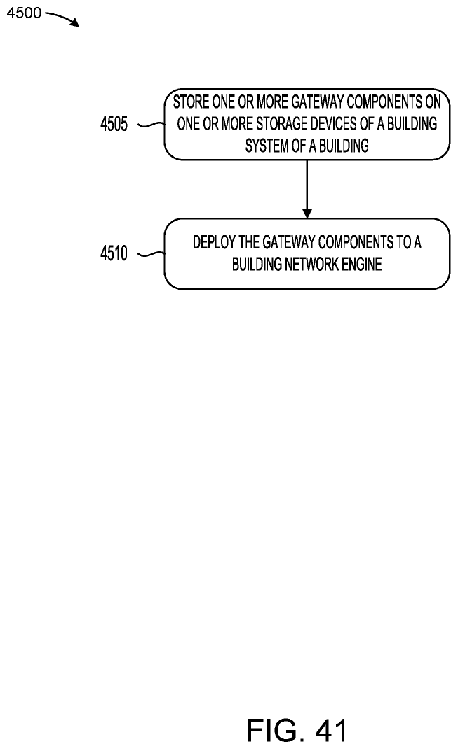

Referring to FIG. 41 is a flow diagram of an example method 4500 for deploying gateway components on a network engine, according to an exemplary embodiment. In various embodiments, the local server 3702 performs the method 4500. However, it should be understood that any computing system described herein may perform any or all of the operations described in connection with the method 4500. For example, in some embodiments, the cloud platform 3106 performs method 4500. In yet other embodiments, the local server 3702 may perform the method 4500. For example, the cloud platform 3106 may perform method 4500 to deploy gateway components on one or more computing devices (e.g., the local server 3702, the device/gateway 3720, the local BMS server 3804, the network engine 3816, the gateway 4004, the gateway manager 4202, the cluster gateway 4206, any other computing systems or devices described herein, etc.) in a building, which may collect, store, process, or otherwise access data samples received via one or more physical building devices. The data samples may be sensor data, operational data, configuration data, or any other data described herein. The computing system performing the operations of the method 4500 is referred to herein as the “building system.”

At step 4505, the building system can store one or more gateway components on one or more storage devices of the building system. The building system may be located within, or located remote from, the building to which the building system corresponds. The gateway components stored on the storage devices of the building system can facilitate communication with a cloud platform (e.g., the cloud platform 3106) and facilitate communication with a physical building device (e.g., the device/gateway 3720, the building subsystems 3122, etc.). The gateway components can be, for example, any of the, connectors, building normalization layers, services, or integrations described herein, including but certainly not limited to the connector 3704, services 3706-710, a building normalization layer 3712, and integrations 3714-718, among other components, software, integrations, configuration settings, or any other software-related data described in connection with FIGS. 37-38.

At step 4510, the building system can deploy the one or more gateway components to a network engine, which may implement one or more local communications networks for one or more building devices of the building and receive one or more data samples from the one or more building devices, as described herein. To deploy the gateway components, the building system can utilize one or more communication channels, which may be established via a network of the building, to transmit the gateway components to the Network engine of the building. Deploying the one or more gateway components can include installing or otherwise configuring the gateway components to execute at the network engine. Generally, the gateway components can be executed to perform any of the operations described herein. Deploying the gateway components can include forming storing computer-executable instructions corresponding to the gateway components at the network engine. In some implementations, the particular gateway components deployed at the network engine can be selected based on the type of the physical building device(s) to which the network engine is connected (e.g., via one or more networks implemented by the network engine, etc.), or to other types of computing systems with which the network engine is in communication. Likewise, in some embodiments, the particular gateway components deployed at the network engine can be selected to correspond to an operation, type, or processing capability of the network engine, among other factors as described herein. Deploying the gateway components may include storing the gateway components in one or more predetermined memory regions at the network engine (e.g., in a particular directory, executable memory region, etc.), and may include installing, configuring, or otherwise applying one or more configuration settings for the gateway components or for the operation of the network engine.

As described herein, the one or more gateway components can include any type of software component, hardware configuration settings, or combinations thereof. The gateway components may include processor-executable instructions, which can be executed by the network engine to which the gateway component(s) are deployed. The one or more gateway components can cause the network engine to communicate with the physical building device to receive the one or more data samples (e.g., via one or more networks or communication interfaces). Additionally, the one or more gateway components cause the network engine to communicate the one or more data samples to the cloud platform. For example, the gateway components can include one or more adapters or communication software APIs that facilitate communication between computing devices within, and external to, the building. The gateway components may include adapters that cause the network engine to communicate with one or more other computing systems (e.g., a BMS server, other building subsystems, etc.). The gateway components can include instructions that, when executed by the network engine, cause the network engine to detect a new physical building device connected to the network engine (e.g., by searching through different connected devices by device identifier, etc.), and then search a device library for a configuration of the new physical building device. Using the configuration for the new physical device, the gateway components can cause the network engine to implement the configuration to facilitate communication with the new physical building device. The gateway components can also perform a discovery process to discover the configuration for the new physical building device and store the configuration in the device library, for example, if the device library did not include the configuration. The device library can be stored at the cloud platform or on the one or more gateway components themselves. In some implementations, the device library is distributed across one or more instances of the one or more gateway components in a plurality of different buildings, and may be retrieved, for example, by accessing one or more networks to communicate with the multiple instances of gateway components to retrieve portions of, or all of, the device library. The gateway components can receive one or more values for control points of the physical building device, for example, from the building system, from the cloud platform, or from another system or device described herein, and communicate the one or more values to the control points of the physical building device via the one or more gateway components.

The one or more gateway components can include a building service that causes the network engine to generate data based on the one or more data samples, which may be analytics data or any other type of data described herein that may be based on or associated with the data samples. When deploying the gateway components, the building system can identify one or more requirements for the building service, or any other of the gateway components. The requirements may include required processing resources, storage resources, data availability, or a presence of another building service executing at the network engine. The building system can query the network engine to determine the current operating characteristics (e.g., processing resources, storage resources, data availability, or a presence of another building service executing at the network engine, etc.), to determine that the network engine meets the one or more requirements for the gateway component(s). If the network engine meets the requirements, the building system can deploy the corresponding gateway components to the network engine. If the requirements are not met, the building system may deploy the gateway components to another network engine. The building system can periodically query, or otherwise receive messages from, the network engine that indicate the current operating characteristics of the network engine. In doing so, the building system can identify whether the requirements for the building service (or other gateway components) are no longer met by the network engine. If the requirements are no longer met, the building system can move (e.g., terminate execution of the gateway components or remove the gateway components from the network engine, and re-deploy the gateway components) the gateway components (e.g., the building service) from the network engine to a different computing system that meets the one or more requirements of the building service or gateway component(s). In some implementations, the building system can identify communication protocols corresponding to the physical building devices associated with the network engine, and deploy one or more integration components (e.g., associated with the physical building devices) to the network engine to communicate with the one or more physical building devices via the one or more communication protocols. The integration components can be part of the one or more gateway components.

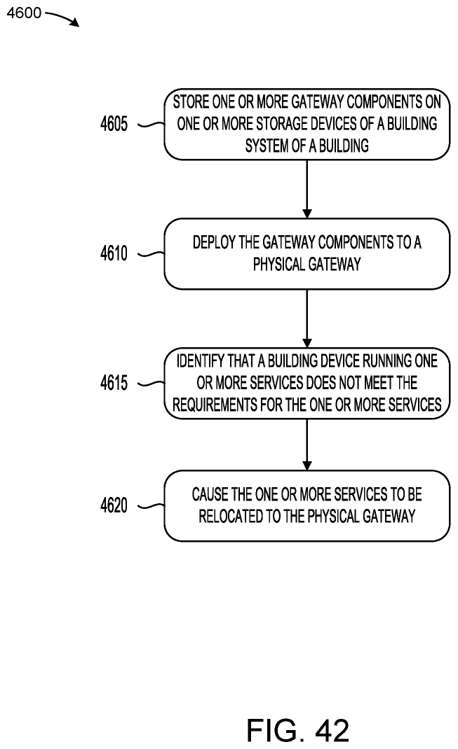

Referring to FIG. 42 is a flow diagram of an example method 4600 for deploying gateway components on a dedicated gateway, according to an exemplary embodiment. In various embodiments, the local server 3702 performs the method 4600. However, it should be understood that any computing system described herein may perform any or all of the operations described in connection with the method 4600. For example, in some embodiments, the cloud platform 3106 performs method 4600. In yet other embodiments, the local server 3702 may perform the method 4600. For example, the cloud platform 3106 may perform method 4600 to deploy gateway components on one or more computing devices (e.g., the local server 3702, the device/gateway 3720, the local BMS server 3804, the network engine 3816, the gateway 4004, the gateway manager 4202, the cluster gateway 4206, any other computing systems or devices described herein, etc.) in a building, which may collect, store, process, or otherwise access data samples received via one or more physical building devices. The data samples may be sensor data, operational data, configuration data, or any other data described herein. The computing system performing the operations of the method 4600 is referred to herein as the “building system.”

At step 4605, the building system can store one or more gateway components on one or more storage devices of the building system. The building system may be located within, or located remote from, the building to which the building system corresponds. The gateway components stored on the storage devices of the building system can facilitate communication with a cloud platform (e.g., the cloud platform 3106) and facilitate communication with a physical building device (e.g., the device/gateway 3720, the building subsystems 3122, etc.). The gateway components can be, for example, any of the, connectors, building normalization layers, services, or integrations described herein, including but certainly not limited to the connector 3704, services 3706-710, a building normalization layer 3712, and integrations 3714-718, among other components, software, integrations, configuration settings, or any other software-related data described in connection with FIGS. 37-38.

At step 4610, the building system can deploy the one or more gateway components to a physical gateway, which may communicate and receive data samples from one or more physical building devices of the building, and provide the data samples to the cloud platform. To deploy the gateway components, the building system can utilize one or more communication channels, which may be established via a network of the building, to transmit the gateway components to the physical gateway of the building. Deploying the one or more gateway components can include installing or otherwise configuring the gateway components to execute at the physical gateway. Generally, the gateway components can be executed to perform any of the operations described herein. Deploying the gateway components can include forming storing computer-executable instructions corresponding to the gateway components at the physical gateway. In some implementations, the particular gateway components deployed at the physical gateway can be selected based on the type of the physical building device(s) to which the physical gateway is connected, or to other types of computing systems with which the physical gateway is in communication. Likewise, in some embodiments, the particular gateway components deployed at the physical gateway can be selected to correspond to an operation, type, or processing capability of the physical gateway, among other factors as described herein. Deploying the gateway components may include storing the gateway components in one or more predetermined memory regions at the physical gateway (e.g., in a particular directory, executable memory region, etc.), and may include installing, configuring, or otherwise applying one or more configuration settings for the gateway components or for the operation of the physical gateway.

As described herein, the one or more gateway components can include any type of software component, hardware configuration settings, or combinations thereof. The gateway components may include processor-executable instructions, which can be executed by the physical gateway to which the gateway component(s) are deployed. The one or more gateway components can cause the physical gateway to communicate with the physical building device to receive the one or more data samples (e.g., via one or more networks or communication interfaces). Additionally, the one or more gateway components cause the physical gateway to communicate the one or more data samples to the cloud platform. For example, the gateway components can include one or more adapters or communication software APIs that facilitate communication between computing devices within, and external to, the building. The gateway components may include adapters that cause the physical gateway to communicate with one or more other computing systems (e.g., a BMS server, other building subsystems, etc.). The gateway components can include instructions that, when executed by the physical gateway, cause the physical gateway to detect a new physical building device connected to the physical gateway (e.g., by searching through different connected devices by device identifier, etc.), and then search a device library for a configuration of the new physical building device. Using the configuration for the new physical device, the gateway components can cause the physical gateway to implement the configuration to facilitate communication with the new physical building device. The gateway components can also perform a discovery process to discover the configuration for the new physical building device and store the configuration in the device library, for example, if the device library did not include the configuration. The device library can be stored at the cloud platform or on the one or more gateway components themselves. In some implementations, the device library is distributed across one or more instances of the one or more gateway components in a plurality of different buildings, and may be retrieved, for example, by accessing one or more networks to communicate with the multiple instances of gateway components to retrieve portions of, or all of, the device library. The gateway components can receive one or more values for control points of the physical building device, for example, from the building system, from the cloud platform, or from another system or device described herein, and communicate the one or more values to the control points of the physical building device via the one or more gateway components.

At step 4615, the building system can identify a building device (e.g., via the gateway on which the gateway components are deployed) that is executing one or more building services that does not meet the requirements for executing the one or more building services. The buildings services, for example, may cause the building device to generate data based on the one or more data samples, which may be analytics data or any other type of data described herein that may be based on or associated with the data samples. The requirements may include required processing resources, storage resources, data availability, or a presence of another building service executing at the building device. The building system can query the building device to determine the current operating characteristics (e.g., processing resources, storage resources, data availability, or a presence of another building service executing at the building device, etc.), to determine that the building device meets the one or more requirements for the building service(s). If the requirements are not met, the building system can perform step 4620. The building system may periodically query the building device to determine whether the building device meets the requirements for the building services.

At step 4620, the building system can cause (e.g., by transmitting computer-executable instructions to the building device and the gateway) the building services to be relocated to the gateway on which the gateway component(s) are deployed. To do so, the building system can move the building services from the building device to the gateway on which the gateway component(s) are deployed, for example, by terminating execution of the building services or removing the building services from the building device, and then re-deploying or copying the building services, including any application state information or configuration information, to the gateway.

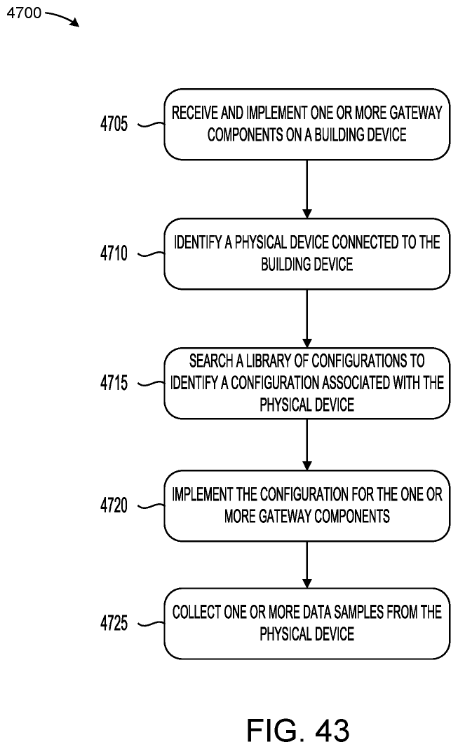

Referring to FIG. 43 is a flow diagram of an example method 4700 for implementing gateway components on a building device, according to an exemplary embodiment. In various embodiments, the device/gateway 3720 performs the method 4700. However, it should be understood that any computing system on which gateway components are deployed, as described herein, may perform any or all of the operations described in connection with the method 4700. For example, in some embodiments, the BMS server 3804, the network engine 3816, the gateway 4004, the building broker device 3105, the gateway manager 4202, or the cluster gateway 4206 performs method 3700. In yet other embodiments, the local server 3702 may perform the method 3700. The computing system performing the operations of the method 4700 is referred to herein as the “building device.”

At step 4705, the building device can receive one or more gateway components and implement the one or more gateway components on the building device. The one or more gateway components can facilitate communication between a cloud platform and the building device. The gateway components can be, for example, any of the, connectors, building normalization layers, services, or integrations described herein, including but certainly not limited to the connector 3704, services 3706-710, a building normalization layer 3712, and integrations 3714-718, among other components, software, integrations, configuration settings, or any other software-related data described in connection with FIGS. 37-38. The building device can receive the gateway components from any type of computing device described herein that can deploy the gateway components to the building device, including the cloud platform 3106, the BMS server 3804, or the network engine 3816, among others.

At step 4710, the building device can identify a physical device connected to the building device based on the one or more gateway components. For example, the gateway components can include instructions that, when executed by the physical gateway, cause the physical gateway to detect a physical device connected to the physical gateway (e.g., by searching through different connected devices by device identifier, etc.). then The gateway components can receive one or more values for control points of the physical device, for example, from the building system, from the cloud platform, or from another system or device described herein, and communicate the one or more values to the control points of the physical device via the one or more gateway components.

At step 4715, the building device can search a library of configurations for a plurality of different physical devices with the identity of the physical device to identify a configuration for collecting data samples from the physical device connected to the building device and retrieve the configuration. Search a device library for a configuration of the physical device. The gateway components can also perform a discovery process to discover the configuration for the physical device and store the configuration in the device library, for example, if the device library did not include the configuration. The device library can be stored at the cloud platform or on the one or more gateway components themselves. In some implementations, the device library is distributed across one or more instances of the one or more gateway components in a plurality of different buildings, and may be retrieved, for example, by accessing one or more networks to communicate with the multiple instances of gateway components to retrieve portions of, or all of, the device library.

At step 4720, the building device can implement the configuration for the one or more gateway components. Using the configuration for the physical device, the gateway components can cause the physical gateway to implement the configuration to facilitate communication with the physical device. The configuration may include configuration for communication hardware (e.g., wireless or wired communications interfaces, etc.) that configure the communication hardware to communicate with the physical device. The configuration can specify a communication protocol that can be used to communicate with the physical device, and may include computer-executable instructions that, when executed, cause the building device to execute an API that carries out the communication protocol to communicate with the physical device.

At step 4725, the building device can collect one or more data samples from the physical device based on the one or more gateway components and the configuration. For example, the gateway components or the configuration can include an API, or other computer-executable instructions, that the building device can utilize to communicate with and retrieve one or more data samples from the physical device. The data samples can be, for example, sensor data, operational data, configuration data, or any other data described herein. Additionally, the building device can utilize one or more of the gateway components to communicate the data samples to another computing system, such as the cloud platform, a BMS server, a network engine, or a physical gateway, among others.

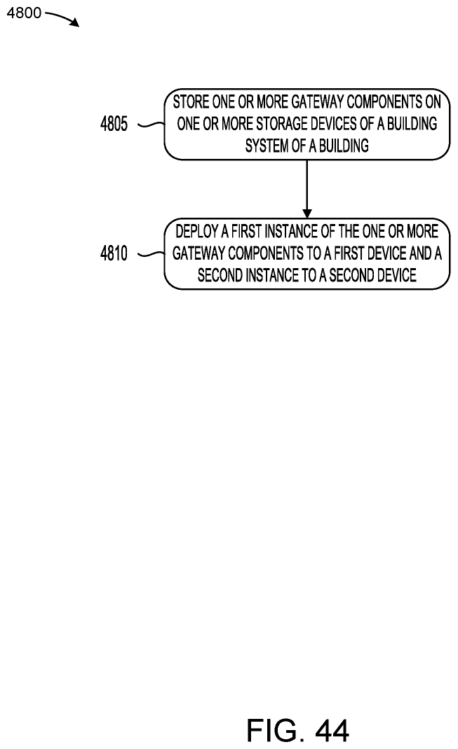

Referring to FIG. 44 is a flow diagram of an example method 4800 for deploying gateway components to perform a building control algorithm, according to an exemplary embodiment. In various embodiments, the local server 3702 performs the method 4800. However, it should be understood that any computing system described herein may perform any or all of the operations described in connection with the method 4800. For example, in some embodiments, the cloud platform 3106 performs method 4800. In yet other embodiments, the local server 3702 may perform the method 4800. For example, the cloud platform 3106 may perform method 4800 to deploy gateway components on one or more computing devices (e.g., the local server 3702, the device/gateway 3720, the local BMS server 3804, the network engine 3816, the gateway 4004, the gateway manager 4202, the cluster gateway 4206, any other computing systems or devices described herein, etc.) in a building, which may collect, store, process, or otherwise access data samples received via one or more physical building devices. The data samples may be sensor data, operational data, configuration data, or any other data described herein. The computing system performing the operations of the method 4800 is referred to herein as the “building system.”

At step 4805, the building system can store one or more gateway components on one or more storage devices of the building system. The building system may be located within, or located remote from, the building to which the building system corresponds. The gateway components stored on the storage devices of the building system can facilitate communication with a cloud platform (e.g., the cloud platform 3106) and facilitate communication with a physical building device (e.g., the device/gateway 3720, the building subsystems 3122, etc.). The gateway components can be, for example, any of the, connectors, building normalization layers, services, or integrations described herein, including but certainly not limited to the connector 3704, services 3706-710, a building normalization layer 3712, and integrations 3714-718, among other components, software, integrations, configuration settings, or any other software-related data described in connection with FIGS. 37-38.

At step 4810, the building system can a first instance of the one or more gateway components to a first edge device and a second instance of the one or more gateway components to a second edge device. The first edge device can measure a first condition of the building and the second edge device can control the first condition or a second condition of the building. The first edge device (e.g., a building device) can be a surveillance camera, and the first condition can be a presence of a person in the building (e.g., within the field of view of the surveillance camera). The second edge device can be a smart thermostat, and the second condition can be a temperature setting of the building. However, it should be understood that the first edge device and the second edge device can be any type of building device capable of capturing data relating to the building or controlling one or more functions, conditions, or other controllable characteristics of the building. To deploy the gateway components, the building system can utilize one or more communication channels, which may be established via a network of the building, to transmit the gateway components to the first edge device and the second edge device of the building.

Deploying the one or more gateway components can include installing or otherwise configuring the gateway components to execute at the first edge device and the second edge device. Generally, the gateway components can be executed to perform any of the operations described herein. Deploying the gateway components can include forming storing computer-executable instructions corresponding to the gateway components at the first edge device and the second edge device. In some implementations, the particular gateway components deployed at the first edge device and the second edge device can be selected based on the operations, functionality, type, or processing capabilities of the first edge device and the second edge device, among other factors as described herein. Deploying the gateway components may include storing the gateway components in one or more predetermined memory regions at the first edge device and the second edge device (e.g., in a particular directory, executable memory region, etc.), and may include installing, configuring, or otherwise applying one or more configuration settings for the gateway components or for the operation of the first edge device and the second edge device. Gateway components can be deployed to the first edge device or the second edge device based on a communication protocol utilized by the first edge device or the second edge device. The building system can select gateway components to deploy to the first edge device or the second edge device that include computer-executable instructions that allow the first edge device and the second edge device to communicate with one another, and with other computing systems using various communication protocols.

As described herein, the one or more gateway components can include any type of software component, hardware configuration settings, or combinations thereof. The gateway components may include processor-executable instructions, which can be executed by the physical gateway to which the gateway component(s) are deployed. The one or more gateway components can cause the physical gateway to communicate with a building device broker (e.g., the building device broker 4105) to facilitate communication of data samples, conditions, operations, or signals between the first edge device and the second edge device. Additionally, the one or more gateway components cause the first edge device or the second edge device to communicate data samples, operations, signals, or messages to the cloud platform. The gateway components may include adapters or integrations that facilitate communication with one or more other computing systems (e.g., a BMS server, other building subsystems, etc.). The gateway components can cause the first edge device to communicate an event (e.g., a person entering the building, entering a room, or any other detected event, etc.) to the second edge device based on a rule being triggered associated with the first condition. The rule can be, for example, to set certain climate control settings (e.g., temperature, etc.) when a person has been detected. However, it should be understood that any type of user-definable condition can be utilized. The second instance of the one or more gateway components executing at the second edge device can cause the second edge device to control the second condition (e.g., the temperature of the building, etc.) upon receiving the event from the first edge device (e.g., via the building device broker, via the cloud platform, via direct communication, etc.). The building components may include one or more building services that can generate additional analytics data based on detected events, conditions, or other information gathered or processed by the first edge device or the second edge device.

Containerization of Gateway Components on Edge Devices—Optimization and Autoconfiguration of Edge Devices

The techniques described herein may be utilized to optimize and configure edge devices utilizing various computing systems described herein, including the cloud platform 3106, the twin manager 3108, the edge platform 3102, the user device 3176, the local server 3656, the computing system 3660, the local server 3702, the local BMS server 3804, the network engine 3816, the gateway 4004, the building broker device 4105, the gateway manager 4206, the cluster gateway 4206, or the building subsystems 3122, among others.

Cloud-based data processing has become more popular due to the decreased cost and increased scale and efficiency of cloud computing systems. Cloud computing is useful when attempting to process data gathered from devices, such as the various building devices described herein, that would otherwise lack the processing power or appropriately optimized software to process that data locally. However, the use of cloud computing platforms for processing large amounts of data from a large pool of edge devices becomes more and more inefficient as the number of edge devices increases. The reduction in processing efficiency and increased latency makes certain types of processing, such as real-time or near real-time processing, impractical to perform using a cloud-processing system architecture.

To address these issues, the systems and methods described herein can be utilized to optimize software components, such as machine-learning models, to execute directly on edge devices. The optimization techniques described herein can be utilized to automatically modify, configure, or generate various components (e.g., gateway components, engine components, connectors, machine-learning models, APIs, etc.) such that the components are optimized for the particular edge device on which they will execute. The configuration of the components can be performed based on the architecture, processing capability, and processing demand of the edge device, among other factors as described herein. While various implementations described herein are configured to allow for processing to be performed at edge devices, it should be understood that, in various embodiments, processing may additionally or alternatively be performed both in edge devices and in other on-premises and/or off-premises devices, including cloud or other off-premises standalone or distributed computing systems, and all such embodiments are contemplated within the scope of the present disclosure.

Automatically optimizing and configuring components for edge devices, when those components would otherwise execute on a cloud computing system, improves the overall computational efficiency of the system. In particular, the use of edge processing enables a distributed processing platform that reduces the inherent latency in communicating and polling a cloud computing system, which enables real-time or near real-time processing of data captured by the edge device. Additionally, utilizing edge processing improves the efficiency and bandwidth of the networks on which the edge devices operate. In a cloud computing architecture, all edge devices would need to transmit all of the data points captured to the cloud computing system for processing (which is particularly burdensome for near real-time processing). By automatically optimizing components to execute on edge devices, the data points captured by the edge devices need not be transmitted en masse to the cloud computing system, which significantly reduces the amount of network resources required to execute certain components, and improves the overall efficiency of the system.

Additionally, the systems and methods described herein can be utilized to automatically configure (sometimes referred to herein as “autoconfigure” or performing “autoconfiguration”) edge devices by managing the components, connectors, operating system features, and other related data via a cloud computing system. The techniques described herein can be utilized to manage the operations of and coordinate the lifecycle of edge devices remotely, via a cloud computing system. The device management techniques described herein can be utilized to manage and execute commands that update software of edge devices, reboot edge devices, manage the configuration of edge devices, restore edge devices to their factory default settings or software configuration, and activate or deactivate edge devices, among other operations. The techniques described herein can be utilized to define and customize connector software, which can facilitate communications between two or more computing devices described herein. The connector software can be remotely defined and managed via user interfaces provided by a cloud computing system. The connector software can then be pushed to edge devices using the device management techniques described herein.

Various implementations of the present disclosure may utilize any feature or combination of features described in U.S. Patent Application Nos. 63/315,442, 63/315,452, 63/315,454, 63/315,459, and/or 63/315,463, each of which is incorporated herein by reference in its entirety and for all purposes. For example, in some such implementations, embodiments of the present disclosure may utilize a common data bus at the edge devices, be configured to ingest information from other on-premises/edge devices via one or more protocol agents or brokers, and/or may utilize various other features shown and described in the aforementioned patent applications. In some such implementations, the systems and methods of the present disclosure may incorporate one or more of the features shown and described, for example, with respect to FIG. 28 (or any of the other illustrative figures and accompanying disclosure) of U.S. Patent Application No. 63/315,463. Additionally or alternatively, various implementations of the present disclosure may utilize any feature or combination of features described in U.S. patent application Ser. Nos. 16/792,149, 17/229,782, 17/304,933, 16/379,700, 16/190,105, 17/648,281, 63/267,386, and/or 17/892,927, each of which is incorporated herein by reference in its entirety and for all purposes.

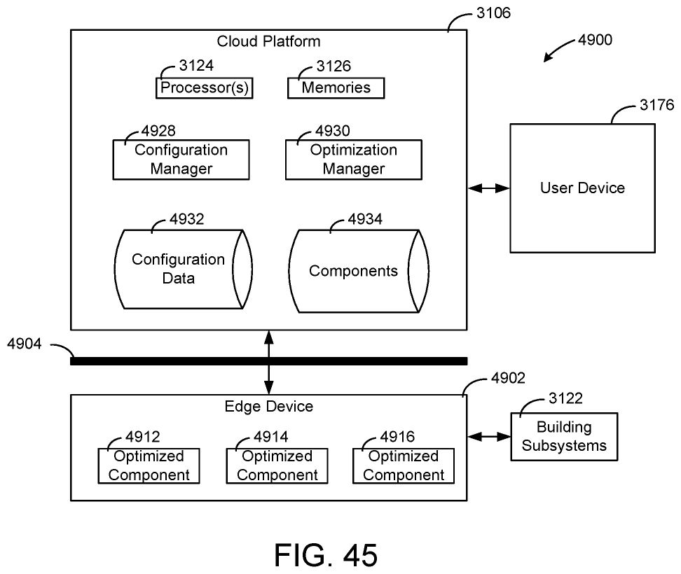

Referring to FIG. 45, illustrated is diagram of a system 4900 that may be utilized to perform optimization and automatic configuration of edge devices, according to an embodiment. As shown, the system 4900 can include an edge device 4902, a cloud platform 3106, and a user device 3176, in an embodiment. The edge device 4902, the cloud platform 3106, and the user device 3176 can each be separate services deployed on the same or different computing systems. In some embodiments, the cloud platform 3106 and the user device 3176 are implemented in off premises computing systems, e.g., outside a building. The edge device 4902 can be implemented on-premises, e.g., within the building. However, any combination of on-premises and off-premises components of the system 4900 can be implemented.

As described herein, the cloud platform 3106 can include one or more processors 3124 and one or more memories 3126. The processor(s) 124 can include a general purpose or specific purpose processors, an ASIC, a graphical processing unit (GPU) one or more field programmable gate arrays, a group of processing components, or other suitable processing components. The processor(s) 124 may be configured to execute computer code and/or instructions stored in the memories 3126 or received from other computer readable media (e.g., CDROM, network storage, a remote server, etc.). The processor(s) 124 may be part of multiple servers or computing systems that make up the cloud platform 3106, for example, in a remote datacenter, server farm, or other type of distributed computing environment.

The memories 3126 can include one or more devices (e.g., memory units, memory devices, storage devices, etc.) for storing data or computer code for completing or facilitating the various processes described in the present disclosure. The memories 3126 can include RAM, ROM, hard drive storage, temporary storage, non-volatile memory, flash memory, optical memory, or any other suitable memory for storing software objects or computer instructions. The memories 3126 can include database components, object code components, script components, or any other type of information structure for supporting the various activities and information structures described in the present disclosure. The memories 3126 can be communicably connected to the processors and can include computer code for executing (e.g., by the processors 3124) one or more processes described herein.

Although not necessarily pictured here, the configuration data 4932 and the components 4934 may be stored as part of the memories 3126, or may be stored in external databases that are in communication with the cloud platform 3106 (e.g., via one or more networks). The configuration data 4932 can include any of the data relating to configuring the edge devices 4902, as described herein. The configuration data can include software information of the edge devices 4902, operating system information of the edge devices 4902, status information (e.g., device up-time, service schedule, maintenance history, etc.), as well as metadata corresponding to the edge devices 4902, among other information. The configuration data 4932 can be created, updated, or modified by the cloud platform 3106 based on the techniques described herein. In embodiment, in response to corresponding requests from the user device 3176, or in response to scheduled updates or changes, the cloud platform 3106 can update a local configuration of a respective edge device 4902 based on the techniques described herein.

The configuration data 4932 can include data configured for a number of edge devices 4902, and for a wide variety of edge devices 4902 (e.g., network engines, device gateways, local servers, etc.). For example, the configuration data 4932 can include configuration data for any of the computing devices, systems, or platforms described herein. The configuration data 4932 can be managed, updated, or otherwise utilized by the configuration manager 4928, as described herein. The configuration data 4932 may also include connectivity data. The connectivity data may include information relating to which edge devices 4902 are connected to other devices in a network, one or more possible communication pathways (e.g., via routers, switches, gateways, etc.) to communicate with the edge devices 4902, and network topology information (e.g., of the network 4904, of networks to which the network 4904 is connected, etc.).

The components 4934 can include software that can be optimized using various techniques described herein. The components 4934 can include connectors, data processing applications, or other types of processor-executable instructions. The components 4934 may be executable by the cloud platform 3106 to perform one or more data processing operations (e.g., analysis of sensor data, machine-learning operations, unsupervised clustering of data retrieved using various techniques described herein, etc.). As described in further detail herein, the optimization manager 4930 can optimize one or more of the components 4934 for one or more target edge devices 4902. In brief overview, the optimization manager 4930 can access the computational capabilities, architecture, status, and other information relating to the target edge device 4902, and can automatically modify one or more of the components to be optimized for the target edge device 4902.

Each of the configuration manager 4928 and the optimization manager 4930 may be hardware, software, or a combination of hardware and software of the cloud platform 3106. The configuration manager 4928 and the optimization manager 4930 can execute one or more computing devices or servers of the cloud platform 3106 to perform the various operations described herein. In an embodiment, the configuration manager 4928 and the optimization manager 4930 can be stored as processor-executable instructions in the memories 3126, and when executed by the cloud platform 3106, cause the cloud platform 3106 to perform the various operations associated with each of the configuration manager 4928 and the optimization manager 4930.

The edge device 4902 may include any of the functionality of the edge device 3102, or the components thereof. The edge device 4902 can communicate with the building subsystems 3122, as described herein. The edge device 4902 can receive messages from the building subsystems 3122 or deliver messages to the building subsystems 3122. The edge device 4902 can includes one or multiple optimized components, e.g., the optimized components 4912, 4914, and 1916. Additionally, the edge device 4902 can include a local configuration, which may include a software configuration or installation, an operating system configuration or installation, driver configuration or installation, or any other type of component configuration described herein.

The optimized components 4912-1916 can include software that has been optimized by the optimization manager 4930 of the cloud platform 3106 to execute on the edge device 4902, for example, to perform edge processing of data received by or retrieved from the building subsystems 3122. Although not pictured here for visual clarify, the edge devices 4902 may include communication components, such as connectors or other communication software, hardware, or executable instructions as described herein, that can act as a gateway between the cloud platform 3106 and the building subsystems 3122. In some embodiments, the cloud platform 3106 can deploy one or more of the optimized components 4912-1916 to the edge device 4902, using various techniques described herein. In this regard, lower latency in management of the building subsystems 3122 can be realized.

The edge device 4902 can be connected to the cloud platform 3106 via a network 4904. The network 4904 can communicatively couple the devices and systems of the system 4900. In some embodiments, the network 4904 is at least one of and/or a combination of a Wi-Fi network, a wired Ethernet network, a ZigBee network, a Bluetooth network, and/or any other wireless network. The network 4904 may be a local area network or a wide area network (e.g., the Internet, a building WAN, etc.) and may use a variety of communications protocols (e.g., BACnet, IP, LON, etc.). The network 4904 may include routers, modems, servers, cell towers, satellites, and/or network switches. The network 4904 may be a combination of wired and wireless networks. Although only one edge device 4902 is shown in the system 4900 for visual clarity and simplicity, it should be understood that any number of edge devices 4902 (corresponding to any number of buildings) can be included in the system 4900 and communicate with the cloud platform 3106 as described herein.

The cloud platform 3106 can be configured to facilitate communication and routing of messages between the user device 3176 and the edge device 4902, and/or any other system. The cloud platform 3106 can include any of the components described herein, and can implement any of the processing functionality of the devices described herein. In an embodiment, the cloud platform 3106 can host a web-based service or website, via which the user device 3176 can access one or more user interfaces to coordinate various functionality described herein. In some embodiments, the cloud platform 3106 can facilitate communications between various computing systems described herein via the network 4904.

The user device 3176 may be a laptop computer, a desktop computer, a smartphone, a tablet, and/or any other device with an input interface (e.g., touch screen, mouse, keyboard, etc.) and an output interface (e.g., a speaker, a display, etc.). The user device 3176 can receive input via the input interface, and provide output via the output interface. For example, the user device 3176 can receive user input (e.g., interactions such as mouse clicks, keyboard input, tap or touch gestures, etc.), which may correspond to interactions. The user device 3176 can present one or more user interfaces described herein (e.g., the user interfaces provided by the cloud platform 3106) via the output interface.

The user device 3176 can be in communication with the cloud platform 3106 via the network 4904. For example, the user device 3176 can access one or more web-based user interfaces provided by the cloud platform 3106 (e.g., by accessing a corresponding uniform resource locator (URL) or uniform resource identifier (URI), etc.). In response to corresponding interactions with the user interfaces, the user device 3176 can transmit requests to the cloud platform 3106 to perform one or more operations, including the operations described in connection with the configuration manager 4928 or the optimization manager 4930.

Referring now to the operations of the configuration manager 4928, the configuration manager 4928 can coordinate and facilitate management of edge devices 4902, including the creation and autoconfiguration of connector templates for one or more edge devices 4902, and providing device management functionality via the network 4904. The configuration manager 4928 can manage and execute commands that update software of edge devices, reboot edge devices, manage the configuration of edge devices 4902, restore edge devices 4902 to their factory default settings or software configuration, and activate or deactivate edge devices 4902, among other operations. The connection manager 4928 may also monitor connectivity between edge devices, identify a connection failure between two edge devices, and determine a recommendation to address the connection failure.

The configuration manager 4928 can access and provide a list of edge devices 4902 with which the cloud platform 3106 can communicate, for example, for display in a user interface. To generate and display the list, the configuration manager 4928 can access the configuration data 4932, which stores identifiers of the edge devices 4902, along with their corresponding status. The user interface can display various information about each edge device 4902, including a device name, a group name, an edge status, a platform name (e.g., processor architecture), an operating system version, a software package version (e.g., which may corresponding to one or more components described herein), a hostname (shown here as an IP address), a gateway name of a gate to which the edge device is connected (if any), and a date identifying the last software upgrade.

In the user interface, each item in the list of devices includes a button that, when interacted with, enables the user to issue one or more commands to the configuration manager 4928 to manage the respective device. Drop-down menus can provide a list of commands for each edge device, such as a command to reboot the respect edge device 4902, a reset to factory default command, a deactivation command, and an upgrade software command. To upgrade, update, or configure software, the configuration manager 4928 can transmit updated software to the respective edge device 4902, and cause the respective edge device 4902 to execute processor-executable instructions to install and configure the software according to the commands issued by the configuration manager 4928.

In an embodiment, when an upgrade software command is selected at the user interfaces provided by the configuration manager 4928, the configuration manager 4928 can provide another user interface to enable the user to select one or more software components, versions, or deployments to deploy to the respective edge device. In an embodiment, if a software version is already up-to-date (e.g., no upgrades available) the configuration manager 4928 can display a notification indicating that the software is up-to-date. The configuration manager 4928 can further provide graphical user interfaces (or other types of selectable user interface elements), or application programming interfaces, that can be utilized to specify which software components to deploy, upgrade, or otherwise provide to the edge device 4902.

The configuration manager 4928 can manage any type of software, component, connector, or other processor-executable instructions that can be provided to and executed by the edge device 4902 in a similar manner. When a software upgrade is selected or specified, the configuration manager 4928 can begin to deploy the selected software to the edge device 4902, and can execute one or more scripts or processor-executable instructions to install and configure the selected software at the edge device 4902. The configuration manager 4928 can transmit the data for the installation to the edge device 4902 via the network 4904.

As the selected components are being deployed, the configuration manager 4928 can maintain and display information indicating a status of the edge device 4902 and the status of the deployment. A historic listing of other operations performed by the configuration manager 4928 can also be maintained or displayed in a status interface. Each item in the listing can include a name of the action performed by the configuration manager 4928, a status of the respective item (e.g., “InProgress,” “Completed,” “Failed,” etc.), a date and timestamp corresponding to the operation, and a message (e.g., a status message, etc.) corresponding to the respective action. Any of the information presented on the user interfaces provided by the configuration manager 4928 can be stored as part of the configuration data 4932.

The configuration manager 4928 can provide user interfaces that enable an operator to configure one or more edge devices 4902, or the components deployed thereon. For example, the configuration manager 4928 can display a user interface that shows a list of configuration templates. The example that follows describes a configuration process for a chiller controller with a device name “VSExxx.” However, similar operations may be performed for any software on any number of edge devices, in order to configure one or more connectors, components, or other processor-executable instructions to facilitate communication between building devices.

The connectors implemented by the configuration manager 4928 can be utilized to connect with different sensors and devices at the edge (e.g., the building subsystems 3122), retrieve and format data retrieved from the building subsystems 3122, and provide said data in one or more data structures to the cloud platform 3106. The connectors may be similar to, or may be or include, any of the connectors described herein. The configuration manager 4928 can provide user interfaces that enable a user to specify parameters for a template connector, which can then be generated by the configuration manager 4928 and provided to the edge device 4902 to retrieve data. In this example, a new connector for a VSExxx device has been defined.

Upon creating the connector template for the VSExxx device, the configuration manager 4928 can enables selection or specification of one or more parameters for the template connector, such as a name for the template, a direction for the data (e.g., inbound is receiving data, such as from a sensor, outbound is providing data, and bidirectional includes functionality for inbound and output), as well as using sensor discovery (e.g., the device discovery functionality described herein). Additionally, the configuration manager 4928 can also enable selection or specification of one or more applications that execute on the edge device 4902 that implement the connector. In an embodiment, if an application is not selected, a default application may be selected based on, for example, other parameters specified for the connector, such as data types or server fields. The application can be developed by the operator for the specific edge device using a software development kit that invokes one or more APIs of the cloud platform 3106 or the configuration manager 4928, thereby enabling the cloud platform 3106 to communicate with the edge device 4902 via the APIs.

The configuration manager 4928 can enable selection or specification of one or more server parameters for the connector (e.g., parameters that coordinate data retrieval or provision, ports, addresses, device data, etc.). The configuration manager 4928 can enable selection or specification of one or more parameters for each field (e.g., field name, property name, value type (e.g., data type such as string, integer, floating-point value, etc.), default value, whether the parameter is a required parameter, and one or more guidance notes that may be accessed while working with the respective connector via the user device 3176, etc.).

The configuration manager 4928 can enable selection of one or more sensor data parameters for the connector template. The sensor parameters can similarly be selected and added form the user interface elements (or via APIs) provided by the configuration manager 4928. The sensor parameters can include parameters of the sensors in communication with the edge device 4902 that are accessed using the connector template. Fields similar to those provided for the server parameters can be specified for each field of the sensor parameters, as shown. In this example, the edge device is in communication with a building subsystem 3122 that gathers data from four vibration sensors, and therefore there are fields for sensor parameters that correspond to each of the four vibration sensors. In an embodiment, the device discovery functionality described herein can be utilized to identify one or more configurations or sensors, which can be provided to the configuration manager 4928 such that the template connector can be automatically populated.

The configuration manager 4928 can save the template in the configuration data 4932. When the operator wants to deploy the generated template to an edge device, the configuration manager 4928 can be utilized to deploy one or more connectors. The configuration manager 4928 can present a user interface that enables the operator to deploy one or more connectors to a selected edge device. In this example, there is one edge device listed, but it should be understood that any number of edge devices may be listed and managed by the configuration manager 4928. The configuration manager 4928 can allow selection of one or more generated connector templates (e.g., via a user interface or an API), which can then be deployed on the edge device 4902 using the techniques described herein.

Referring now to the operations of the optimization manager 4930, the optimization manager 4930 can optimize one or more of the components 4934 to execute on a target edge device 4902, by generating corresponding optimized components (e.g. the optimized components 4912-1916). As described herein, cloud-based computing is impractical or impossible for real-time or near real-time data processing, due to the inherent latency of cloud computing. To address these issues, the optimization manager 4930 can optimize and deploy one or more components 4934 for a target edge device 4902, such that the target edge device 4902 can execute the corresponding optimized component at the edge without necessarily performing cloud computing.

The components 4932 may include machine-learning models that execute using data gathered from the building subsystems 3122 as input. An example machine learning workflow can include of preprocessing, prediction (or executing another type of machine-learning operation), and post processing. Constrained devices (e.g., the edge devices 4902) may generally have fewer resources to run machine-learning workflows than the cloud platform 3106. This problem is compounded by the fact that typical machine-learning workflows are written in dynamic languages like Python. Although dynamic languages can accelerate deployment of machine-learning implementations, such languages are inefficient when it comes to resource usage and are not as computationally efficient compared to compiled languages. As such, machine-learning models are typically developed in a dynamic language and then executed on a large cluster of servers (e.g., the cloud platform 3106). Additionally, the data is pre- and post-processed before and after machine learning model prediction in a workflow by the cloud platform 3106 (e.g., by another cluster of computing devices, etc.).

One approach to solving this problem is to combine machine learning and stream processing using components (e.g., the optimized components 4912-1916) to be executed on an edge device 4902. To do so, the optimization manager 4930 can generate code that gets compiled into code specific to the machine-learning model and the target edge device 4902, thereby using the computational resources and memory of the edge device 4902 as efficiently as possible. To do so, the optimization manager 4930 can utilize two sets of APIs. One set of APIs is utilized for stream processing and other set of APIs is used for machine learning. The stream processing APIs can be used to read data, and perform pre-processing and post-processing. The machine learning APIs can be executed on the edge device 4902 to load the model, bind the model inputs to the streams of data and bind the outputs to streams that can be processed further.

The optimization manager 4930 can support existing machine-learning libraries as any new machine libraries that may be developed as part of the components 4934. Once a machine-learning model is developed in a framework of their choice, they can define all the pre-processing and post-processing of inputs and outputs using API bindings that invoke functionality of the optimization manager 4930. Once the code for the machine-learning model and the pre-processing and post-processing steps have been developed, the optimization manager 4930 can apply software optimization techniques and generate an optimized model and stream processing definitions (e.g., the optimized components 4912-1916) into a compiled language (e.g., C, C++, Rust, etc.). The optimization manager 4930 can then compiles the generated code while targeting a native binary for the target edge device 4902, suing runtime that is already deployed on the target edge device 4902 (e.g., one or more software configurations, operating systems, hardware acceleration libraries, etc.).

One advantage of this approach is operators that develop machine-learning models need not manually optimize the machine-learning models for any specific target edge device 4902. The optimization manager 4930 can automatically identify and apply optimizations to machine-learning models based on the respective type of model, input data, and other operator-specified (e.g., via one or more user interfaces) parameters of the machine-learning model. Some example optimizations include pruning. The optimization manager 4930 can generate code for machine-learning models that can execute efficiently while using fewer computational resources and with faster inference times for a target edge device 4902. This enables efficient edge processing without tedious manual intervention or optimizations.

Models that will be optimized by the optimization manager 4930 can be platform agnostic and may be developed using any suitable the machine-learning library or framework. Once a model has been developed and tested locally using a framework implemented or utilized by the optimization manager 4930, the optimization manager 4930 can utilize input provided by a user to determine one or more model parameters. The model parameters can include, but are not limited to, model architecture type, number of layers, layer type, loss function type, layer architecture, or other types of machine-learning model architecture parameters. The optimization manager 4930 can also enable a user to specify target system information (e.g., architecture, computational resources, other constraints, etc.). Based on this data, the optimization manager 4930 can select an optimal runtime for the model, which can be used to compile the model while targeting the target edge device 4902.

In an example implementation, an operator may first define a machine-learning model using a library such as Tensorflow, which may utilize more computational resources than are practically available at a target edge device 4902. Because the model is specified in a dynamic language, the model is agnostic of a target platform, but may implemented in a target runtime which could be different from runtimes present at the target edge device 4902. The optimization manager 4930 can then perform one or more optimization techniques on the model, to optimize the model in various dimensions. For example, the optimization manager 4930 can detect the processor types present on the target edge device 4902 (e.g., via the configuration data 4932 or by communicating with the target edge device 4902 via the network 4904). Furthering this example, if the model can be targeted to run on one or more GPUs, and the target edge device 4902 includes a GPU that is available for machine-learning processing, the optimization manager 4930 can configure the model to utilize the GPU accelerated runtimes of the target edge device. Likewise, if the model can be targeted to run on a general-purpose CPU, and the target edge device includes a general-purpose CPU that is available for machine-learning processing, the optimization manager 4930 can automatically transform the model to execute on a CPU runtime for the target edge device 4902 (e.g., OpenVINO, etc.). In another example, if the target edge device 4902 is a resource constrained device, such as an ARM platform, the optimization manager 4930 can transform the model to utilize the tflite runtime, which is less computationally intensive and optimized for ARM devices. Additionally, the optimization manager 4930 may deploy tflite to the target edge device 4902, if not already installed. In addition, the optimization manager 4930 can further optimize the model to take advantage of vendor-specific libraries like armnn, for example, when targeting an ARM device.

Referring back to the functionality of the configuration manager 4928, the configuration manager 4928 can monitor and identify connection failures in the network 4904 or other networks to which the edge devices 4902 are connected. In particular, the configuration manager can monitor connectivity between edge devices, identify a connection failure between two edge devices, and determine a recommendation to address the connection failure. The configuration manager 4928 can perform these operations, for example, in response to a corresponding request from the user device 3176. As described herein, the configuration manager 4928 can provide one or more web-based user interfaces that enable the user device 3176 to provide requests relating to the connectivity functionality of the configuration manager 4928. The configuration manager 4928 can store connectivity data as part of the configuration information 4930. The connectivity data can include information relating to which edge devices 4902 are connected to other devices in a network, one or more possible communication pathways (e.g., via routers, switches, gateways, etc.) to communicate with the edge devices 4902, and network topology information (e.g., of the network 4904, of networks to which the network 4904 is connected, etc.), network state information, among other network features described herein.

The configuration manager 4928 can utilize a variety of techniques to diagnose connectivity problems on various networks (e.g., the network 4904, underlay networks, overlay networks, etc.). For example, the configuration manager 4928 can ping local devices to check the connectivity of local devices behind an Airwall gateway, check tunnels to determine whether communications can travel over a host identity protocol (HIP) tunnel (e.g., and create a tunnel between two Airwalls if one does not exist), ping an IP or hostname from an Airwall via an underlay or overlay network (e.g., both of which may be included in the network 4904), perform a traceroute to an IP or hostname from an Airwall from an overlay or underlay network, as well as check HIP connectivity to an Airwall relay (e.g., an Airwall that relays traffic between two other Airwalls when they cannot communicate directly on an underlay network due to potential network address translation (NAT) issues), among other functionality.

Based on requests from the user device 3176 and based on network information in the configuration data 4932, the configuration manager 4928 can automatically select and execute operations to check and diagnose potential connectivity issues between at least two edge devices 4902 (or between an edge device 4902 and another computing system described herein, or between two other computing systems that communicate via the network 4904). Automatic detection and diagnosis of network connectivity issues is useful because operators may not have all of the information or resources to manually detect or rectify the connectivity issues without the present techniques. Some example network issues include Airwalls that need to be in a relay rule so they can communicate via relay because they do not have direct underlay connectivity, firewall rules inadvertently blocking a HIP port preventing connectivity, or broken underlay network connectivity due to a gateway and its local device(s) not having routes set up to communicate with remote devices, among others.

The configuration manager 4928 can detect network settings (e.g., portions of the configuration data 4932) that have been misconfigured and are causing connectivity issues between two or more devices. Some example network configuration issues can include disabled devices, disabled gateways, disabled networks or subnets, or rules that otherwise block traffic between two or more devices (e.g., blocked ports, blocked connectivity functionality, etc.). Using the user interfaces provided by the configuration manager 4928, the user device 3176 can select two or more device for which to check and diagnose connectivity. Based on the results of its analysis, the configuration manager 4928 can provide one or more suggestions in the web-based interface to address any detected connectivity issues.

Some example conditions in the network 4904 that the configuration manager 4928 can detect include connectivity rules (or lack thereof) in the underlay or overlay network that prevent device connectivity, port filtering that blocks internet control message protocol (ICMP) traffic, offline gateways (e.g., Airwalls), or lack of configuration to communicate with remote devices, among others. To detect these conditions, the configuration manager 4928 can identify and maintain various information about the status of the network in the configuration data 4932, including device groups policies and blocks; the status (e.g., enabled, disabled) of devices, gateways (e.g., Airwalls), and overlay networks; relay rule data; local device ping; remote device ping on an overlay network; information from gateway underlay network pings and BEX (e.g., HIP tunnel handshake); gateway connectivity data (e.g., whether the gateway is connecting to other Airwalls successfully); relay probes; and relay diagnostic information; among other data.

One or more source devices (e.g., an edge device 4902, other computing systems described herein) and one or more destination devices (e.g., another edge device 4902, other computing systems described herein, etc.) can be selected (e.g., via a user interface or an API) or identified, in order to evaluate connectivity between the selected devices. The A hostname or an IP address may be provided as the source or destination device. Upon selection of the devices, the configuration manager 4928 can access the network topology information in the configuration data 4932, and generate a graph indicating a communication pathway (e.g., via the network 4904, which may include one or more gateways) between the two devices.

The configuration manager 4928 can then present the generated graph showing the communication pathway on another user interface. The configuration manager 4928 can check the connectivity between the two selected devices. The configuration manager 4928 can begin executing the various connectivity checks described herein. In an embodiment, the configuration manager 4928 may execute one or more of the connectivity operations in parallel to improve computational efficiency. In doing so, the configuration manager 4928 can analyze the results of the diagnostic tests performed between the two devices to determine whether connectivity was successful.

When the configuration manager 4928 is performing the connectivity checks, the configuration manager 4928 can display another user interface that shows a status of the diagnostic operations. As each diagnostic test completes, the configuration manager 4928 can dynamically update the user interface to include each result of each diagnostic test. The user interface can be dynamically updated to display a list of each completed diagnostic test and its corresponding status (e.g., passed, failed, awaiting results, etc.). Once all of the diagnostic tests have been performed, the configuration manager 4928 can provide a list of recommendations to address any connectivity issues that are detected.

The configuration manager 4928 can detect or implement port filtering (e.g., including layer 4 rules), provide tunnel statistics, pass application traffic (e.g., RDP, HTTP/S, SSH, etc.), and inspect cloud routes and security groups, among other functionality. In some embodiments, the configuration manager 4928 can enable a user to select a network object and indicate an IP address within the network object. In addition to recommendations, the configuration manager 4928 may provide links that, when interacted with, cause the configuration manager 4928 to attempt to address the detected connectivity issues automatically. For example, the configuration manager 4928 may enable one or more devices, device groups, or overlay networks, add one or more gateways to a relay rule, or activate managed relay rules for an overlay network, among other operations.

Additional functionality of the configuration manager 4928 includes spoofing traffic from a local device so a gateway can directly ping or pass traffic to a remote device, to address limitations relating to initiating traffic on device that are not under the control of the configuration manager 4928. The configuration manager 4928 can mine data from a policy builder that can indicate what the connectivity intention should be, as well as add the ability to detect device-to-device traffic on overlay networks. The configuration manager 4928 can provide a beacon server on an overlay network to detect whether the beacon server is accessible to a selected device. The configuration manager 4928 can test the basic connectivity of an overlay network by determining whether a selected device can communicate with another device on the network.

### Containerization of Gateway Components on Edge Devices—Integration and Containerization of Gateway Components

Edge devices, such as gateways, network devices, or other types of network-capable building equipment can be utilized to manage building subsystems that otherwise lack “smart” capabilities, such as intelligent management or connectivity to cloud computing environments. Edge devices may be any type of device that executes software, including any of the computing devices described herein. Building device gateways, which may include any of the gateways, network devices, or edge devices described herein, can act as interfaces between traditional networked computing systems and building equipment, enabling remote management, automatic configuration, and additional controls. One advantage of these types of systems is the ability to interface with any type of building equipment, enabling conversion of legacy buildings with legacy devices into network-enabled smart buildings.

The techniques described herein provide containerized building management software components. Using containerized components reduces instances of software conflicts (e.g., dependency issues), improves performance and efficiency of updating or on-boarding building device gateways, and/or provides an extensible communication framework based on a publisher-subscriber messaging protocol, in various illustrative implementations. For example, rather than re-imaging entire devices or maintaining cumbersome package management software, the implementation of gateway components as containers enables updates or modifications to system software without inadvertently causing compatibility issues with the gateway components. Communication between containerized gateway components can be facilitated via one or more virtual busses, which may be implemented via virtual IP networks by the processors of the building device gateway.

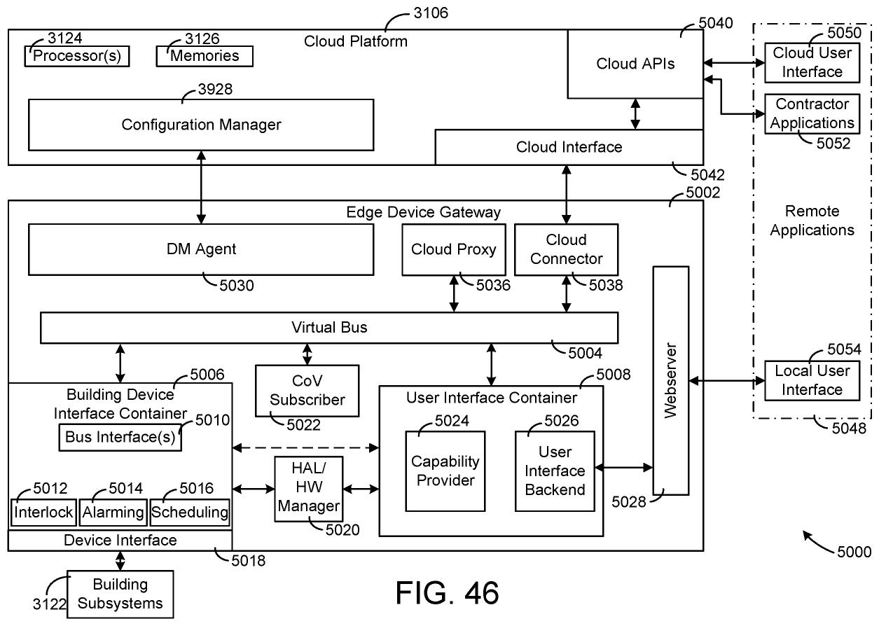

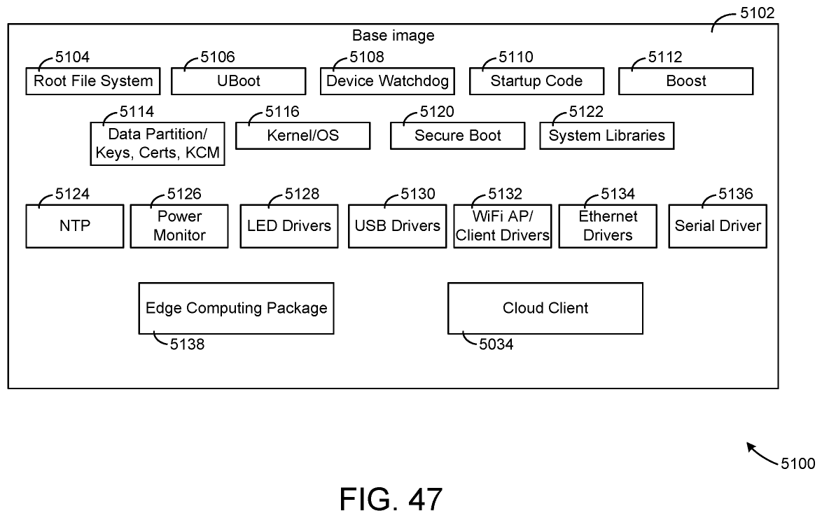

Referring to FIG. 46, illustrated is a block diagram of an example system 5000 including an example building device gateway 5102 that implements containerized gateway components (e.g., the building device interface container 5006, the user interface container 5008, the edge manager/Airwall manager 5032, the change of value (CoV) subscriber 5022, the cloud proxy 5036, the cloud connector 5038, etc.), in accordance with one or more implementations. As shown, the system 5000 includes the cloud platform 3106, the edge device gateway 5002, one or more remote applications 5048 (e.g., which may be implemented or executed by one or more user devices 3176 described herein, etc.), and one or more building subsystems 3122. The edge device gateway 5002 and the cloud platform 3106 can each be separate services deployed on the same or different computing systems. In some embodiments, the cloud platform 3106 is implemented in off-premises computing systems, e.g., outside a building. The edge device gateway 5002 and the building subsystems 3122 can be implemented on-premises, e.g., within the building. However, any combination of on-premises and off-premises components of the system 5000 can be implemented.

As described herein, the cloud platform 3106 can include one or more processors 3124 and one or more memories 3126. The processor(s) 124 can include a general purpose or specific purpose processors, an ASIC, a graphical processing unit (GPU) one or more field programmable gate arrays, a group of processing components, or other suitable processing components. The processor(s) 124 may be configured to execute computer code and/or instructions stored in the memories 3126 or received from other computer readable media (e.g., CDROM, network storage, a remote server, etc.). The processor(s) 124 may be part of multiple servers or computing systems that make up the cloud platform 3106, for example, in a remote datacenter, server farm, or other type of distributed computing environment.

The memories 3126 can include one or more devices (e.g., memory units, memory devices, storage devices, etc.) for storing data or computer code for completing or facilitating the various processes described in the present disclosure. The memories 3126 can include RAM, ROM, hard drive storage, temporary storage, non-volatile memory, flash memory, optical memory, or any other suitable memory for storing software objects or computer instructions. The memories 3126 can include database components, object code components, script components, or any other type of information structure for supporting the various activities and information structures described in the present disclosure. The memories 3126 can be communicably connected to the processors 3124 and can include computer code for executing (e.g., by the processors 3124) one or more processes described herein. The edge device gateway 5002 may also include one or more processors 3124 and one or more memories 3126.

As shown, the cloud platform 3106 can store one or more configuration images 5044, which may include full system images that store software for the edge device gateway 5002. The configuration images 5044 can be requested by or communicated to the device management (DM) agent 5030 executing on the edge device gateway 5002. The configuration images 5044 stored by the cloud platform 3106 can be specific to (e.g., include software compiled or otherwise configured for) particular edge devices (e.g., the edge device gateway 5002, the edge device 4902, other edge devices described herein, etc.).

The cloud platform 3106 can implement or execute the configuration manager 4928, and any of the functionality associated therewith described herein. In some implementations, the cloud platform 3106 can include and execute the optimization manager 4930 described in connection with FIG. 44. The configuration manager 4928 can communicate with the edge manager/airwall manager 5032 of the edge device gateway 5002. In some implementations, the configuration manager 4928 can update, remove, provide, or modify one or more of the containerized components of the edge device gateway 5002. In some implementations, the configuration manager 4928 can create, modify, or remove one or more network permissions of the edge device gateway 5002, enabling (or disabling) the ability of the edge device gateway 5002 to communicate via one or more networks.

The cloud platform 3106 can implement a cloud manager 5046, which can be utilized to provide, update, modify, or remove any low-level software that can be implemented by the edge device gateway 5002. For example, the cloud manager 5046 provide, update, modify, or remove device firmware, low-level drivers or system configurations, or host-specific applications that are separate from the containerized gateway components described herein. The cloud manager 5046 can communicate with the cloud client 5034 that executes on the edge device gateway 5002. The cloud client 5034 can retrieve, implement, manage, or execute any of the commands or data received or requested from the cloud manager 5046.

The cloud platform 3106 can include one or more cloud interfaces 5042, which can include software, hardware, or combinations of hardware and software that enable communication with the cloud connector 5038 of one or more edge device gateways 5002. The cloud interface 5042 can send or receive various messages to or from the cloud platform 3106, or in some implementations, via other computing systems. The cloud interface 5042 can utilize one or more encrypted keys, certificates, or other types of authentication credentials to verify or authenticate the edge device gateway 5002 with which the cloud platform 3106 is communicating.

The cloud platform 3106 can include one or more cloud APIs 5040, which may be utilized to communicate with one or more computing devices other than the edge device gateway 5002. For example, the cloud APIs 5040 may be utilized to communicate with one or more user devices 3176 as described herein, which may implement or execute one or more of the remote applications 5048. For example, the cloud APIs 5040 may provide one or more cloud user interfaces 5050 (e.g., via a webserver and displayed in a web browser, etc.). In some implementations, the cloud APIs 5040 can be utilized to communicate with one or more contractor applications 5052, which may be executing on a device of a contractor that is servicing one or more of the building subsystems 3122 of the building.

The system 5000 can include one or more remote applications 5048, which may be executed by one or more user devices 3176 in communication with the cloud computing system via a network (e.g., the network 4904 described in FIG. 44, etc.). The remote applications 5048 can include web browsers, native applications, or applications specific to particular edge devices or edge device gateways 5002, among others. The remote applications 5048 can be utilized to present a cloud user interface 5050 (e.g., via one or more web browsers or native applications). The cloud user interface 5050 can be provided via one or more of the cloud APIs 5040, and can enable control of the building subsystems 3122 or the edge device gateway 5002, display data from the building subsystems 3122 or the edge device gateway 5002, or enable configuration of the building subsystems 3122 or the edge device gateway 5002.

The contractor applications 5052 can be executed by one or more user devices 3176 in communication with the cloud computing system via a network (e.g., the network 4904 described in FIG. 44, etc.). The contractor applications 5052 can be executing on a device of a contractor that is servicing one or more of the building subsystems 3122 or the edge device gateway 5002 of the building. The contractor applications 5052 can provide, for example, low-level configuration functionality to diagnose or configure the functionality of the edge device gateway 5002. In some implementations, the contractor applications 5052 can provide additional administrative functionality that is otherwise absent from the cloud user interface 5050.

The remote applications 5048 can include one or more local user interfaces 5054, which may be executed by one or more user devices 3176 in communication with the edge device gateway 5002 via a network (e.g., the network 4904 described in FIG. 44, etc.). The local user interfaces 5054 can include web browsers, native applications, or applications specific to particular edge devices or edge device gateways 5022, among others. The local user interfaces 5054 can be utilized to present a user interface provided by the webserver 5028 of the edge device gateway 5002. The local user interfaces 5054 can enable control of the building subsystems 3122 or the edge device gateway 5002, display data from the building subsystems 3122 or the edge device gateway 5002, or enable configuration of the building subsystems 3122 or the edge device gateway 5002. The local user interfaces 5054 can be provided via a local network, rather than via the cloud platform 3106. In some implementations, the local user interfaces 5054 can be provided via the Internet.

Prior to discussing the functionality of the edge device gateway 5002, an example base image (e.g., one or more of the configuration images 5044) will be described in connection with FIG. 46. Referring to FIG. 46 in the context of the components described in connection with FIG. 45, illustrated is a block diagram 5100 of an example base image 5102 that may be implemented by the building device gateway 5002 described in connection with FIGS. 20, in accordance with one or more implementations. The base image 5102 may be a serialized copy of the entire state of a computer system stored in a non-volatile format. For example, the base image 5012 can include a root file system 5104, which may include a file system and a directory structure for storing one or more of the files described herein.

The base image 5102 can include a boot loader, shown here as UBoot 5106. The UBoot 5106 can include software written in machine code that loads the operating system 5116 into RAM during the boot process, and initiates execution of the operating system 5116. The base image 5102 may specify that UBoot 5106 be stored at a predetermined location in the memory of the edge device gateway 5002 with which the base image 5102 is configured.

The base image 5102 may include a device watchdog 5108. The device watchdog 5108 can be utilized to automatically reset the edge device gateway 5002 if certain conditions are not met. For example, the device watchdog 5108 can be a script or other processor-executable software that monitors the configuration of one or more containerized gateway components as the gateway components are initialized by the operating system 5116. The device watchdog 5108 can determine that a particular container has an error or has become unresponsive during initialization or execution. The device watchdog 5108 can generate a record of the error or unresponsive container, and may automatically reset the edge device gateway 5002. In some implementations, the device watchdog 5108 can transmit a message to the cloud platform 3106 or a user device 3176. In some implementations, the device watchdog 5108 can request automatic reconfiguration (e.g., re-flashing the base image 5102, upgrading one or more unresponsive containers, etc.) of the edge device gateway 5002 in response to detecting one of the aforementioned conditions.

The base image 5102 may include startup code 5110, which may include scripts or other processor-executable instructions that initialize one or more containerized gateway components and other software implemented by the edge device gateway 5002. When the operating system 5116 of the edge device gateway 5002 is initialized, the operating system 5116 may execute one or more of the startup scripts 5110 to initialize the containerized gateway components. For example, the edge device gateway 5002 may execute the startup scripts 5110 to initiate a Docker compose, which may cause various gateway component containers (e.g., the building device interface container 5006, the user interface container 5008, etc.) to become initialized. Additionally, the startup scripts 5110 may initiate the virtual bus 5004, which may include generating one or more virtual IP networks with which the containerized gateway components can communicate.

The base image 5102 can include one or more libraries, such as the Boost libraries 5112, which provide a suite of functions and computer-executable instructions that can be utilized to implement the various functionalities of the edge device gateway 5002. The base image 5102 can include the system libraries 5122, which may include libraries that provide low-level access to system functionalities of the edge device gateway 5002. The base image 5102 can include one or more encrypted keys, certificates, or key continuity management (KCM) functionalities, which may be stored in a separate data partition 5114.

The base image 5102 can include the operating system 5116, which may include a kernel, machine code, or other processor-executable instructions that enable management of the various processes that may execute on the edge device gateway 5002. The operating system 5116 can coordinate scheduling, initiating, and terminating different processes in both user space and kernel space. The operating system 5116 can manage memory for the various components of the edge device gateway 5002. The operating system 5116 can perform system-level management of hardware devices, including loading, implementing, and executing device drivers for various hardware interfaces of the edge device gateway 5002. Examples of such drivers include the light emitting diode (LED) drivers 5128, the Universal Serial Bus (USB) drivers 5130, the WiFi Access Point (AP)/client drivers 5132, the Ethernet drivers 5134, and the serial driver 5136, among others. The operating system 5116 may also execute or coordinate various protocols, including the Network Time Protocol (NTP) 5124. The NTP 5124 can be utilized to synchronize time over a network (e.g., by transmitting a request for the current time to a server and setting a system time to the value retrieved from the server). The operating system 5116 can implement one or more power monitors 5126, which may monitor the voltage or usage of power from one or more batteries or other external power sources.

The base image 5102 can include a node 5118, which may include software, scripts, libraries, or other processor-executable instructions that can implement a node-based network. For example, the node 5118 can include information relating to a topology of a network, or information relating to the implementation of one or more network interfaces or protocols. The base image 5102 can include secure boot 5120 software, which may include software, scripts, libraries, or other processor-executable instructions that can implement the Unified Extensible Firmware Interface (UEFI) Secure Boot protocol. The Secure Boot protocol can verifies that the code loaded by the firmware on a motherboard is the intended code for the edge device gateway 5002.

The base image 5102 can include the edge computing package 5138. The edge computing package 5138 can include any of the containers or other software implemented by the edge device gateway 5002 as described herein. The edge computing package 5138 can include, for example, software that implements the virtual bus 5004, software that implements the edge manager/Airwall manager 5032, software that implements an analytical engine, a logger, a log rotator (e.g., implementing a log rotation policy), and software that initializes the containerized components described herein (e.g., the cloud proxy 5036, the cloud connector 5038, the building device interface container 5006, the user interface container 5008, the CoV subscriber 5022, etc.). For example, the edge computing package 5138 may include a container initialization script (or other processor-executable instructions), configuration data for the containers, among other data related to the containers as described herein. The base image 5102 can include additional software that implements the functionality of the cloud client 5034 of the edge device gateway 5002.

Referring back to FIG. 46, the edge device gateway 5002 can include the DM agent 5030. The DM agent 5030 may not be a containerized component of the edge device gateway 5002, and may instead be installed and managed separately from the containerized components described herein. The DM agent 5030 can perform host operating system-level interactions on behalf of the edge manager 5032, which is containerized. The DM agent 5030 can manage a container environment (e.g., a Docker Compose) for the various containerized components of the edge device gateway 5002. The DM agent 5030 can configure credentials (e.g., a common shared secret, OAuth tokens, etc.) for retrieving one or more configuration images 5044.

The edge device gateway 5002 can include the edge manager/Airwall manager 5032 (sometimes referred to herein as the edge manager 5032). The edge manager 5032 can communicate with the configuration manager 4928 and with the DM agent 5030 to retrieve information such as one or more containerized gateway components, gateway component configurations, or configuration images 5044, and deploy said information on the edge device gateway 5002. The edge manager 5032 can further execute or implement one or more remote management commands received from the configuration manager 4928. Some example remote management commands include rebooting the edge device gateway 5002, creating, modifying, or removing configuration settings of one or more components of the edge device gateway 5002, or triggering discovery operations remotely, among others. The edge manager/Airwall manager 5032 can implement one or more network functionalities described in connection with the configuration manager 4928 in FIG. 45, for example, to provide isolation of an edge device gateway 5002 on local networks or external networks, as well as enabling secure, remote access to the functionality of the edge device gateway 5002.

In some implementations, the edge manager 5032 can implement additional containers other than those shown in FIG. 46. For example, the edge manager 5032 can implement one or more analytical engines, machine learning models, or Complex Event Processing (CEP) modules that have the ability to monitor or subscribe to messages from the virtual bus 5004. Such components can be utilized to analyze and make decisions based on configured logic, and publish back the analytical results on the virtual bus 5004 using a subscriber-publisher protocol, described in further detail herein. Such processing can be performed on information “in flight” (e.g., recently received from the building subsystems 3122). In some implementations, data from the building subsystems is stored as historical data, for example, if a larger data set is required by the analytical modules or containerized components.

The edge device gateway 5002 can include the cloud connector 5038, which can send and receive one or more messages to and from the cloud interface 5042 of the cloud platform 3106. The cloud connector 5038 may utilize one or more encrypted keys, credentials, or other authorization mechanisms to establish secure communication channel(s) with the cloud platform 3106. The cloud connector 5038 can act as an interface between the cloud platform 3106 and the containerized gateway components that communicate via the virtual bus 5004. The cloud connector 5038 can receive commands provided from one or more of the remote applications 5048 via the cloud APIs 5040, for example. The cloud connector 5038 may further provide data via the cloud interface 5042, which can communicate the data for display to the remote application(s) 5048 via the cloud APIs 5040.

The edge device gateway 5002 can include the cloud client 5034. The cloud client 5034 can update, modify, remove, or otherwise manage any low-level software that can be implemented by the edge device gateway 5002. For example, the cloud client 5034 can update, modify, remove, or manage device firmware, low-level drivers, system configurations, or host-specific applications that are separate from the containerized gateway components described herein. The cloud client 5034 may be in communication with the cloud manager 5046, for example, via a network. The cloud client 5034 can retrieve, implement, manage, or execute any of the commands or data received or requested from the cloud manager 5046.

The edge device gateway 5002 can instantiate, implement, execute, or otherwise provide the virtual bus 5004. The virtual bus 5004 can be a virtually defined network bus managed by the operating system or other software (e.g., software retrieved and implemented using the edge manager 5032). The virtual bus 5004 can be a virtual IP network bus, which may enable one or more of the containerized gateway components (e.g., the cloud proxy 5036, the cloud connector 5038, the building device interface container 5006, the user interface container 5008, the CoV subscriber 5022, etc.) to communicate with one another. Each container (or interface of a container) that communicates via the virtual bus 5004 may be associated with a corresponding virtual IP address (e.g., assigned by the software managing the virtual bus 5004, etc.). To facilitate communication between the containerized gateway components, the software managing the virtual bus 5004 routes IP packets directed to the container having the IP address indicated in the header of the IP packet.

In some implementations, the virtual bus 5004 can implement a publish-subscribe messaging pattern. Publish-subscribe is a messaging pattern where senders of messages (e.g., various containers or software components transmitting messages via the virtual bus 5004), called publishers, do not program the messages to be sent directly to specific receivers, called subscribers. Instead, the sender containers or components can categorize published messages into classes (sometimes referred to herein as “topics”) without knowledge of which subscribers, if any, there may be. Subscriber containers or components (e.g., containers or components that can receive messages via the virtual bus 5004) can each be associated with one or more topics to which those containers or components “subscribe.”

Such containers or components may only receive messages having topics matching those that they subscribe to, without knowledge of which publishers, if any, there are. Publish-sub scribe messaging patterns provide greater network scalability and a more dynamic network topology, with a resulting decreased flexibility to modify the publisher and the structure of the published data. This enables multiple containers to be implemented in a scalable way, and in a manner that is agnostic to other containers that may be implemented by the edge device gateway 5002. In the publish-subscribe model, subscribers may receive a subset of the total messages published. In a topic-based system, messages are published to “topics,” or named logical channels. Subscribers in a topic-based system will receive the messages published to the topics to which they subscribe. The publisher is responsible for defining the topics to which subscribers can subscribe (e.g., via one or more internal configuration settings, configuration settings received via the cloud platform, etc.).

The containerized components of the edge device gateway 5002 described herein may implement a Smart Equipment Messaging (SEM) protocol, which may be implemented on top of HTTP. Other types of messaging protocols may also be utilized, such as RabbitMQ, ZeroMQ (which may, for example, include additional extensions corresponding to the cloud platform 3106), MQTT, HTTP, Kafka, etc.). In some implementations, the virtual bus 5004 can implement additional messaging patterns, such as point-to-point Remote Procedure Call (RPC) or bulk transfer messaging protocols. The virtual bus 5004 (or the containers that communicate via the virtual bus 5004) can translate various different building device protocols (e.g., OPC, UA, Modbus, BACnet, etc.) into a common schema (e.g., the SEM protocol, other messaging protocols described herein, etc.)

Each of the containerized gateway components (e.g., the cloud proxy 5036, the cloud connector 5038, the building device interface container 5006, the user interface container 5008, the CoV subscriber 5022, etc.) described herein may be implemented using one or more separate containers. Containers, as described herein, is a software package for one or more applications that includes code, and all its dependencies, so the one or more applications can execute quickly and reliably from one computing environment to another. Containers can be standalone, executable packages of software that includes code, runtime, system tools, system libraries and configuration settings. Containers can be distributed as “container images,” which can be loaded and executed by a container manager of the edge device gateway 5002. One example of a type of container image is a Docker container image. Each container may maintain its own storage. In some implementations, scripts or code that instantiate multiple containers can generate a shared region of memory called one or more “volumes,” which may be a location in memory that can be accessed by one or more containers with read access, write access, or read and write access. Read and write permissions for one or more volumes can be specified in the configuration of the respective container, for from other configuration settings.

One advantage of using containers is that containerized software will always run the same, regardless of the infrastructure or conflicting dependencies that may be present on the edge device gateway 5002. This is because containers can isolate software from its environment and ensure that it works uniformly despite differences, for instance, between development and staging. To communicate with other containers, software, or hardware, each container described herein can implement one or more interfaces. The interfaces may be virtual network interfaces (e.g., that communicate with the virtual bus 5004, etc.). In some implementations, a container may access and communicate with one or more hardware interfaces of the edge device 5002, such as a serial interface, a USB interface, an Ethernet interface, or one or more wireless interfaces, among others.

In some implementations, one or more of the containers described herein can communicate with a hardware abstraction layer (HAL)/device manager 5020 implemented by the operating system of the edge device gateway 5002. The HAL/device manager 5020 includes software components that enables a computer operating system or other containers of the edge device gateway 5002 to interact with a hardware device (e.g., an interface, an external device communicatively coupled to the edge device gateway 5002, etc.), at a general or abstract level rather than at a detailed hardware level. In doing so, the containers described herein can access and control hardware interfaces of the edge computing device, including visual indicators (e.g., display devices, LEDs, etc.), auditory indicators (e.g., alarms, speakers, etc.), network interfaces, or serial interfaces. In some implementations, the HAL/device manager 5020 is itself implemented as a container.

The edge device gateway 5002 can implement or execute the CoV Subscriber 5022, which may be implemented and executed as a container in communication with the virtual bus 5004. The CoV subscriber 5022 can manage subscriptions to message topics from multiple sources (e.g., containers or software components that transmit messages via the virtual bus 5004). In some implementations, the CoV subscriber 5022 can implement caching of the latest value from each subscribed topic reference. This enables each container that communicates via the virtual bus 5004 to publish CoVs without having to track the dynamic subscriptions of the containers implemented by the edge device gateway 5004, and frees each container from caching the latest CoV. The CoV subscriber 5022 can subscribe to various CoV data sources (containers for integrations, analytics, etc.) to maintain its cache of the latest value. The CoV subscriber 5022 can cache simple data types (e.g., enums, floats, strings, etc.) or other data types.

The edge device gateway 5002 can implement or execute the cloud proxy 5036, which may be implemented and executed as a container in communication with the virtual bus 5004. The cloud proxy 5036 can implement logic to conserve Internet bandwidth and map locally generated messages from the containers via the virtual bus 5004 to or from the requirements of the cloud interface 5042. For example, the cloud proxy 5036 can transform cloud-formatted cloud-to-device commands into HTTP commands used by the containers implemented by the edge device gateway 5002, to control or implement said commands. The cloud proxy 5036 can further add headers required by the cloud interface 5042 to outgoing messages. In some implementations, the cloud proxy 5036 can accumulate messages from the various components of the edge device gateway 5002, and can transmit the messages to the cloud platform 3106 periodically (e.g., once every 30 seconds, etc.).

The edge device gateway 5002 can implement or execute the building device interface container 5006, which may be implemented and executed as a container in communication with the virtual bus 5004. The building device interface container 5006 may also communicate directly with the user interface container 5006, for example, via the bus interfaces(s) 5010 using a MUDAC API. The building device interface container 5006 can include the bus interfaces 5010, interlock objects 5012, alarming objects 5014, and scheduling objects 5016.

The building device interface container 5006 can include one or more device interfaces 5018, which may include one or more hardware interfaces, such as RS-485 serial interfaces, USB interfaces, Ethernet interfaces, wireless interfaces, or general serial interfaces, that can be utilized to communicate with one or more of the building subsystems 3122. The building device interface container 5006 can include one or more bus interface(s) 5010, which may include one or more MUDAC APIs, or other communication APIs, which enable the building device interface container 5006 to communicate directly with the capability provider 5024 of the user interface container 5008. The building device interface container 5006 can communicate with the HAL/Device manager 5020 container, for example, to activate one or more LEDs or interface with hardware components of the edge device gateway 5002. The interlock objects 5012, the alarming objects 5014, and the scheduling objects 5016 can be Object Runtime Environment (ORE) Objects, and may be utilized to configure operation of the building subsystems 3122.

The building device interface container 5006 can automatically discover Master-Slave/Token-Passing (MSTP) equipment over wired or wireless networks, and can interact with and send/receive data and commands to and from multiple BACnet controllers in a building network. The building device interface container 5006 can implement a generic API to allow interaction with the BACnet MSTP equipment using the standardized messages transmitted via the virtual bus 5004. The building device interface container 5006 can implement a MUDAC API, which enables display of information via the user interface container 5008 (e.g., using the web server 5028, etc.), and to interact with features of the ORE and Smart Equipment. The MUDAC API interface between the building device interface container 5006 and the user interface container 5008 can be leveraged via the virtual bus 5004, for example, using a Rust Bus SDK.

In doing so, the building device interface container 5006 can implement the both the MUDAC API and a BACnet integration API as part of the bus interface(s) 5010, both of which can interface with the virtual bus 5004 and software components and data of the building device interface container 5006. For example, the building device interface container 5006 can implement the ORE Framework, including ORE core assets, ORE objects, base libraries, point mappers, BACnet communication frameworks, equipment mappers, data models, and integrations. Additionally, the building device interface container 5006 can implement discovery functionality as described herein by interfacing with the building subsystems 3122. The building device interface container 5006 can execute a protocol engine to carry out building protocols, store a dictionary of building data, store a template cache for the container, implement an IP data link, and implement a CoV manager to manage CoVs produced by the building subsystems 3122. The building device interface container 5006 may also interface with one or more operating system APIs. The functionality implemented by the building device container 5006 may include any of the functionalities of the data access layer described in connection with U.S. patent application Ser. No. 17/750,824, filed May 23, 5022, the contents of which is incorporated by reference herein.

The edge device gateway 5002 can implement or execute the user interface container 5008, which may be implemented and executed as a container in communication with the virtual bus 5004. The user interface container 5008 can implement a user interface backend 5026, which can translate messages received from the building device interface container 5006 via the capability provider 5024 into format usable by the webserver 5028 (e.g., one or more HTML files, PHP files, JavaScript files, etc.). For example, the user interface backend 5026 can format raw data (e.g., sensor data, diagnostic data, log messages, metadata, data relating to control schedules, fault data, data from the cloud platform 3106, state data relating to the edge device gateway 5002, operating system data, information relating to a status of one or more containers implemented by the edge device gateway 5002, etc.) received from the building device interface container 5006 or the virtual bus 5004 into one or more tables, databases, or other formats that can be displayed in a web-based interface. The user interface backend 5026 can both format the raw data and provide the formatted data (e.g., provide access to files generated from the raw data) to the web server 5028 for display as the local user interface 5054. In doing so, the user interface backend 5026 can generate a graphical user interface based on the data from the one or more building devices.

The user interface container 5008 can implement the capability provider 5024, which can include software, scripts, or other processor-executable instructions that interface with the HAL/Device manager 5020 and the building device interface container 5006. For example, the capability provider 5024 may communicate using one or more MUDAC APIs implemented by the bus interface(s) 5010 of the building device interface container 5006. The capability provider 5024 can receive requests from the user interface backend 5026, which may be generated in response to interactions with user interface elements of webpages provided via the webserver 5028.

For example, if an operator requests to view data relating to a particular building device (e.g., one or more building subsystems 3122 or any other building computing device described herein, etc.), the user interface backend 5026 can generate a corresponding request for that data, and provide the request to the capability provider 5024. The capability provider 5024 can generate one or more commands to retrieve or access that data, and provide said commands via the MUDAC APIs of the building device interface container 5006. The building device interface container 5006 can execute the commands to retrieve the requested data, and provide the requested data to the user interface container 5008 via the MUDAC APIs. Then, the capability provider 5024 can provide the raw data to the user interface backend 5026, which can format it for display via the webserver 5028, as described herein. Although the communication between the user interface container 5008 and the building device interface container 5006 are described as MUDAC APIs, it should be understood that any suitable communication channel (e.g., virtual IP networks, the virtual bus 5004, inter-process communication, etc.) may be utilized to facilitate communication between the building device interface container 5006 and the user interface container 5008.

The edge device gateway 5002 may implement a webserver 5028. The webserver 5028 may be an Apache webserver or an NGINX webserver, among others. The webserver 5028 can include software or combinations of hardware and software that accept requests via HTTP or HTTPS. Requests can be transmitted to the webserver 5028 via the local user interface 5054, which may include, commonly a web browser or native application implementing web-browsing functionality. The webserver 5028 can receive a request for one or more web pages (e.g., generated or provided by the user interface backend 5026) or other resources using HTTP. The webserver 5028 can responds with the content of that resource or an error message.

The edge device gateway 5002 can execute the various containers described herein according to a startup sequence, which may be specified in one or more configuration settings or files, or may be provided as part of the container(s) received in a configuration image 5044, for example. In some implementations, different containers implemented by the edge device gateway 5002 can include one or more internal dependencies (e.g., an identification of containers that should be initialized prior to the instant container). A watchdog wrapper script, application startup handshakes, or periodic heartbeats (e.g., where each component publish a periodic heartbeat with its running status that other components on the bus can subscribe to) can be implemented to enforce a startup execution order of the various containers implemented by the edge device gateway 5002.

It should be understood that although the forgoing description has described the edge device gateway 5002 as implementing various containers, that any type of building device described herein may implement containers, connectors, and the virtual bus 5004 to facilitate communication between the implemented container and other software components. For example, the various building gateways, BMS servers, and building devices described herein may also implement various containers. In some implementations, said devices may further implement connectivity with the cloud platform 3106 to create, update, or remove container components, and to gather data from and control various building subsystems 3122 or other building devices in one or more buildings.

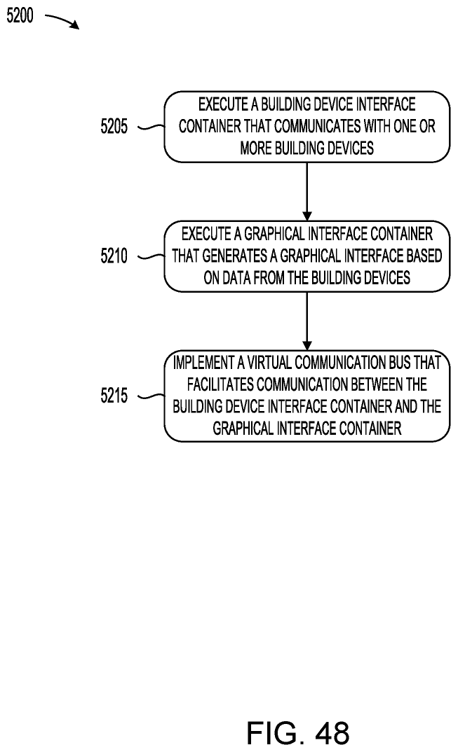

FIG. 48 is a flow diagram of an example method 5200 for the integration and containerization of gateway components on edge devices, in accordance with one or more implementations. In various embodiments, the edge device gateway 5002 performs the method 5200. However, it should be understood that any computing system described herein may perform any or all of the operations described in connection with the method 5200. For example, in some embodiments, the local server 3702, the device/gateway 3720, the local BMS server 3804, the network engine 3816, the gateway 4004, the gateway manager 4202, the cluster gateway 4206, the edge device 4902, the edge device gateway 5002, or any other computing systems or devices described herein, may perform the method 5200. The computing system performing the operations of the method 5200 is referred to in the following description as the “building device gateway.” The method 5200 includes steps 5205-5215, however it should be understood that steps may be removed, performed in an alternate order, or additional steps may be performed, while still achieving useful results.

At step 5205, the building device gateway (e.g., the edge device gateway 5002, the local server 3702, the device/gateway 3720, the local BMS server 3804, the network engine 3816, the gateway 4004, the gateway manager 4202, the cluster gateway 4206, the edge device 4902, etc.) can execute a building device interface container (e.g., the building device interface container 5006) that communicates, via an interface (e.g., the device interface 5018, etc.) implemented by the building device interface container, with one or more building devices (e.g., one or more building subsystems 3122) of a building to control or collect data from the one or more building devices. The building device gateway can provide the building device interface container for execution, for example, by storing the building device interface container in a region of memory of the building device gateway. The data can be sensor data, diagnostic data, log messages, metadata, data relating to control schedules, fault data, operational data, configuration data, or any other type of data described herein.

At step 5210, the building device gateway can execute a graphical interface container (e.g., the user interface container 5008) that generates a graphical user interface (e.g., presented via the local user interface 5054) based on the data from the one or more building devices. The building device gateway can provide the graphical interface container for execution, for example, by storing the graphical interface container in a region of memory of the building device gateway. For example, the graphical user interface may include any of the data captured from or relating to the building devices. In some implementations, an operator can provide one or more requests for particular data or sets of data via the user interface. The graphical interface container can process and forward the request to the building device interface container, which can retrieve the requested data from computer memory or from the corresponding building subsystems 3122. The building device interface container can then forward the retrieved data to the graphical interface container, which can format and present the retrieved data in the graphical user interface to satisfy the request.

At step 5215, the building device gateway can implement a virtual communication bus (e.g., the virtual bus 5004) that facilitates communication between the building device interface container and the graphical interface container. The virtual communication bus can include a virtual IP network, and may transmit messages by communicating one or more IP packets between the containers executed by the building device gateway. The messages may include HTTP data or data corresponding to any type of messaging protocol described herein. The virtual communication bus can implement a publish-subscribe messaging pattern, where the virtual communication bus can receive and transmit one or more messages identifying one or more topics. The topics can be specified by the containers that transmitted the one or more message, and the messages can be provided to the container that subscribes to the topics to with which the messages are associated. For example, the graphical interface container can include a configuration that subscribes the graphical interface container to a subset of the one or more topics, such as topics involving raw data that is to be provided for display.

The building device gateway can implement additional containers that communicated via the implemented virtual communication bus. In some implementations, the building device gateway can implement a cloud communication container (e.g., the cloud connector 5038) that communicates data transmitted via the virtual communication bus to or from a cloud computing system (e.g., the cloud platform 3106). The cloud communication container can subscribe to a subset of the topics that indicate the messages should be transmitted to the cloud computing system. In some implementations, the building device gateway can execute a cloud proxy container (e.g., the cloud proxy 5036) that formats data transmitted via the virtual communication bus according to a standard format of the cloud computing system. In some implementations, the cloud proxy container can periodically transmit the formatted data to the cloud computing system via the cloud communication container and the virtual communication bus.

In some implementations, the building device gateway can implement one or more software components to instantiate, modify, update, or remove one or more containers. For example, the building device gateway can receive an update (e.g., via the edge manager 5032, the DM agent 5030, from the cloud platform 3106, etc.) to one or more of the building device interface container or the graphical interface container. Upon receiving the updates to the container, the building device gateway can modify one or more of the building device interface container or the graphical interface container according to the update. For example, the building device gateway can modify a configuration of the corresponding container, replace the container with an updated container, or remove a container, among other operations described herein.

### Integration of Gateway Device, Cloud Platform, and Containerization

Referring generally to the figures, a gateway can be used with containerization to allow a single design of a gateway to function in multiple environments. Containerization of a gateway device is the bundling of applications (i.e., local UI, system bus links, cloud connectors, analytics algorithms, data processors, reports generation, data publishers, device management, alarm managers, schedule managers, logic controls, computing applications, artificial intelligence and machine learning processors, network managers, hardware managers, security managers, protocol integrations, etc.) along with their required dependencies, libraries, and other necessary files into an individual or a combination of self-contained units otherwise known as a container. Bundling an application into a container allows the application to run across different environments and platforms, without needing to ensure compatibility. Containers can be isolated and independent so they can be easily managed, scaled and deployed using one or more container orchestration tools. Containers can be grouped together into packages, with each package representing a unique combination of containers. The packages can be associated with an environment, control system, protocol, or software suit. The packages can be efficiently distributed to gateway devices in a select system to provide said gateway device with the containers necessary to operate in that environment. A gateway with a base operating system can receive and initialize containers to obtain different functional abilities. Containers can also be removed or updated to reconfigure a gateway to operate in an entirely different computing environment than it was otherwise previously configured for.

As described herein, gateway 3112, gateway 4004, and edge device gateway 5002 can be substantially similar to gateway devices 268, 302, 602, and 902 except as otherwise provided herein. Gateway 3112, gateway 4004, and edge device gateway 5002 can encompass, comprise, or integrate one or more aspects, elements, or characteristics of gateway devices 268, 302, 602, and 902, and vice versa, to form a unified gateway device that combines the benefits and functionalities of both components. For example, the features and description of edge gateway device 5002 as shown in FIG. 46 can be implemented and combined with the features gateway device 302 of FIG. 5, gateway device 602 of FIG. 6, and/or gateway device 902 of FIG. 9. For further example, the software elements of gateway devices 268, 302, 602, and 902, including for instance the local UI 512, the cloud client 514, the communications interface 516, the capability provider 518, the data access layer 520, the OS 524, and the system bus data link 526 of gateway device 302 can all be containerized and provided to the gateway device 302 as containers for implementation as described herein with regards to gateway 3112, gateway 4004, and edge device gateway 5002. In some embodiments, the cloud platform 3106 can similarly be substantially similar to cloud platform 324 and cloud platform 924 except as otherwise provided herein.

When a gateway device (e.g., gateway 3112, gateway 4004, edge device gateway 5002, gateway devices 268, gateway devices 302, gateway devices 602, and gateway devices 902) is installed in a building management system such as BMS 300, a package of containers can be provided to the gateway device. In some embodiments, the package is substantially similar to or a part of the one or more configuration images 2024. The package can be selected from a plurality of packages based on one or more characteristics of the building management system. For example, if the BMS is a BACnet MS/TP system, the package (i.e., group of containers) associated with a BACnet MS/TP system can be provided to the gateway device 302. In some embodiments, a container may be included in more than one package. The package may include, for example, one or more of the local UI 512, the cloud client 514, the communications interface 516, the capability provider 518, the data access layer 520, the OS 524, and the system bus data link 526 in containers. The package may include more than one of the same container. In some embodiments, the gateway device 302 can install and initialize the one or more containers in the received package on the gateway device so that they can be executed and run as described herein. In some embodiments, multiple packages may be received by the gateway device. The packages can then be executed to operate as described herein for each of the gateway devices gateway 3112, gateway 4004, edge device gateway 5002, gateway devices 268, gateway devices 302, gateway devices 602, and gateway devices 902 to function as described.

Referring now to FIG. 46, in some embodiments the edge gateway device 5002 can be substantially similar to the gateway devices 268, 302, 602, and 902 except as otherwise specified. For example, the virtual bus 5004 can communicably couple containers for each of the local UI 512, the cloud client 514, the communications interface 516, the capability provider 518, the data access layer 520, the OS 524, and the system bus data link 526 of the gateway device 302 in FIG. 5. Each of these elements of the gateway device can be containerized as described herein and provided to the gateway device 302 according to the building management system requirements or features. In some embodiments, the virtual bus 5004 can be substantially similar to system bus datalink 526 except as otherwise specified; the cloud connector can be substantially to the communications interface 516 except as otherwise specified; the user interface container 5008 can be substantially similar to the local UI 512 except as otherwise specified; the building device interface container 5006 can be substantially similar to the data access layer 520 except as otherwise specified; and the building subsystems 3122 can be substantially similar to the MS/TP coordinator 306, the CV RTU 318, the input/output module 320, and the thermostat controller 334 or any other building equipment operable to be connected to and controlled by the gateway devices 302, 602, and 902 except as otherwise specified. Virtual bus 5004 can be a single bus in some embodiments.

Referring still to FIG. 46, in some embodiments edge gateway device 5002 is configured to communicate with building subsystems 3112 over wired and/or wireless MS/TP networks in a manner substantially similar to gateway device 602. For example, the device interface 5018 of the building device edge interface container 5006 can be substantially similar to the MS/TP connection 684 and/or system bust datalink 526, and can be configured to communicate with building equipment over wired and/or wireless MS/TP networks. In some embodiments, the edge gateway device 5002 can include a plurality of building device interface containers 5006. In some embodiments, separate building device interface containers 5006 are used for interfacing with the wired and for interfacing with the wireless MS/TP networks. In some embodiments, a single building device edge interface container 5006 can communicate with building subsystems 3122 connected with it over both wired and wireless MS/TP buses. In some embodiments, the building device edge interface container 5006 can communicate with the building subsystems 3122 as shown in FIGS. 15A and 15B over both a wired input 340 and a wireless system bus 332.

In some embodiments, the edge gateway device 5002 can be configured to interface with external, detachable, network adapters such as cellular adapter 1538, Wi-Fi adapter 1540 and Ethernet adapter 1542. For example, the edge device gateway 5002 can include a communications interface such as communications interface 516 or 616. In other embodiments, the cloud connector 5038 and/or the DM agent 5030 of the edge device gateway 5002 can be substantially similar to communications interface 516 or communications interface 616 and be configured to communicate over ethernet, cellular, or Wi-Fi networks. In some embodiments, the edge device gateway 5002 can be substantially similar to the gateway device 302 as shown in FIGS. 16-18 and can be configured to communicate over the external cell modem 1602 or 1802, the Wi-Fi adapter 1604 or 1802, the system bus 330 or the wired input 340 via the cellular adapter 1538, Wi-Fi adapter 1540 and Ethernet adapter 1542. Beneficially, this allows for the edge gateway device 5002 to connect to a plurality of disparate networks depending on the type of external, removal, network adapter that is installed.

In some embodiments, the gateway device provided in FIG. 19 can be substantially similar to the edge gateway device 5002. For example, the edge gateway device 5002 can be configured with one or more detachable network adapters and can provide building equipment to a cloud-based data platform via the one or more detachable network adapters. In some embodiments, the cloud connector 5038 and the device interface 5018 can both communicate over the network adapters.

Referring now to FIGS. 20-26, in some embodiments the edge device gateway 5002 can substantially similar to the gateway device 302 performing part of the data control template update process 2000. The IoT Hub 1004, the heartbeat processor 1008, D2C storage 1016, the Web UI 1028, the CED/CSD Event Hub 1024, and the C2D Storage 2402, can be part of remote applications 5048 accessible via the cloud platform 3106. For example the web UI 1028 can be substantially similar to the cloud user interface 5050 unless otherwise specified to allow a user to request a data control template. The data control template process as shown in FIG. 20 can thus be implemented with the edge device gateway 5002 to control the amount of data the edge device gateway 502 provides over a network.

APPENDIX A
Example Device Twin Subscription List

```
“subscriptionList”: {
  “url”: “https://path-to-subscription-list-sas-url”,
  “timestamp”: “2021-01-01T00:00:00.000Z”
End of Appendix A.
```

APPENDIX B
Equipment Model Template Example

```
{
  “Version”: “1.0.0.10_AAA”,
  “Template”: [
  {
    “-type”: 0,
    “-subtype”: 38,
    “-dictionary”: “1.0.0.1664”,
    “-name”: “Advanced Control Status”,
    “-description”: “Advanced Control Status Template”,
    “-ID”: “Equipment_Advanced_Control_Status_v1”,
    “-presentValueAttributeId”: 7000,
    “-PropertyList”: {
    “-Property”: [
      {
      “-ID”: 7000,
      “-Required”: 1,
      “-WritableFlag”: 0,
      “-Name”: {
        “-setId”: 1675,
        “-value”: 574
      },
      “-DataType”: 4,
      “-IPUnits”: {
        “-setId”: 507,
        “-value”: 98
      },
      “-SIUnits”: {
        “-setId”: 507,
        “-value”: 98
      },
      “-IPDisplayPrecision”: 6,
      “-SIDisplayPrecision”: 6
      },
      {
      “-ID”: 7004,
      “-Required”: 1,
      “-WritableFlag”: 0,
      “-Name”: {
        “-setId”: 1675,
        “-value”: 582
      },
      “-DataType”: 9,
      “-StringsetId”: 854
      },
End of Appendix B.
```

APPENDIX C
Subscription list Example

```
{
  “points”: [
  {
    “ref”: {
    “networkReference”: “Local Field Bus”,
    “deviceReference”: “JCI-1”,
    “equipmentReference”: “ RTU”,
    “objectReference”: null,
    “propertyId”: 7000
    }
  },
  {
    “ref”:
    “networkReference”: “Local Field Bus”,
    “deviceReference”: “JCI-7”,
    “equipmentReference”: “York RTU”,
    “objectReference”: “Fan Control”,
    “propertyId”: 7000
    }
  }
  ]
}
End of Appendix C.
```

APPENDIX D
Device Twin Example

```
{
  “properties”: {
    “reported”: {
    “cegDevice”: {
      “modelName”: “CEG”,
      “cegEncodingType”: {
      “set”: 575,
      “id”: 2
      }
  },
  “ethernet”: {
      “macAddress”: “00:00:00:00:00:00”
  },
  “bacnet”: {
      “mstp”: {
      “macAddress”: 117,
      “objectIdentifier”: 1,
      “maxMaster”: 127,
      “networkNumber”: 64999,
      “activeBaudRate”: {
        “set”: 3426,
        “id”: 4
      }
      }
  },
  “heartbeat”:
      “rateInMs”: 60000
  },
      “enabled”: true,
      “rateInMs”: 30000
  },
  “equipmentList”: {
      “enabled”: true,
      “rateInMs”: 60000
  },
  “subscriptionList”: {
      “url”: “https://path-to-subscription-list-sas-url”,
  },
  “remoteServices”: {
      “accountId”: “CEG_ACCOUNT ID”
  }
  firmware”: {
      “package Version”: “1.0.0”
      “lastUpdateTime”: “2021-01-01T00:00:00.000Z”
  }
  },
  “desired”: {
    “heartbeat”: {
      “rateInMs”: 18000000
  },
  “telemetry”: {
      “enabled”: true,
      “rateInMs”: 30000
  },
  “equipmentList”: {
      “enabled”: true,
      “rateInMs”: 86400000 //24hrs
  },
  “subscriptionList”: {
      “url”: “https://path-to-subscription-list-sas-url”,
      “timestamp”: “2021-01-01T00:00:00.000Z”,
      “checksum”: “ABCDEFGH123”,
      “etag”: “ABCDEFGH123”,
      “contentType”: “application/json”,
      “contentEncoding”: “application/gzip”
  },
  “remoteServices”: {
      “accountId”: “CEG_ACCOUNT_ID”,
      “accountIdLastUpdateTime”: “2021-01-01T00:00:00.000Z”
  }
  }
  }
}
End of Appendix D.
```

```
Appendix E - Telemetry Example
{
  “device”: “CEG111111111111111”,
  “account”: “100_CustomerName.100_CustomerName-Site1”,
  “owner”: “100_CustomerName”,
  “equipment”: [
    {
      “ref”: “/Local Field Bus.JCI-9.York RTU”,
      “points”: [
        {
          “ref”: “Cooling Control”,
          “attr”: 7777,
          “samples”: [
              “ts”: “2021-01-01T01:00:00Z”,
              “val”: −0.1
            }
          ]
        },
        {
          “ref”: “Heating Control”,
          “attr”: 7776,
          “samples”: [
            {
              “ts”: “2021-01-01T01:00:00Z”,
              “val”: −0.1
            }
          ]
        }
      ]
    },
    {
      “ref”: “/Local Field Bus.JCI-4.YT3_YK”,
      “points”: [
        {
          “ref”: “YMC3 Read Data”,
          “attr”: 7775,
          “samples”: [
            {
              “ts”: “2020-01-01T00:00:00Z”,
              “val”: “A string value”
            }
          ]
        },
        {
          “ref”: “YMC3 Read Data”,
          “attr”: 7002,
          “samples”: [
            {
              “ts”: “2020-01-01T00:00:00Z”,
              “val”: 0
            }
          ]
        }
      ]
    }
  ]
}
End of Appendix E.
```

```
Appendix F - Heartbeat Message Example
{
  “date”: “2021-01-01T00:00:00.000Z”
}
End of Appendix F.
Appendix G - Equipment List Example
{
  “timestamp”: “2021-01-01T00:00:00.000Z”,
  “networks”: [
    {
      “networkReference”: “Local Field Bus”,
      “devices”: [
        {
          “deviceReference”: {
            “networkReference”: “Local Field Bus”,
            “deviceReference”: “JCI-7”
          },
          “name”: “SE-RTU”,
          “description”: “Smart Equipment Stage1 UCB”,
          “address”: 7,
          “isOnline”: false,
          “equipmentModels”: [
            {
              “equipmentReference”: {
                “equipmentReference”: “York RTU”
              },
              “template”: {
                “id”: “Equipment_York_RTU_v1”,
                “version”: “3.4.0.0129”
              },
              “viewDefinition”: {
                “version”: “3.4.0.1029_SES1”
              }
            }
          ]
        },
        {
          “deviceReference”: {
            “networkReference”: “Local Field Bus”,
            “deviceReference”: “JCI-9”
          },
          “name”: “SE-RTU”,
          “description”: “Smart Equipment Stage1 UCB”,
          “address”: 9,
          “isOnline”: false,
          “equipmentModels”: [
            {
              “equipmentReference”: {
                “equipmentReference”: “York RTU”
              },
              “template”: {
                “id”: “Equipment_York_RTU_v1”,
                “version”: “3.4.0.0129”
              },
              “viewDefinition”: {
                “version”: “3.4.0.1029_SES1”
              }
            }
          ]
        },
        {
          “deviceReference”: {
            “networkReference”: “Local Field Bus”,
            “deviceReference”: “Device-88”
          },
          “name”: “device1”,
          “description”: “Device Description”,
          “address”: 88,
          “isOnline”: true,
          “equipmentModels”: [
            {
              “equipmentReference”: {
                “equipmentReference”: “Device-88-RTU-Open”
              },
              “template”: {
                “id”: “genericEquipmentModelTemplate”,
                “version”: “Device-88-RTU-Open_adebe”
              },
              “viewDefinition”: {
                “version”: “Device-88-RTU-Open”
              }
            }
          ]
        }
      ]
    },
    {
      “networkReference”: “Ethernet IP”,
      “devices”: [
        {
          “deviceReference”: {
            “networkReference”: “Ethernet IP”,
            “deviceReference”: “EthernetDevice123”
          },
          “name”: “Ethernet Chiller”,
          “description”: “Chiller Description”,
          “address”: “111.111.111.111”,
          “isOnline”: true,
          “firmwareVersion”: “1.0.0.0”,
          “equipmentModels”: [
            {
              “equipmentReference”: {
                “equipmentReference”: “Some BACnet/IP Chiller”
              },
              “template”: {
                “id”: “Equipment_BAC_IP_CHILLER_v1”,
                “version”: “1.0.0.0_BACIP”
              },
              “viewDefinition”: {
                “version”: “1.0.0.0_BACIP”
              }
            }
          ]
        }
      ]
    }
  ]
}
End of Appendix G.
```

### Appendix H—U.S. application Ser. No. 17/374,135 Filed Jul. 13, 2021

What is claimed is:

1. A building management system (BMS) comprising:
building equipment operable to affect a physical state or condition of a building;
a gateway device configured to:
execute an MS/TP container that communicates, via an interface implemented by the MS/TP container, with the building equipment via the wireless MS/TP bus or the wired MS/TP bus;
execute a cloud communication container that communicates, via an interface implemented by the cloud communication container, with a cloud-based data platform; and
receive building data from the building equipment via the MS/TP container and provide the building data to the cloud-based data platform via the cloud-connector container;
wherein the cloud-based platform is configured to:
communicate the building data to at least one of a control application, an analytic application, or a monitoring application; and
receive a command from at least one of the control application, the analytic application, or the monitoring application, based on the building data;
wherein the gateway device is further configured to operate according to the command.

2. The BMS of claim 1, further comprising:
a second building equipment operable to affect a physical state or condition of the building;
wherein the gateway device is further configured to:
receive, via the interface implemented by the MS/TP container, second building data from the second building equipment via the wireless MS/TP bus or the wired MS/TP bus not coupling the gateway device to the building equipment; and
provide the second building data to the cloud-based data platform via the cloud communication container.

3. The BMS of claim 2, wherein the building equipment and the gateway device are building automation control network (BACnet) MS/TP devices.

4. The BMS of claim 1, further comprising:
a second building equipment operable to affect a physical state or condition of the building;
wherein the gateway device is further configured to:
execute a BACnet IP container that communicates, via an interface implemented by the BACnet IP container, with the second building equipment over a BACnet IP bus;
receive, via the interface implemented by the BACnet IP container, second building data from the second building equipment via the BACnet IP bus; and
provide the second building data to the cloud-based data platform via the cloud communication container.

5. The BMS of claim 1, wherein the gateway device is further configured to:
receive a package comprising a plurality of containers, wherein the plurality of containers includes the MS/TP container and the cloud communication container; and
initialize the MS/TP container and the cloud communication container on the gateway device.

6. The BMS of claim 5, wherein the package is received from a source external to the gateway device, and wherein the package is identified from a plurality of packages based on one or more aspects of the building management system.

7. The BMS of claim 1, wherein the gateway device is further configured to implement a virtual communication bus that facilitates communication between the MS/TP container and the cloud communication container.

8. The BMS of claim 6, wherein the MS/TP container and the cloud communication container communicate over the virtual communication bus via a standardized protocol.

9. The BMS of claim 1, wherein wireless MS/TP bus comprises a plurality of wireless bridge devices forming a multi-point to multi-point network configured to communicate between the gateway device and at least one BACnet MS/TP device.

10. The BMS of claim 9, wherein the multi-point to multi-point network is configured to provide wireless communications to and from the gateway device and the building equipment such that the gateway device and the building equipment are operationally unaware of the wireless communications.

11. A building management system (BMS) comprising:
building equipment operable to affect a physical state or condition of a building;
a gateway device coupled to the building equipment;
a network adapter removably coupled to the gateway device, the network adapter configured to communicably couple the gateway device to a cloud-based platform;
wherein the gateway device is configured to:
execute a building device interface container that communicates, via an interface implemented by the building device interface container, with the building equipment; and
execute a cloud communication container that interfaces with the network adapter to communicate building data from the building equipment to a cloud-based data platform, wherein the cloud communication container is selected from a plurality of communication containers based on the network adapter;
wherein the cloud-based platform is configured to:
communicate the building data output to at least one of a control application, an analytic application, or a monitoring application; and
receive a command from at least one of the control application, the analytic application, or the monitoring application based on the building data output;
the gateway device further configured to operate according to the command.

12. The BMS of claim 11, wherein the network adapter is configured to automatically operate over regional network protocols.

13. The BMS of claim 11, wherein the network adapter is configured to connect the gateway device to the cloud-based platform according to regional network protocols, such that the gateway device coupled to the network adapter is further configured to operate on a regional network automatically.

14. The BMS of claim 11, wherein the gateway device is further configured to:
receive a package comprising a plurality of containers, wherein the plurality of containers includes the building device interface container and the cloud communication container; and
initialize the building device interface container and the cloud communication container on the gateway device.

15. The BMS of claim 14, wherein the package is received from a source external to the gateway device, and wherein the package is identified from a plurality of packages based on the network adapter.

16. The BMS of claim 11, wherein the gateway device is further configured to implement a virtual communication bus that facilitates communication between the MS/TP container and the cloud communication container.

17. A building management system (BMS) comprising:
a gateway device coupled to building equipment and configured to:
execute a building device interface container that communicates, via an interface implemented by the building device interface container, with the building equipment to control or collect data from the building equipment;
execute a cloud communication container that communicates, via an interface implemented by the cloud communication container, with a cloud-based data platform according to a data control template configured to control a data rate between the gateway device and the cloud-based platform; and
provide building data obtained from the building equipment via the building device interface container to the cloud-based data platform via the cloud communication container;
the cloud-based platform comprising:
a hub configured to:
generate a virtual device twin, the virtual device twin configured to represent the gateway device on the cloud-based platform and comprising the data control template; and
receive the building data;
a plurality of cloud applications, wherein the plurality of cloud applications are configured to receive the building data from the hub and process the building data to provide a building data output;
wherein the cloud-based platform is configured to:
communicate the building data output to at least one of a control application, an analytic application, or a monitor application; and
receive a command from at least one of the control application, the analytic application, or the monitor application based on the building data output;
the gateway device further configured to operate according to the command.

18. The BMS of claim 17, wherein the cloud-based platform is further configured to:
receive a command to modify a property of the data control template from at least one of the control application, the analytic application, or the monitor application; and
update the data control template in the virtual device twin based on the command and generate a new virtual device twin containing the updated data control template;
wherein the gateway device is further configured to receive the updated virtual device twin via the cloud communication container and communicate with the cloud-based platform according to the updated data control template.

19. The BMS of claim 17, wherein the data control template comprises control properties configured to control the data rate to and from the gateway device and the cloud-based platform, the control properties comprising at least one property selected from the group consisting of a telemetry rate, a heartbeat rate, an equipment list rate, a data compression setting, a COV file upload threshold setting, and a subscription list, the subscription list comprising a fully qualified reference, a change of value (COV) increment value, and a COV minimum time value.

20. The BMS of claim 17, wherein the gateway device is further configured to:
receive a package comprising a plurality of containers, wherein the plurality of containers includes the building device interface container and the cloud communication container; and
initialize the building device interface container and the cloud communication container on the gateway device.
